(19) United States
(12) Patent Application Publication
(10) Pub. No.: US 2004/0054605 A1
(43) Pub. Date: Mar. 18, 2004

(54) Method and system for publishing a real estate listing through a global computer network

(76) Inventor: William Clayton Whittet, Austin, TX (US)

Correspondence Address: HAYNES AND BOONE, LLP, 600 CONGRESS AVENUE, SUITE 1600, AUSTIN, TX, 78701, US

(21) Appl. No.: 10/610,381

(22) Filed: Jun. 30, 2003

Related U.S. Application Data
(62) Division of application No. 09/618,521, filed on Jul. 18, 2000, now abandoned.

(51) Int. Cl. G06F 17/60

(52) U.S. Cl. 705/27

(57) ABSTRACT

From a user through a global computer network, a computing system receives (a) first information about real estate and (b) second information. In association with an address within the global computer network, the computing system stores at least a portion of the first information. The address includes a domain name and the second information. Through the global computer network, in association with receiving the first information, the computing system outputs a notification of the address to the user.

### CROSS-REFERENCE TO RELATED APPLICATIONS

This application claims priority to and is a divisional of co-owned co-pending U.S. patent application Ser. No. 09/618,521, filed Jul. 18, 2000, by William Clayton Whittet, entitled METHOD AND SYSTEM FOR PUBLISHING A REAL ESTATE LISTING THROUGH A GLOBAL COMPUTER NETWORK, which is incorporated herein by reference in its entirety.

This application relates to co-owned co-pending U.S. patent application Ser. No. 09/618,709, filed Jul. 18, 2000, by William Clayton Whittet, entitled METHOD AND SYSTEM FOR CONTROLLING ACCESS TO A REAL ESTATE LISTING THROUGH A GLOBAL COMPUTER NETWORK, which is incorporated herein by reference in its entirety.

### BACKGROUND

The disclosures herein relate in general to information processing systems and in particular to a method and system for publishing a real estate listing through a global computer network.

Various techniques have been implemented for publishing a real estate listing through a global computer network. Nevertheless, according to many of those techniques, if a user wants to access and review a real estate listing, the user operates a search engine to identify and retrieve the real estate listing in response to a user-specified search query. For example, the user may specify such a query in the form of keywords and/or navigating menus to narrow the scope of identified real estate listings.

A shortcoming of such techniques is that numerous real estate listings may be identified and retrieved in response to such a query. Accordingly, despite initially narrowing the scope of identified real estate listings, the user may still feel compelled to specify additional queries in order to further narrow the scope of identified real estate listings. In many situations, such a query approach is unreliable and inefficient (e.g. cumbersome and time consuming).

Accordingly, a need has arisen for a method and system for publishing a real estate listing through a global computer network, in which various shortcomings of previous techniques are overcome. For example, a need has arisen for a method and system for publishing a real estate listing through a global computer network, in which a user is able to access and review a real estate listing in a more reliable and efficient manner.

### SUMMARY

According to one embodiment, a computing system receives, from a user through a global computer network, (a) first information about real estate and (b) second information. In association with an address within the global computer network, the computing system stores at least a portion of the first information. The address includes a domain name and the second information. Through the global computer network, in association with receiving the first information, the computing system outputs a notification of the address to the user.

A principal advantage of these embodiments is that various shortcomings of previous techniques are overcome. For example, a principal advantage of these embodiments is that a user is able to access and review a real estate listing in a more reliable and efficient manner.

### BRIEF DESCRIPTION OF THE DRAWING

FIG. 1 is a block diagram of a system for listing real estate according to the illustrative embodiment.

FIG. 2 is a block diagram of a representative one of the computing systems of the system of FIG. 1.

FIG. 3a is an illustration of a 1st screen displayed by a display device of a seller or buyer of the system of FIG. 1.

FIG. 3b is an illustration of a 2nd screen displayed by a display device of a seller or buyer of the system of FIG. 1.

FIG. 3c is an illustration of a 3rd screen displayed by a display device of a seller or buyer of the system of FIG. 1.

FIG. 3d is an illustration of a 4th screen displayed by a display device of a seller or buyer of the system of FIG. 1.

FIG. 3e is an illustration of a 5th screen displayed by a display device of a seller or buyer of the system of FIG. 1.

FIG. 3f is an illustration of a 6th screen displayed by a display device of a seller or buyer of the system of FIG. 1.

FIG. 3g is an illustration of a 7th screen displayed by a display device of a seller or buyer of the system of FIG. 1.

FIG. 3h is an illustration of an 8th screen displayed by a display device of a seller or buyer of the system of FIG. 1.

FIG. 3i is an illustration of a 9th screen displayed by a display device of a seller or buyer of the system of FIG. 1.

FIG. 3j is an illustration of a 10th screen displayed by a display device of a seller or buyer of the system of FIG. 1.

FIG. 3k is an illustration of an 11th screen displayed by a display device of a seller or buyer of the system of FIG. 1.

FIG. 3l is an illustration of a 12th screen displayed by a display device of a seller or buyer of the system of FIG. 1.

FIG. 3m is an illustration of a 13vh screen displayed by a display device of a seller or buyer of the system of FIG. 1.

FIG. 3n is an illustration of a 14th screen displayed by a display device of a seller or buyer of the system of FIG. 1.

FIG. 3o is an illustration of a 15th screen displayed by a display device of a seller or buyer of the system of FIG. 1.

FIG. 3p is an illustration of a 16th screen displayed by a display device of a seller or buyer of the system of FIG. 1.

FIG. 3q is an illustration of a 17th screen displayed by a display device of a seller or buyer of the system of FIG. 1.

FIG. 3r is an illustration of an 18th screen displayed by a display device of a seller or buyer of the system of FIG. 1.

FIG. 3s is an illustration of a 19th screen displayed by a display device of a seller or buyer of the system of FIG. 1.

FIG. 3t is an illustration of a 20th screen displayed by a display device of a seller or buyer of the system of FIG. 1.

FIG. 3u is an illustration of a 21st screen displayed by a display device of a seller or buyer of the system of FIG. 1.

FIG. 3v is an illustration of a 22nd screen displayed by a display device of a seller or buyer of the system of FIG. 1.

FIG. 3w is an illustration of a 23rd screen displayed by a display device of a seller or buyer of the system of FIG. 1.

FIG. 4a is an illustration of a 1st screen displayed by a display device of a buyer or seller of the system of FIG. 1.

FIG. 4b is an illustration of a 2nd screen displayed by a display device of a buyer or seller of the system of FIG. 1.

FIG. 4c is an illustration of a 3rd screen displayed by a display device of a buyer or seller of the system of FIG. 1.

FIG. 4d is an illustration of a 4th screen displayed by a display device of a buyer or seller of the system of FIG. 1.

FIG. 4e is an illustration of a 5th screen displayed by a display device of a buyer or seller of the system of FIG. 1.

FIG. 4f is an illustration of a 6th screen displayed by a display device of a buyer or seller of the system of FIG. 1.

FIG. 4g is an illustration of a 7th screen displayed by a display device of a buyer or seller of the system of FIG. 1.

FIG. 4h is an illustration of an 8th screen displayed by a display device of a buyer or seller of the system of FIG. 1.

FIG. 4i is an illustration of a 9th screen displayed by a display device of a buyer or seller of the system of FIG. 1.

FIG. 4j is an illustration of a 10th screen displayed by a display device of a buyer or seller of the system of FIG. 1.

FIG. 4k is an illustration of an 11th screen displayed by a display device of a buyer or seller of the system of FIG. 1.

FIG. 4l is an illustration of a 12th screen displayed by a display device of a buyer or seller of the system of FIG. 1.

FIG. 4m is an illustration of a 13vh screen displayed by a display device of a buyer or seller of the system of FIG. 1.

FIG. 4n is an illustration of a 14th screen displayed by a display device of a buyer or seller of the system of FIG. 1.

FIG. 4o is an illustration of a 15th screen displayed by a display device of a buyer or seller of the system of FIG. 1.

FIG. 4p is an illustration of a 16th screen displayed by a display device of a buyer or seller of the system of FIG. 1.

FIG. 4q is an illustration of a 17th screen displayed by a display device of a buyer or seller of the system of FIG. 1.

FIG. 5 is a conceptual illustration of operations performed by a website server of FIG. 1 according to member types and account types.

FIG. 6a is a flowchart of a 1st operation performed by the website server of FIG. 1.

FIG. 6b is a flowchart of a 2nd operation performed by the website server of FIG. 1.

FIG. 6c is a flowchart of a 3rd operation performed by the website server of FIG. 1.

FIG. 6d is a flowchart of a 4th operation performed by the website server of FIG. 1.

FIG. 6e is a flowchart of a 5th operation performed by the website server of FIG. 1.

FIG. 6f is a flowchart of a 6th operation performed by the website server of FIG. 1.

FIG. 6g is a flowchart of a 7th operation performed by the website server of FIG. 1.

FIG. 6h is a flowchart of an 8th operation performed by the website server of FIG. 1.

FIG. 6i is a flowchart of a 9th operation performed by the website server of FIG. 1.

FIG. 7a is an illustration of a 1st screen displayed by an advertiser of the system of FIG. 1.

FIG. 7b is an illustration of a 2nd screen displayed by an advertiser of the system of FIG. 1.

FIG. 8 is an illustration of various display templates of the system of FIG. 1.

### DETAILED DESCRIPTION

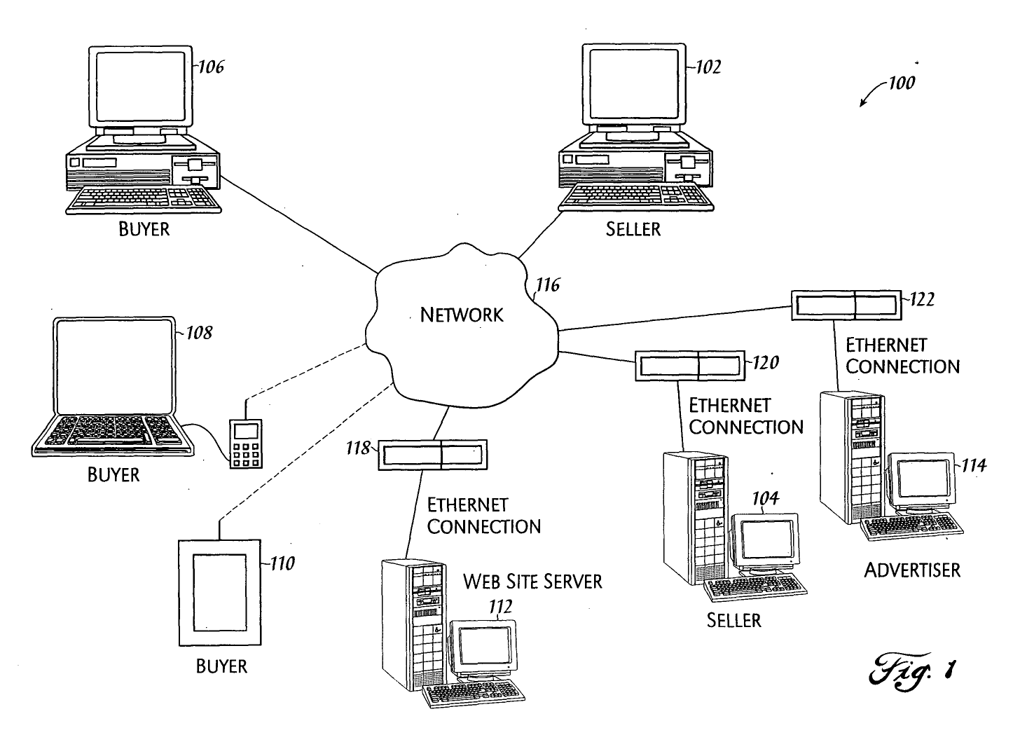

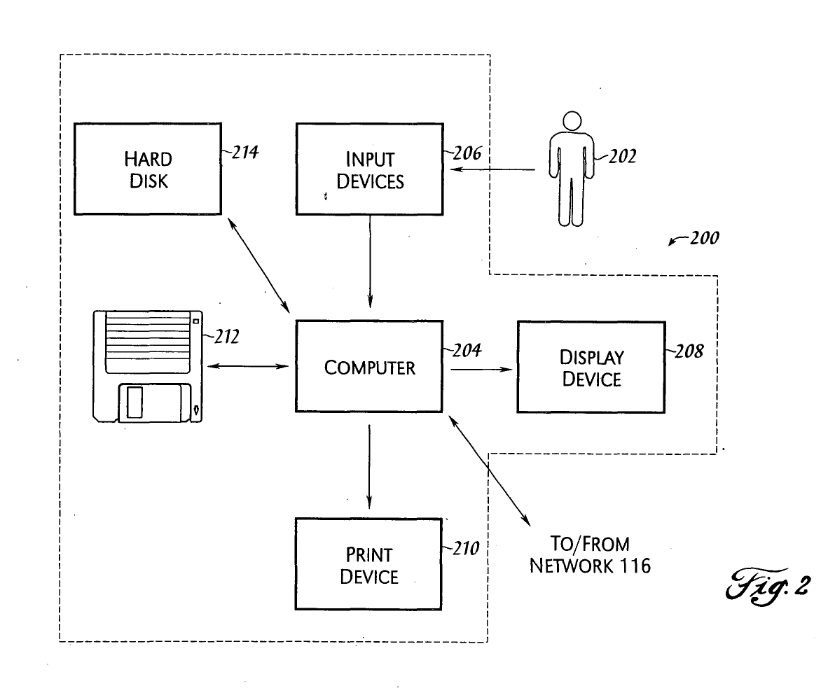

FIG. 1 is a block diagram of a system, indicated generally at 100, for listing real estate according to the illustrative embodiment. Advantageously, system 100 includes features directed specifically to the listing of real estate. Such features are discussed further hereinbelow. For clarity, FIG. 1 is not drawn to scale.

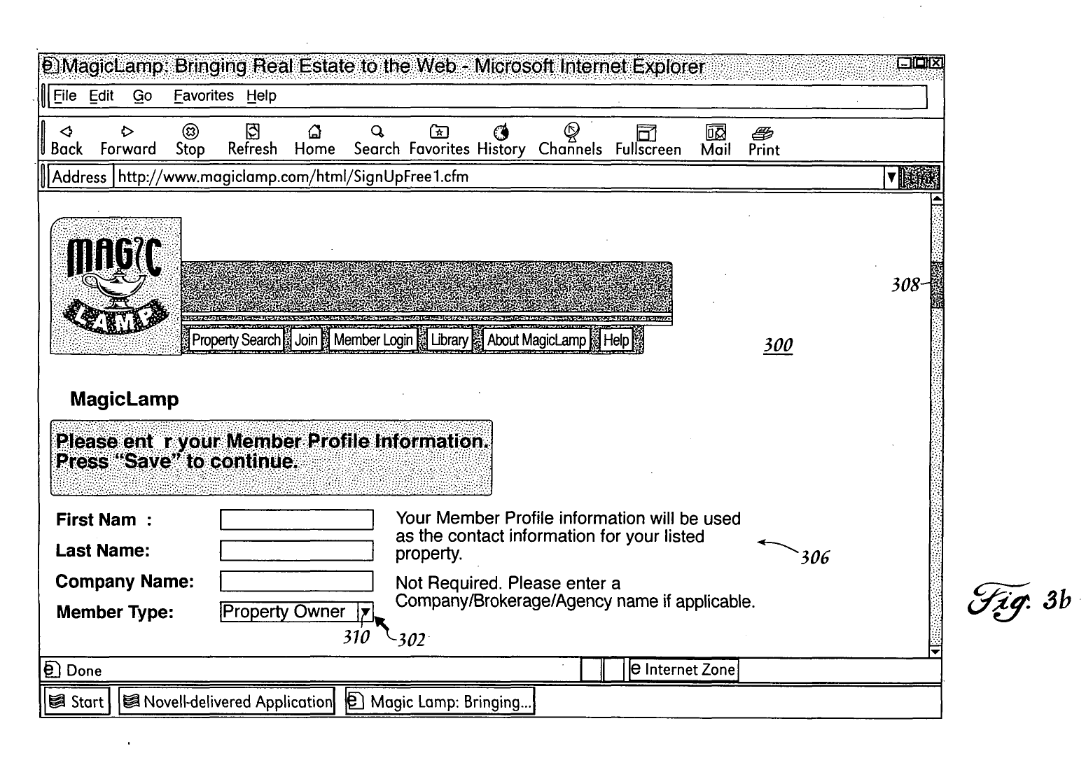

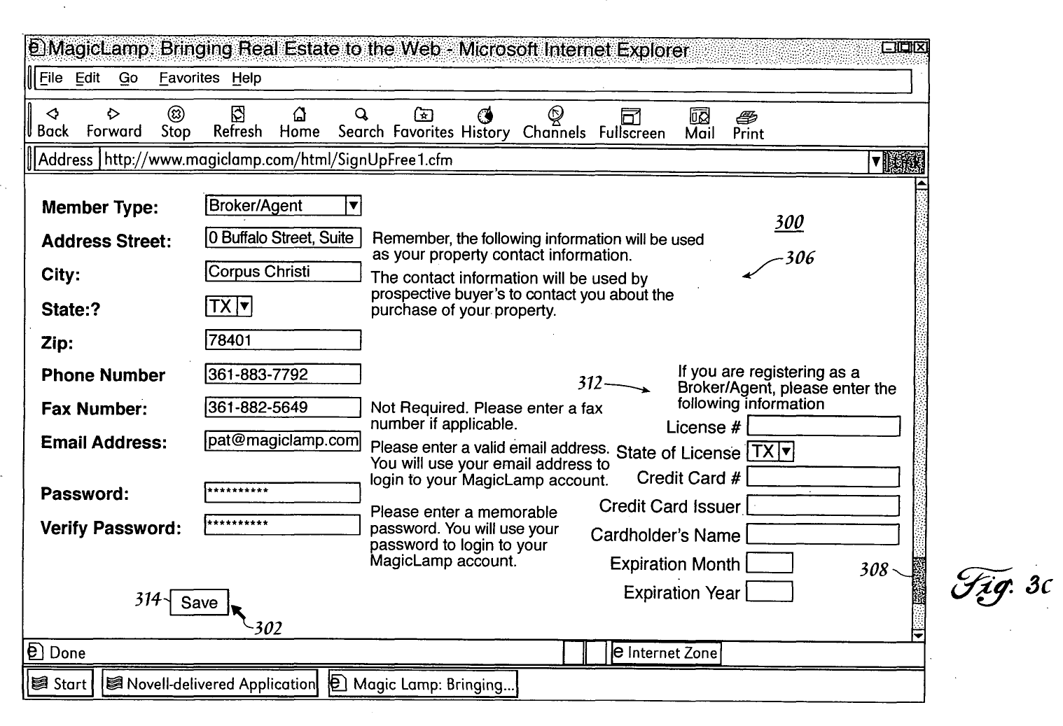

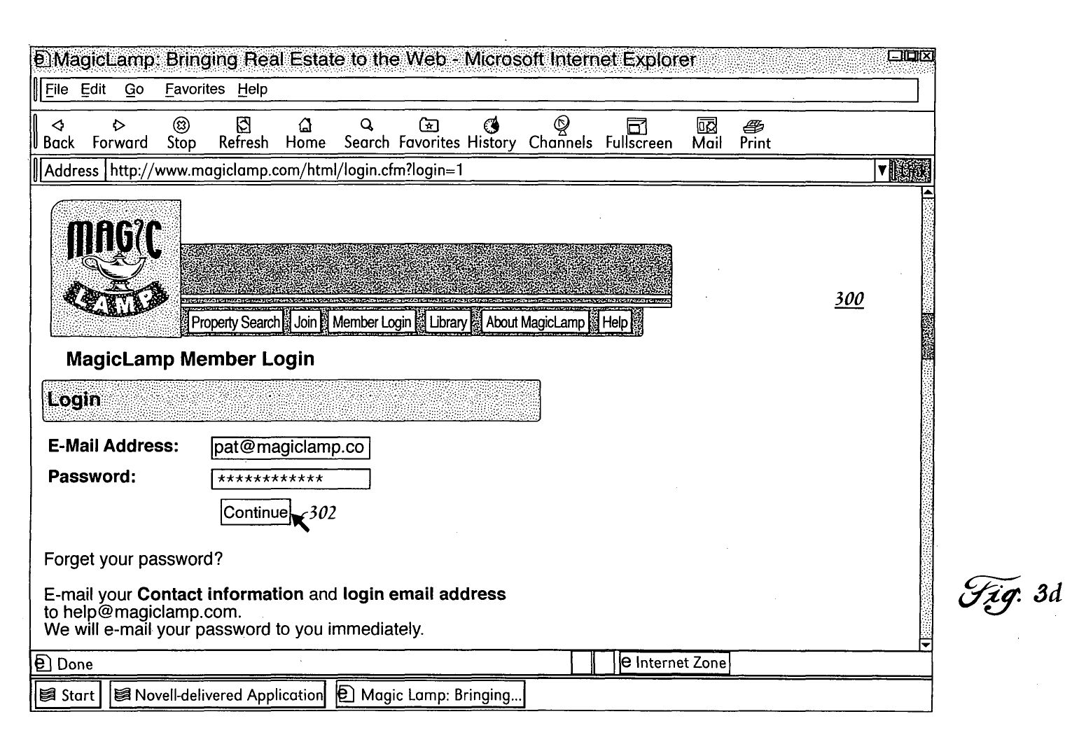

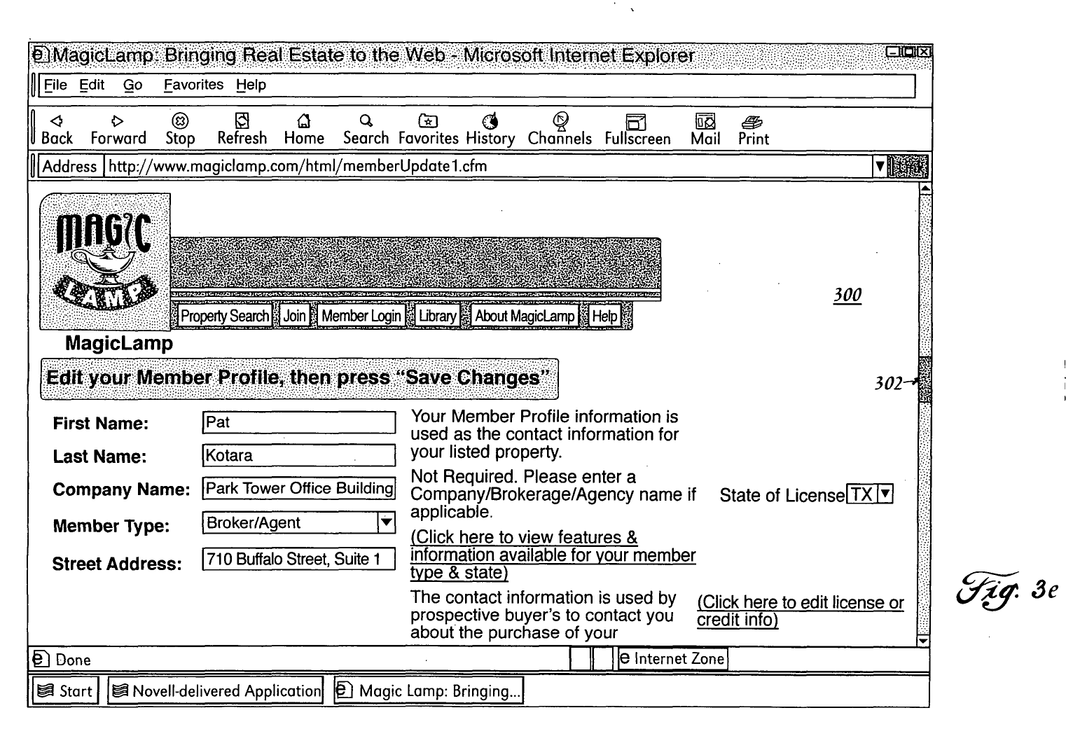

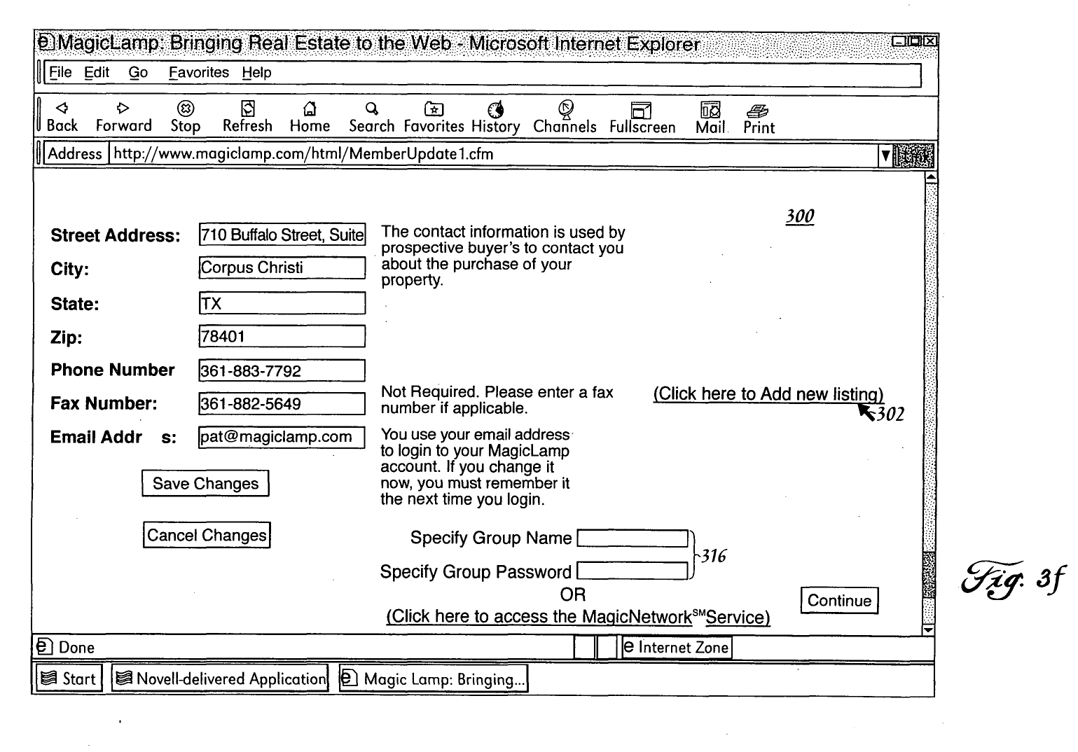

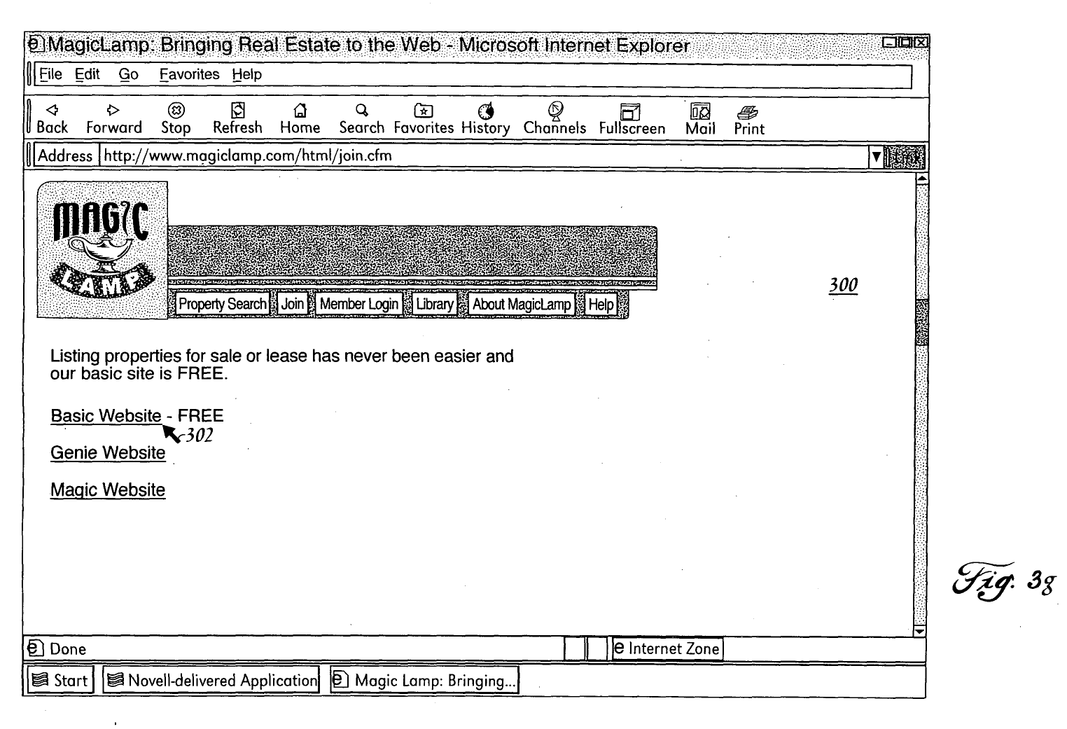

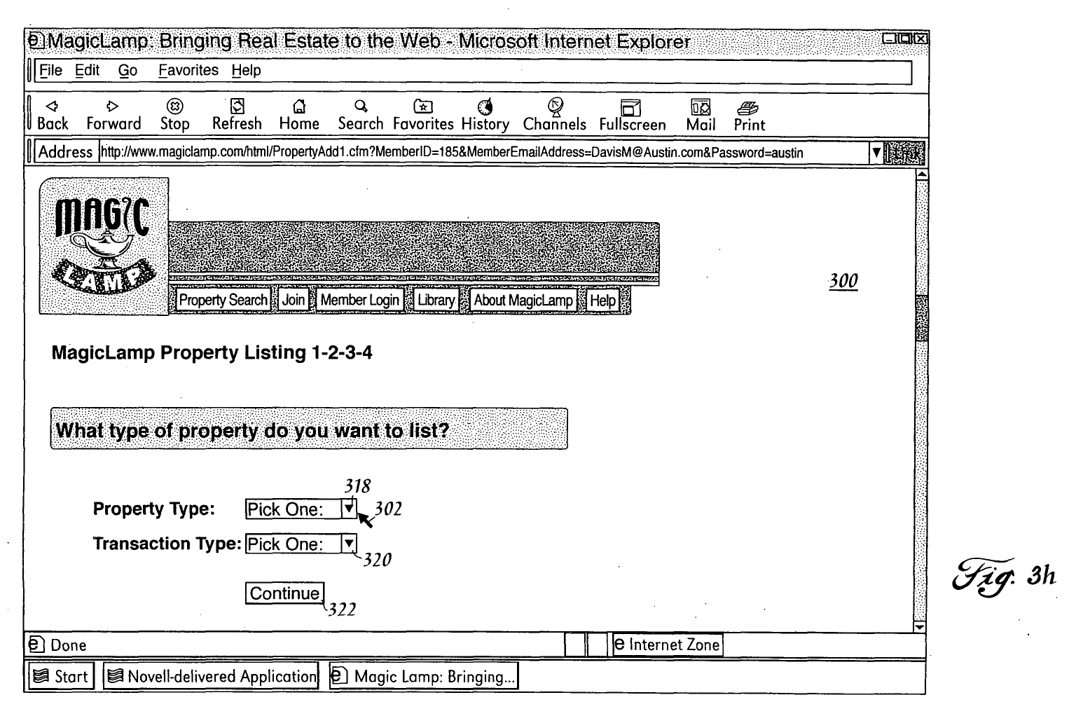

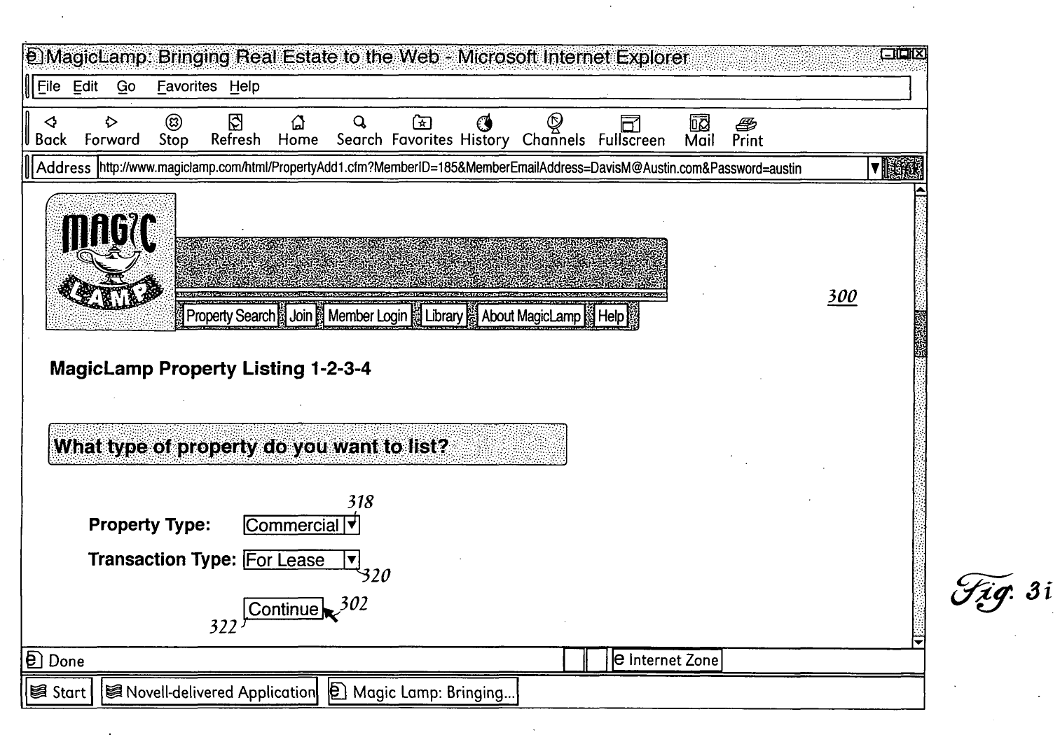

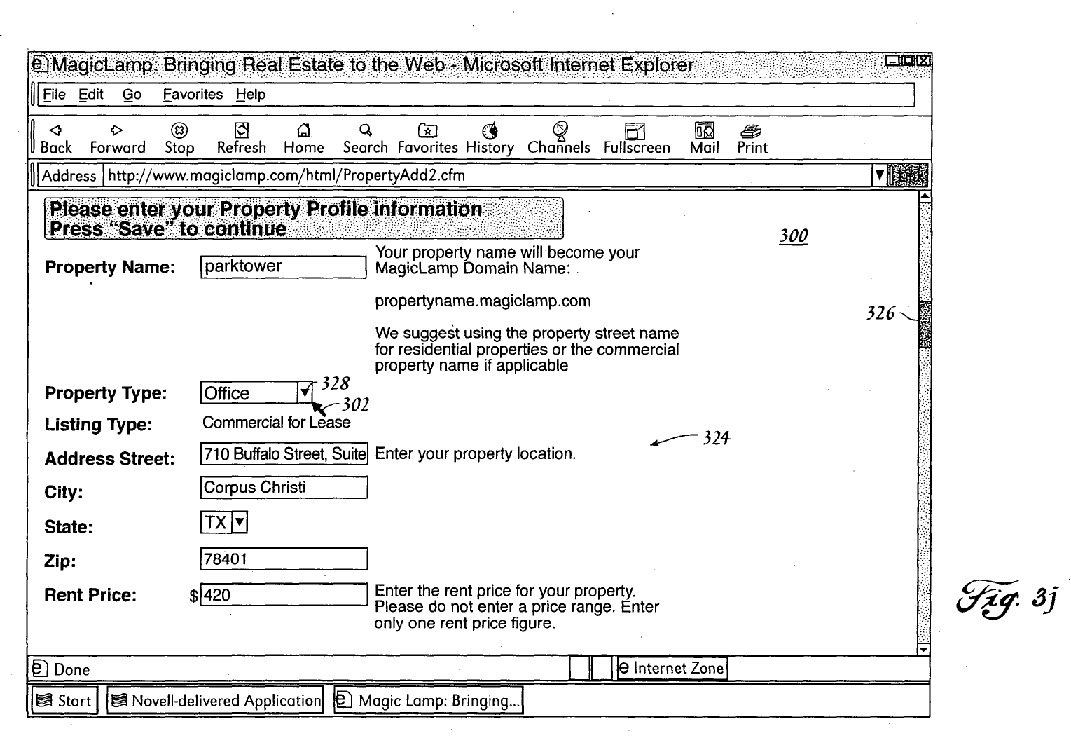

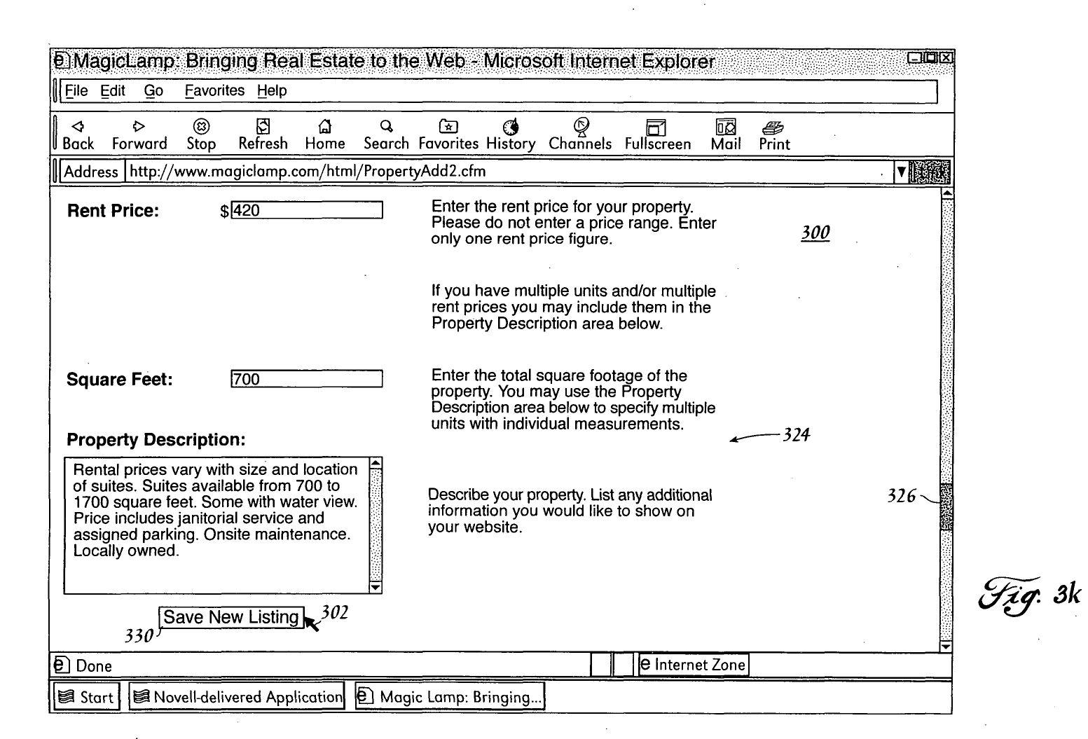

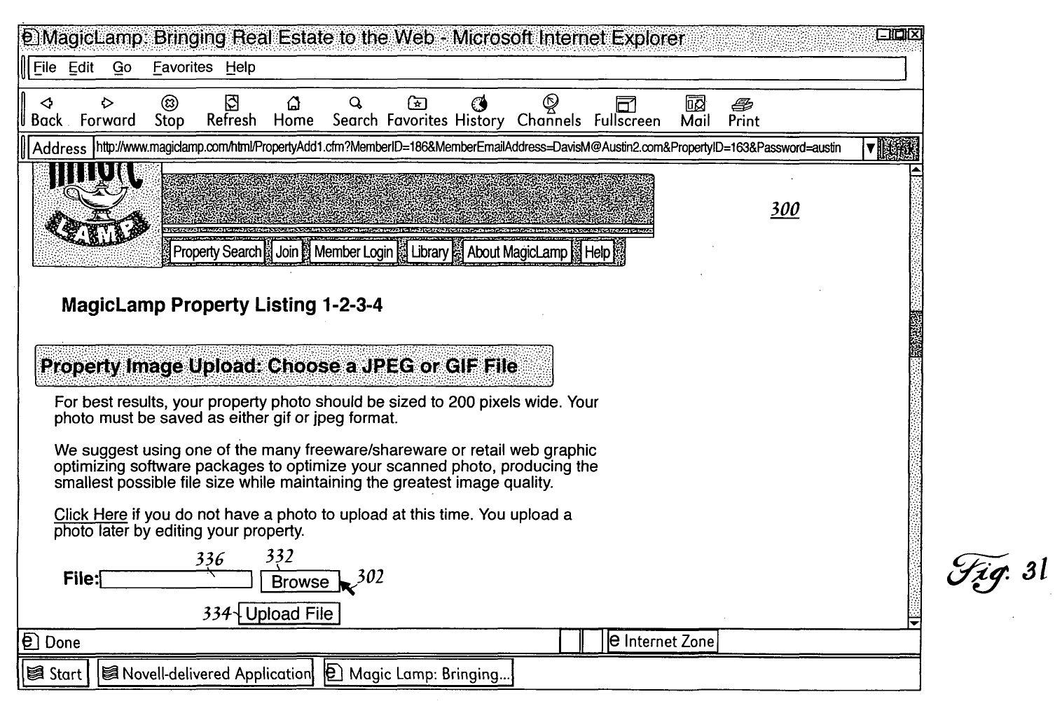

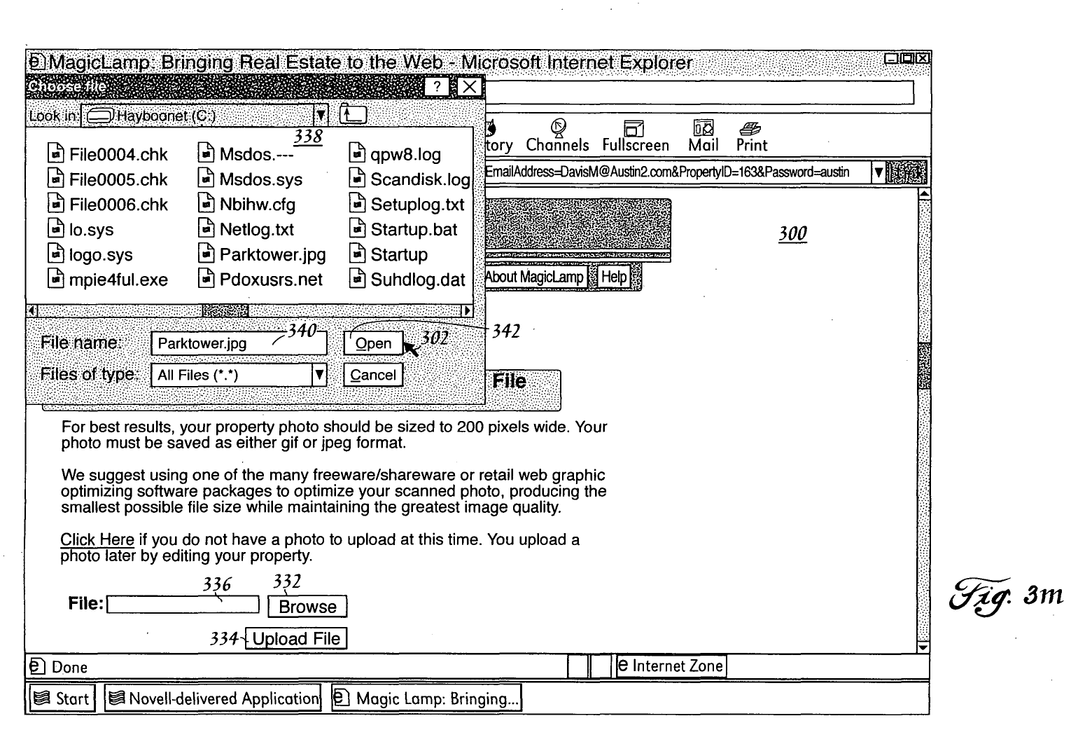

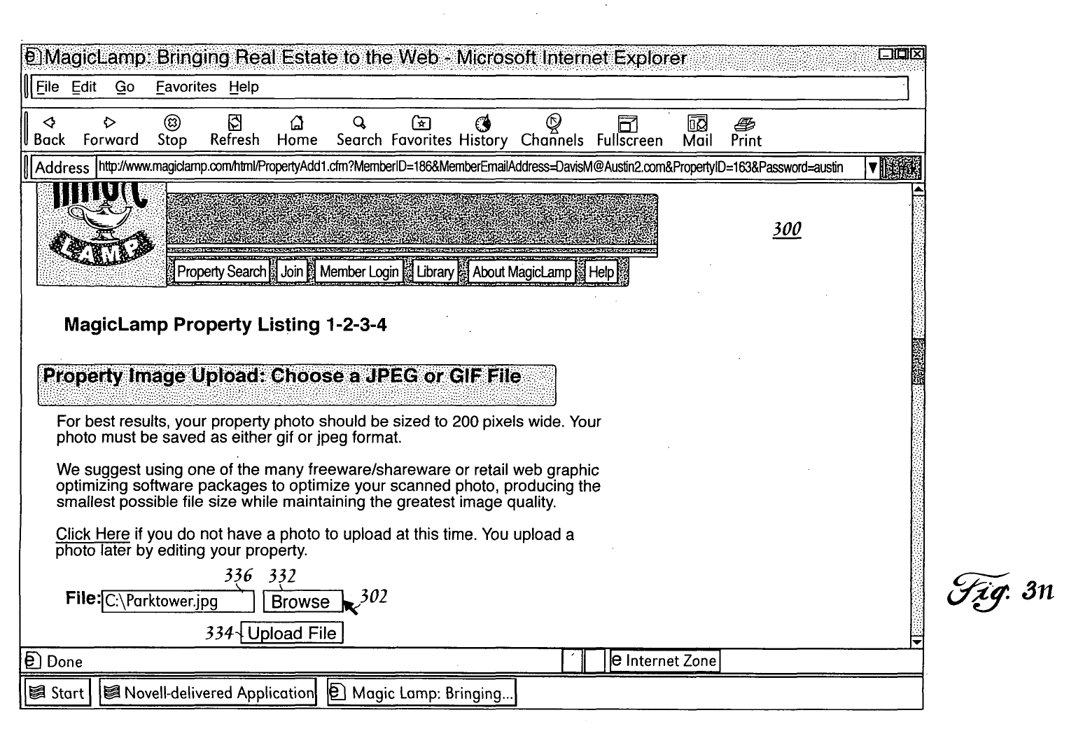

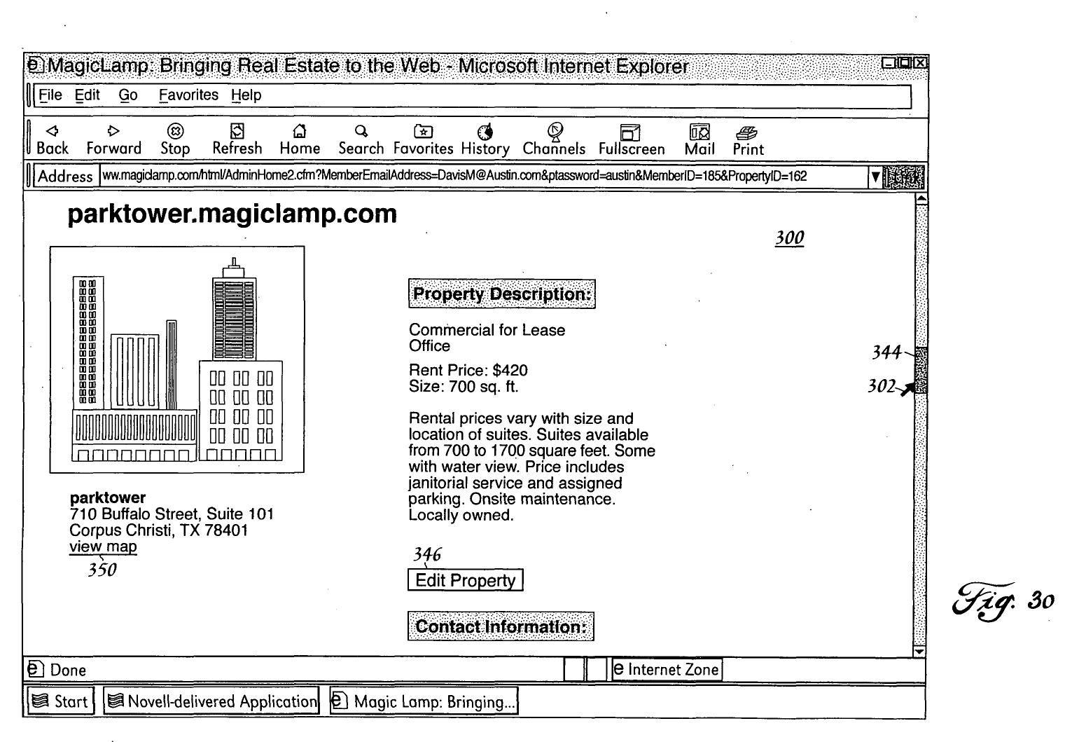

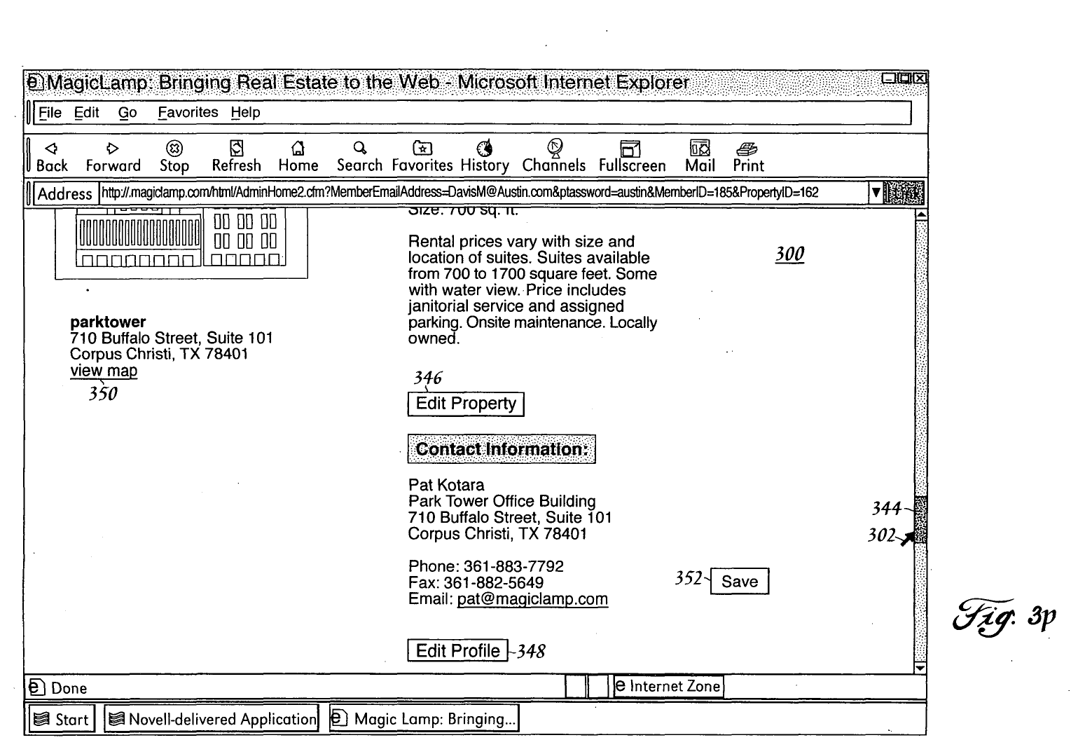

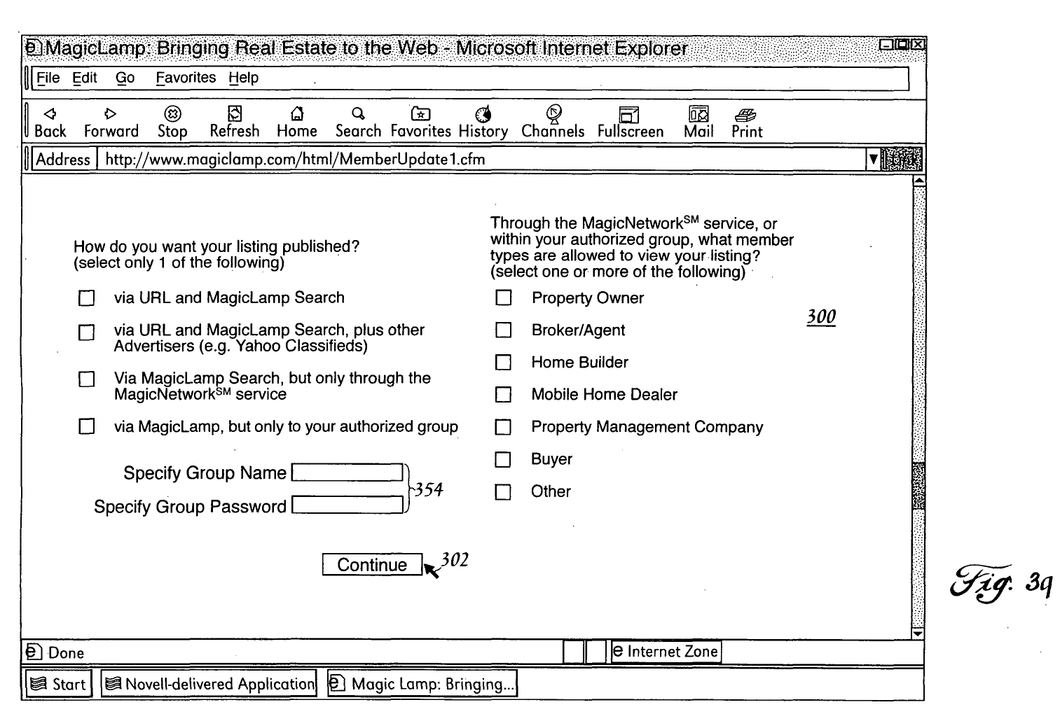

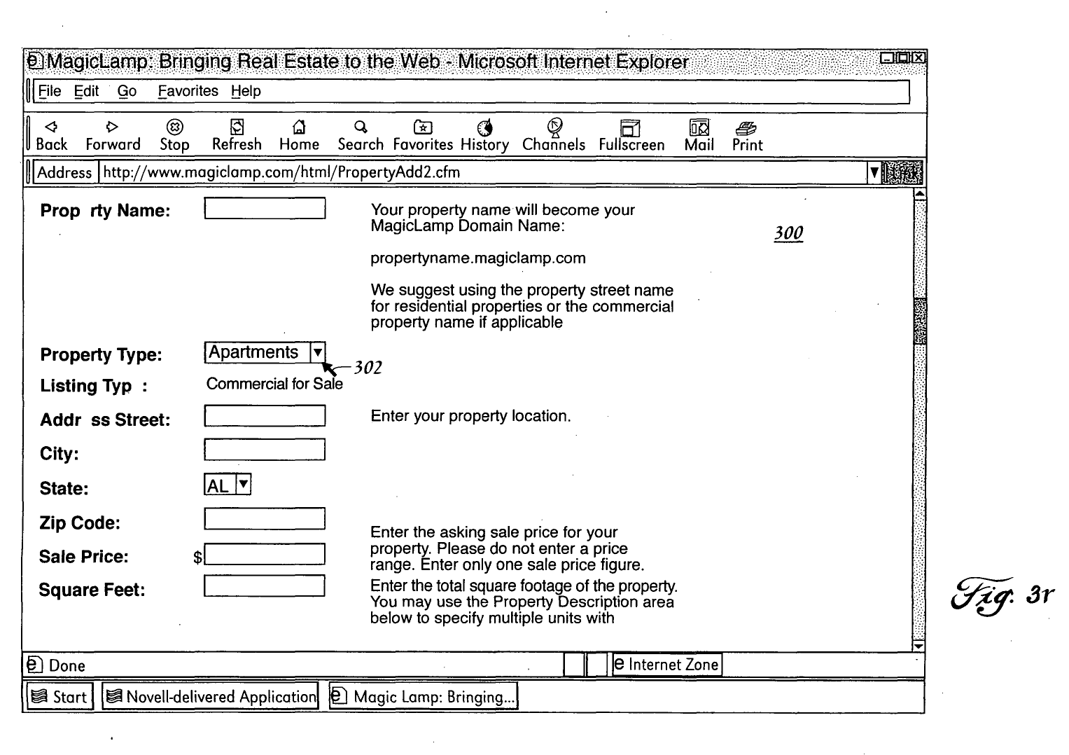

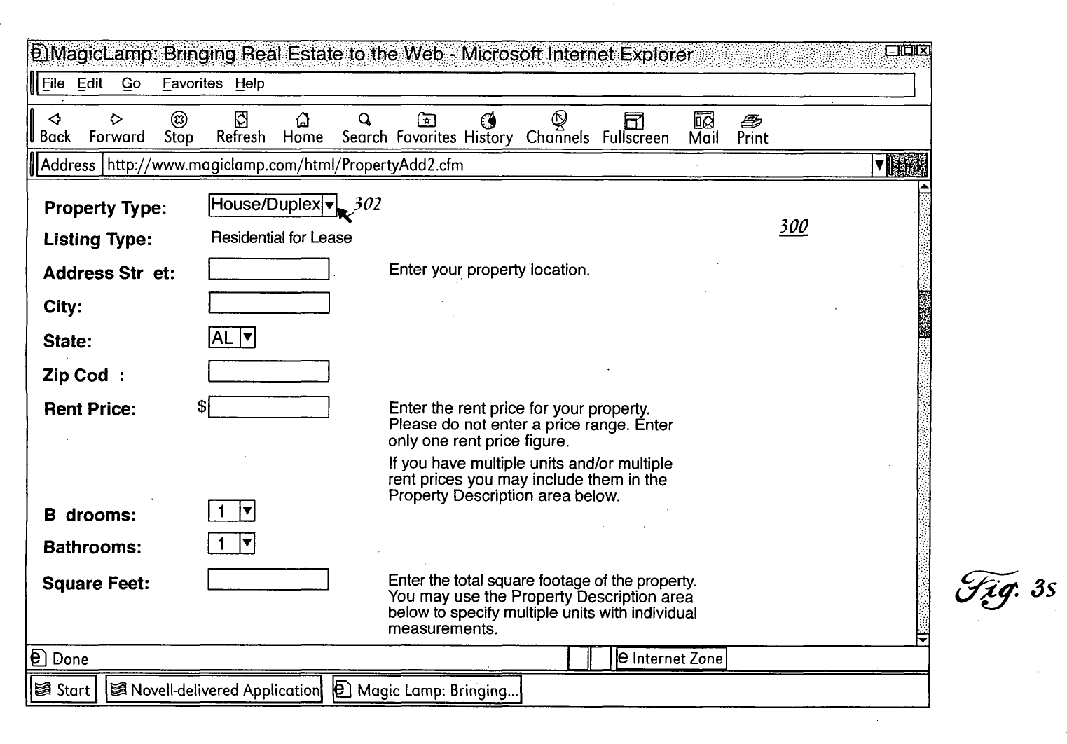

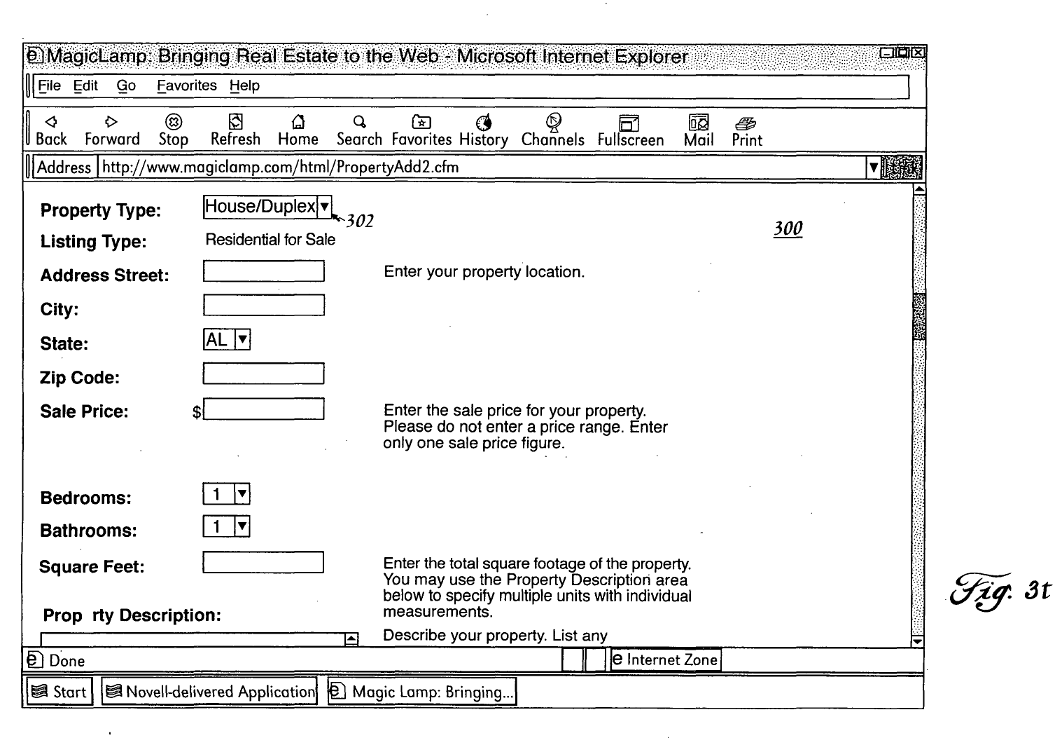

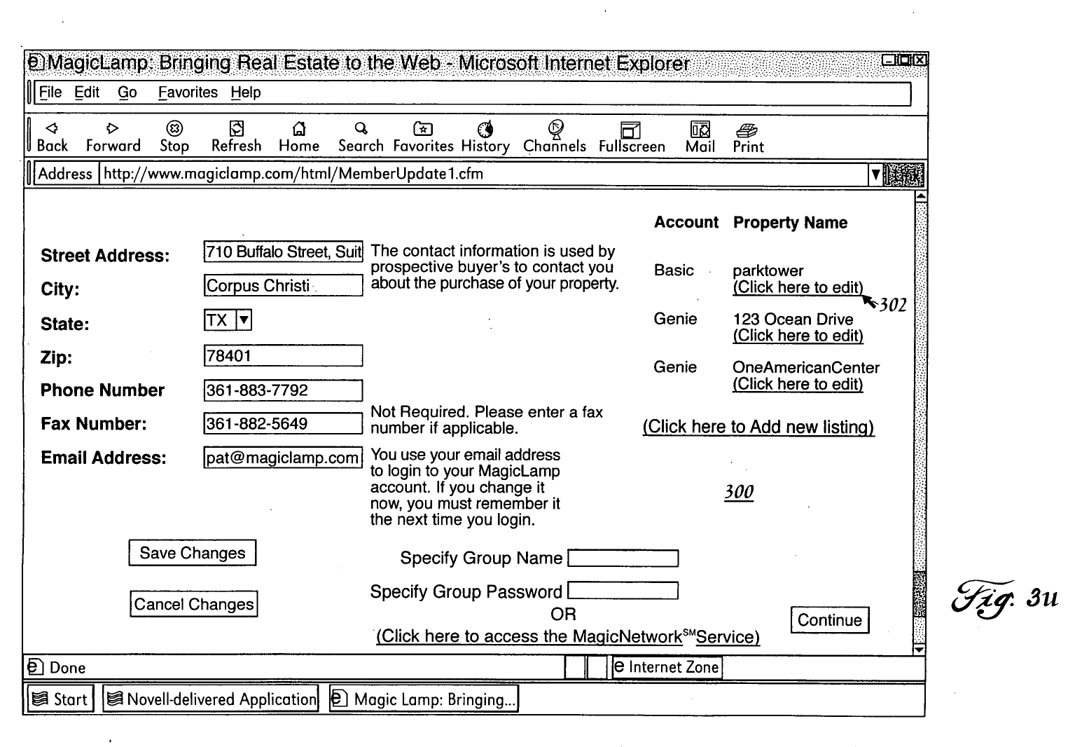

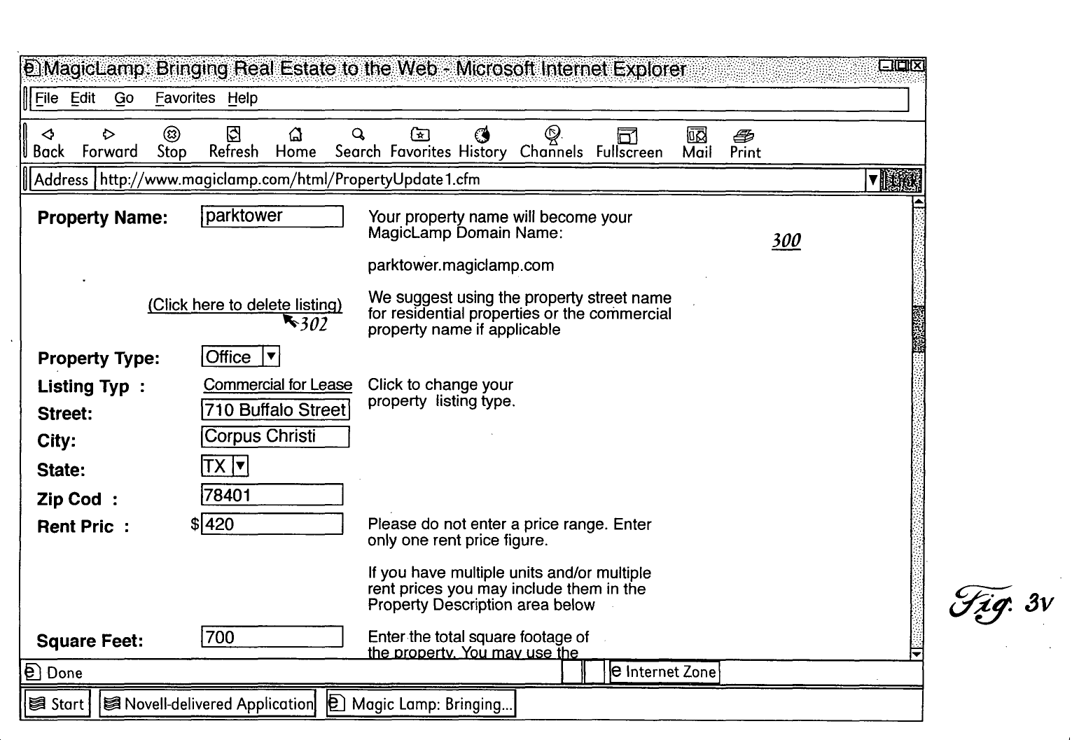

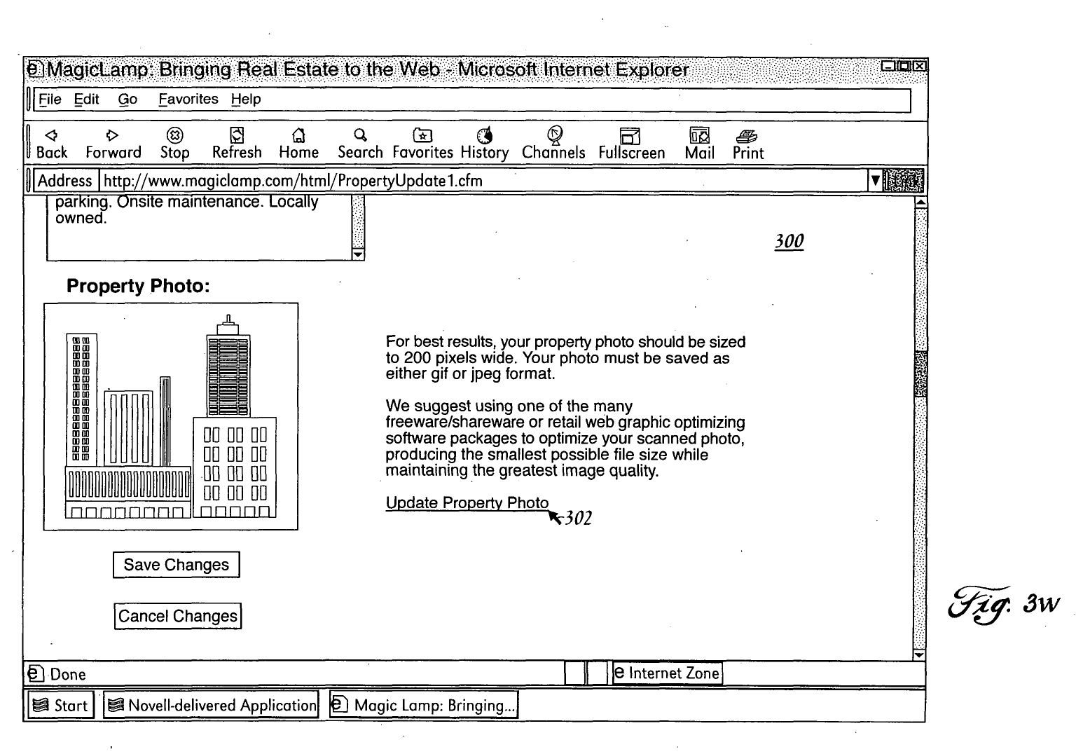

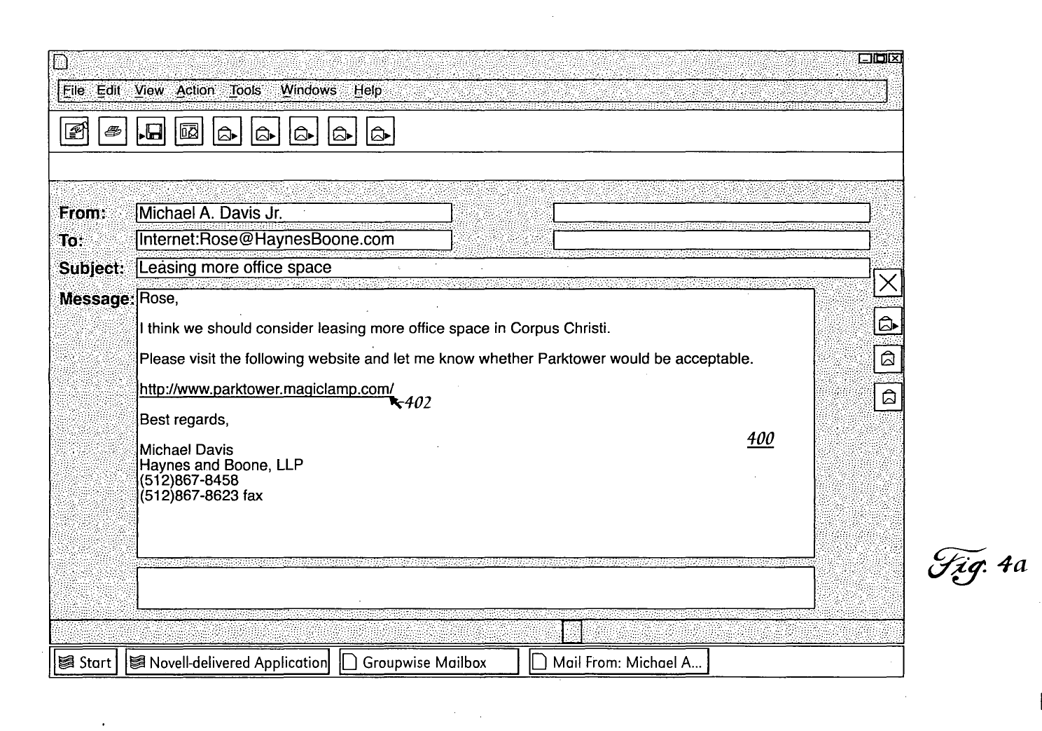

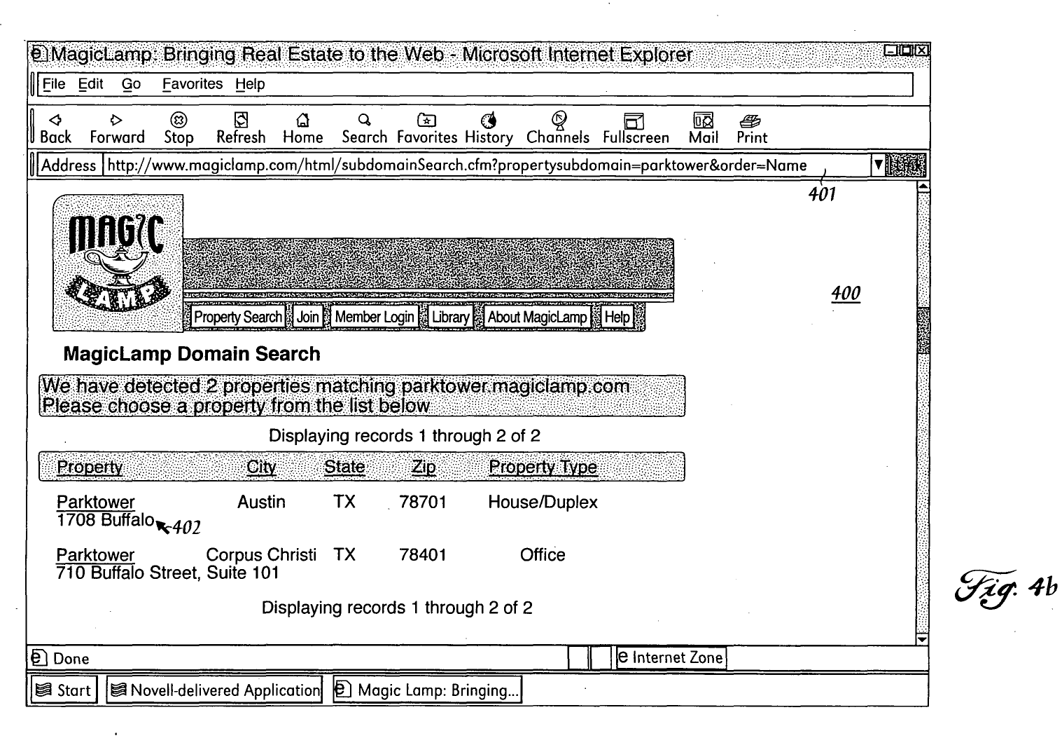

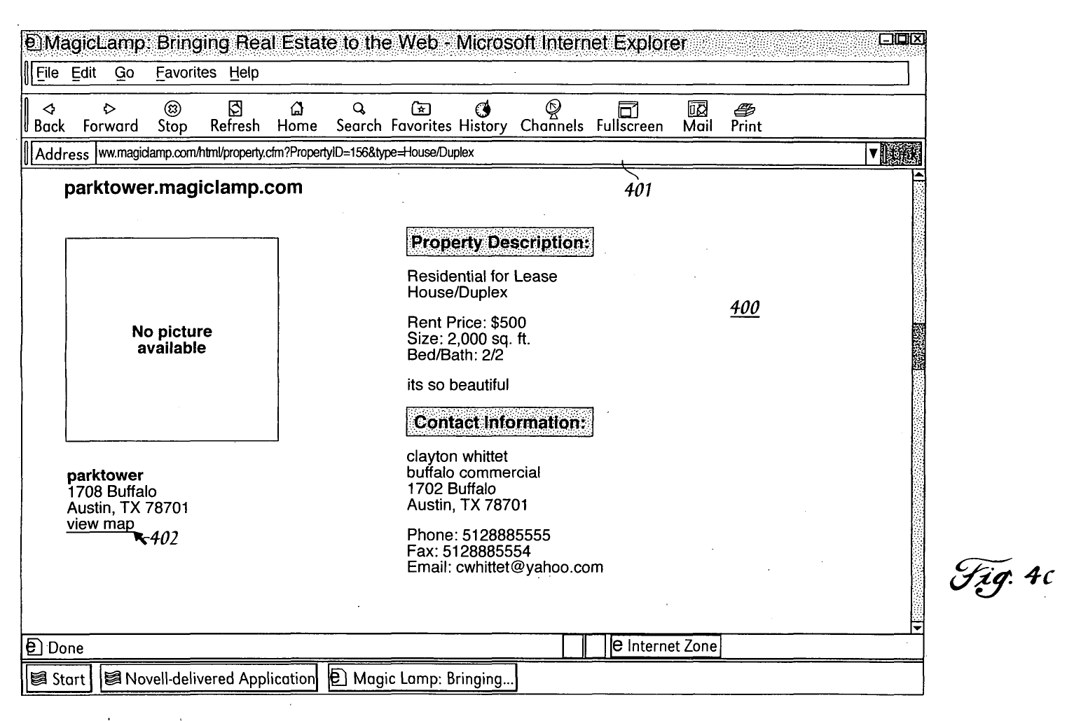

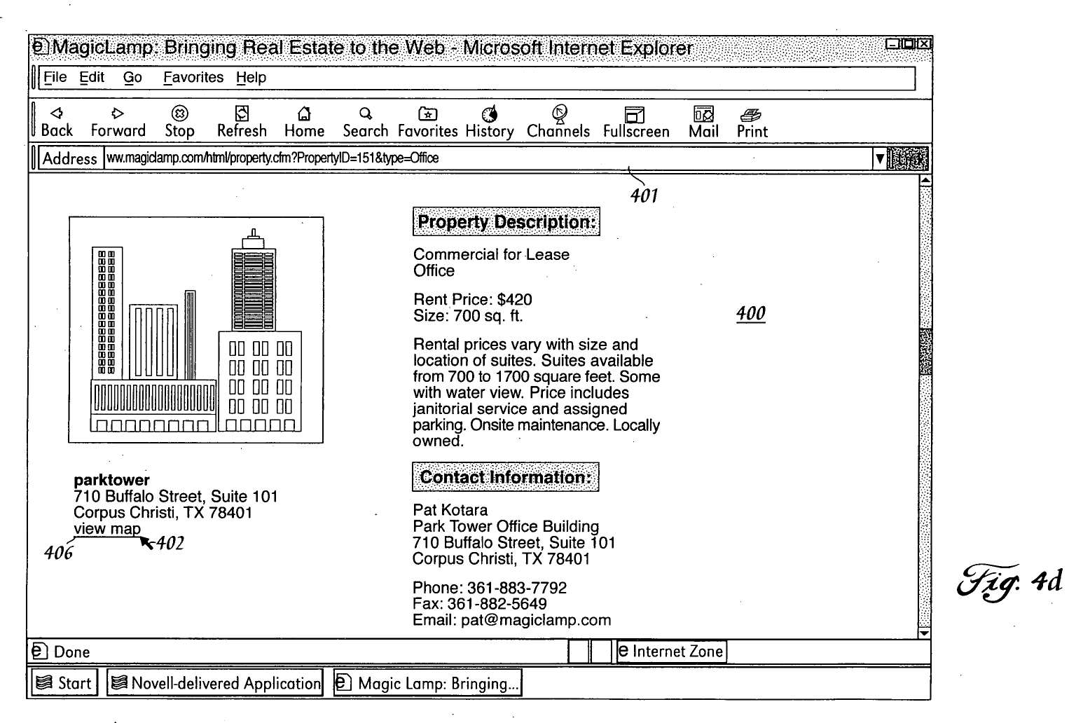

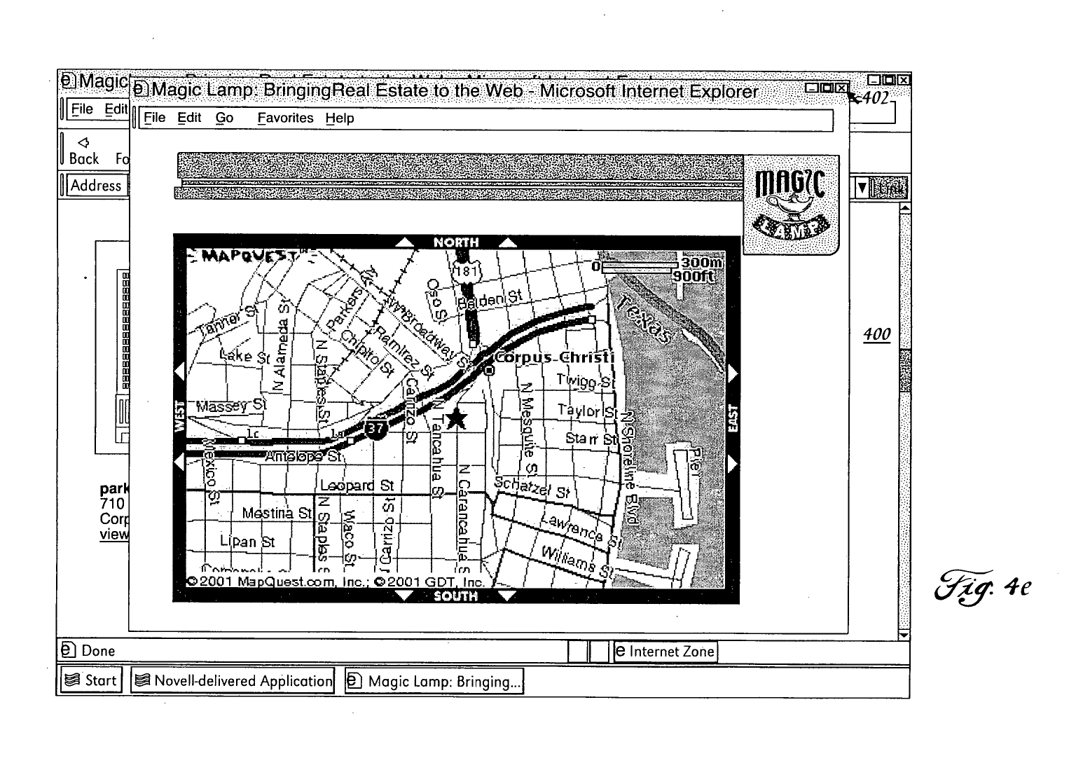

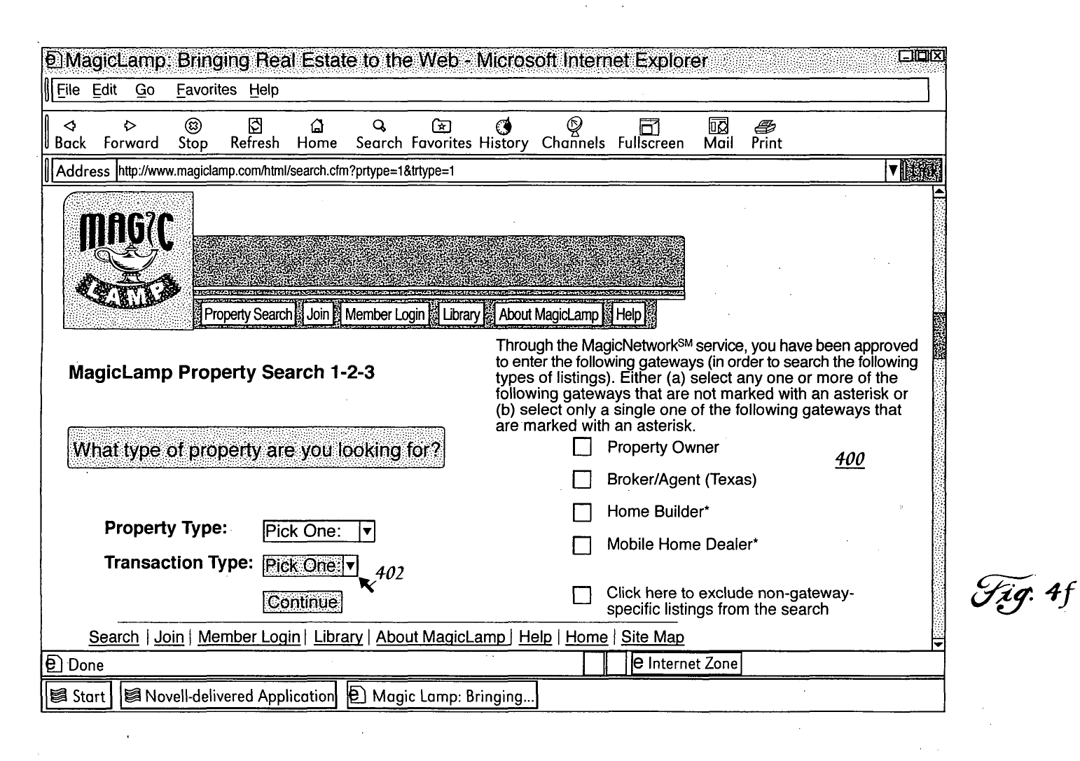

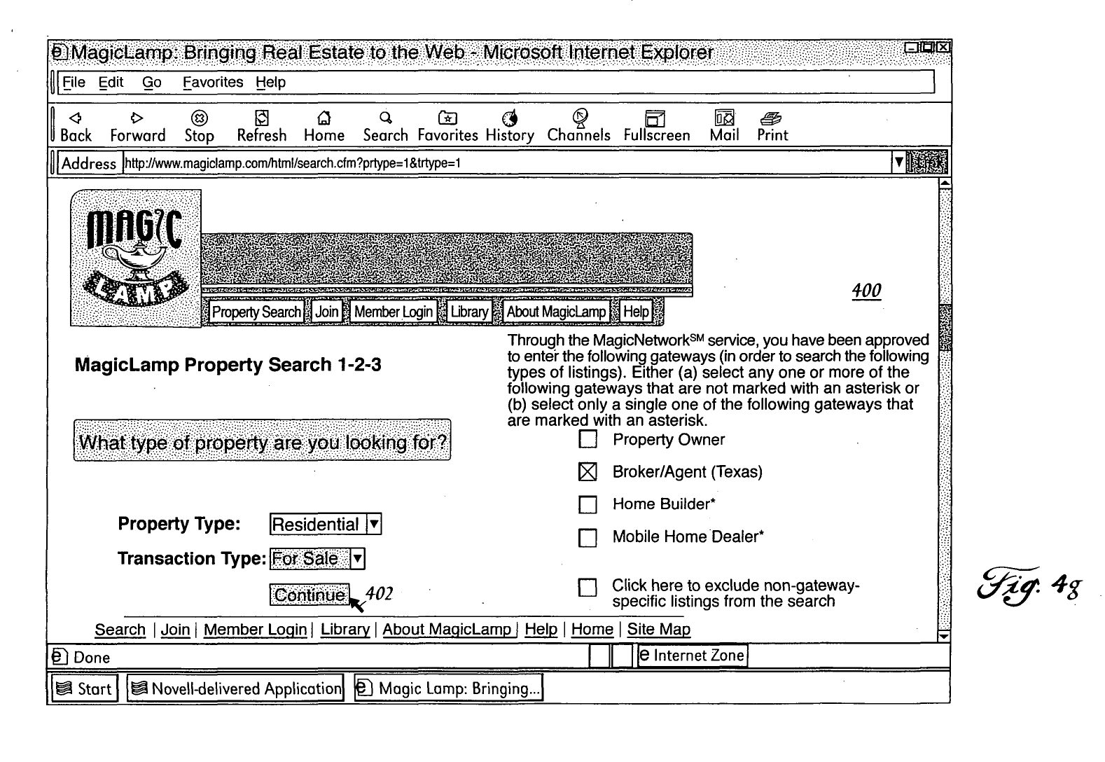

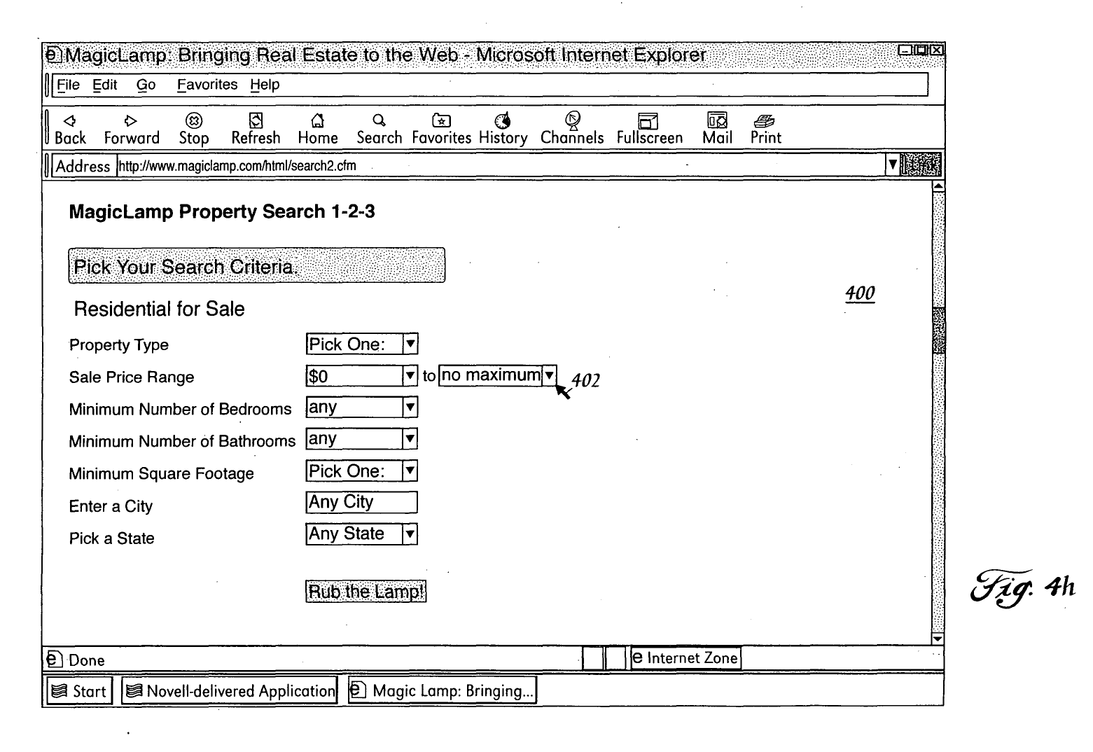

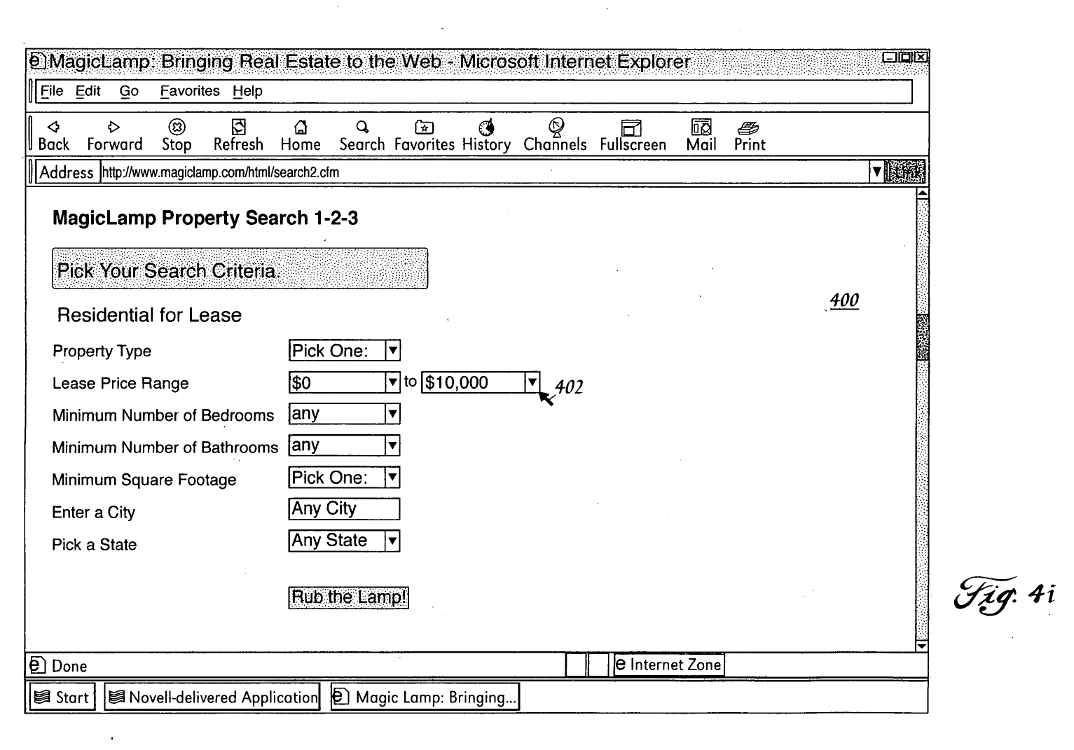

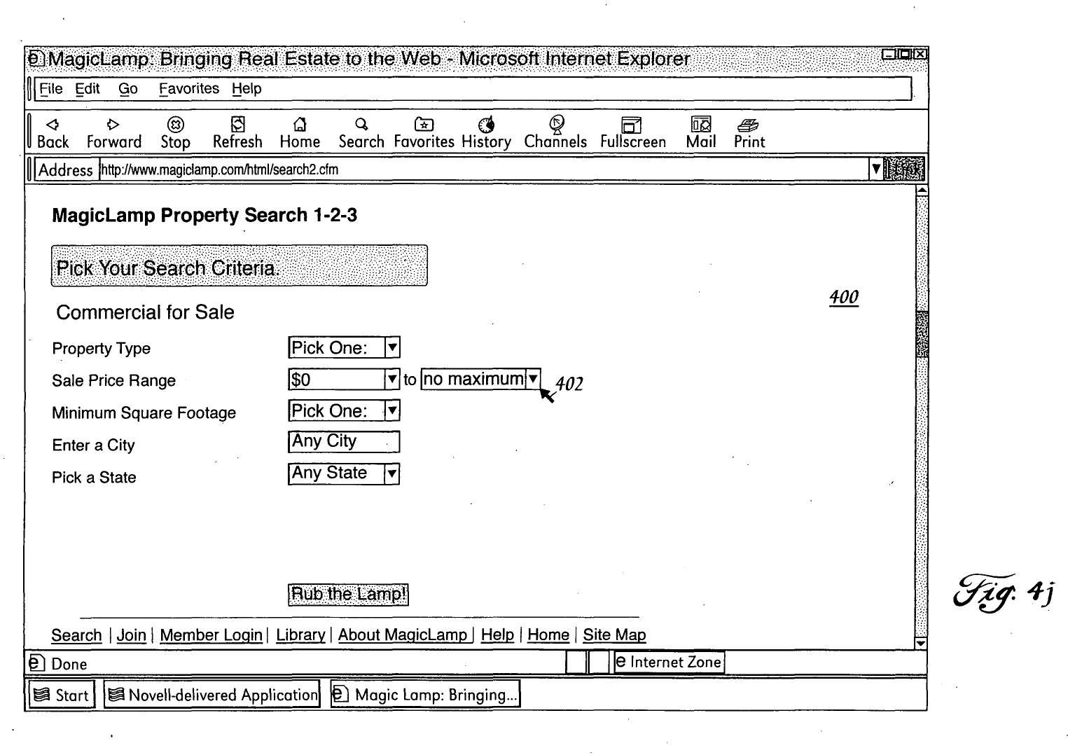

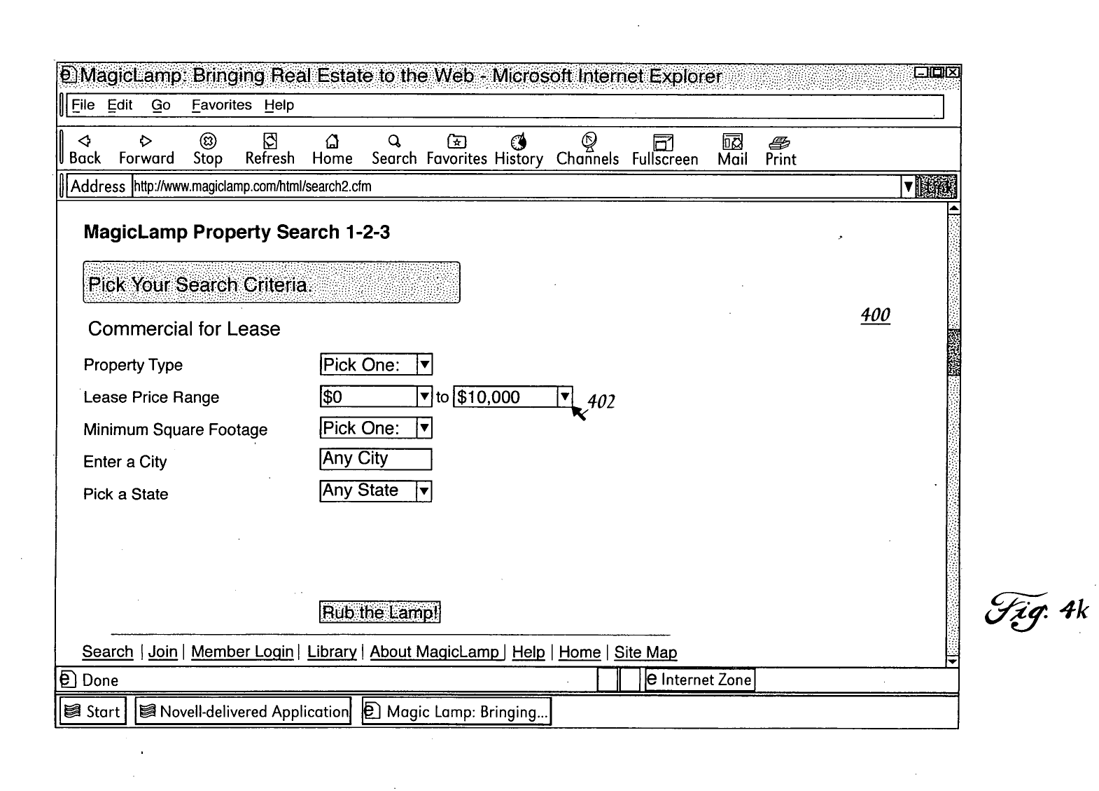

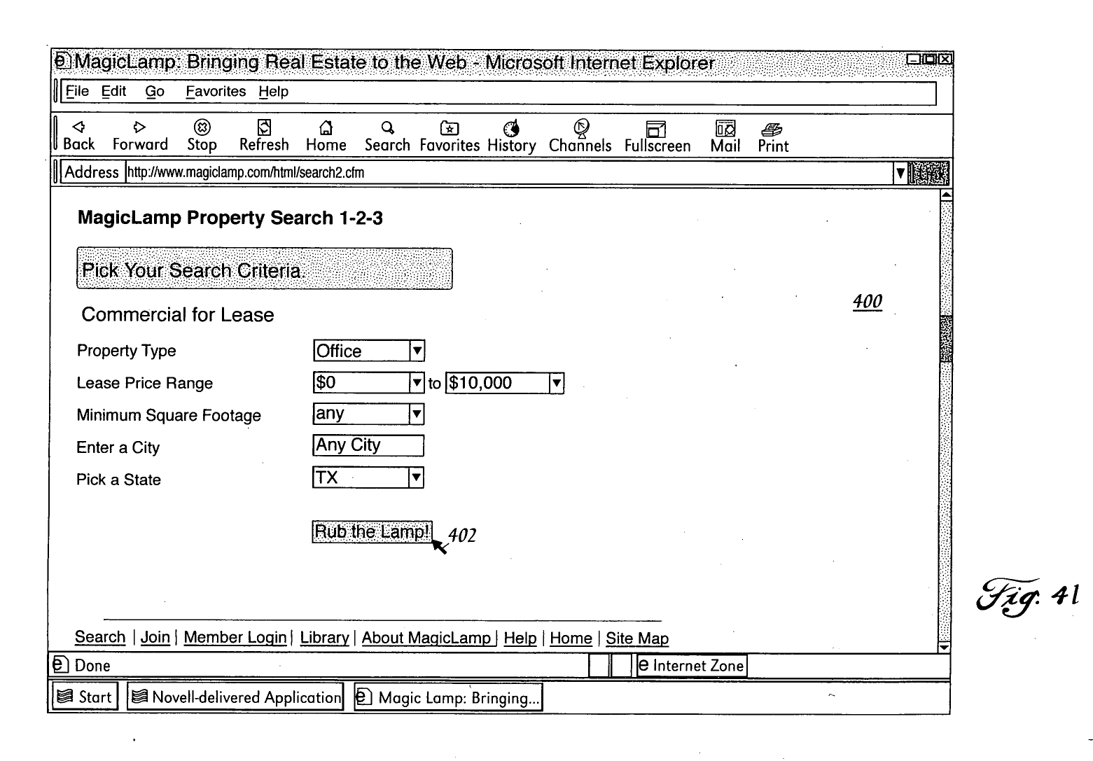

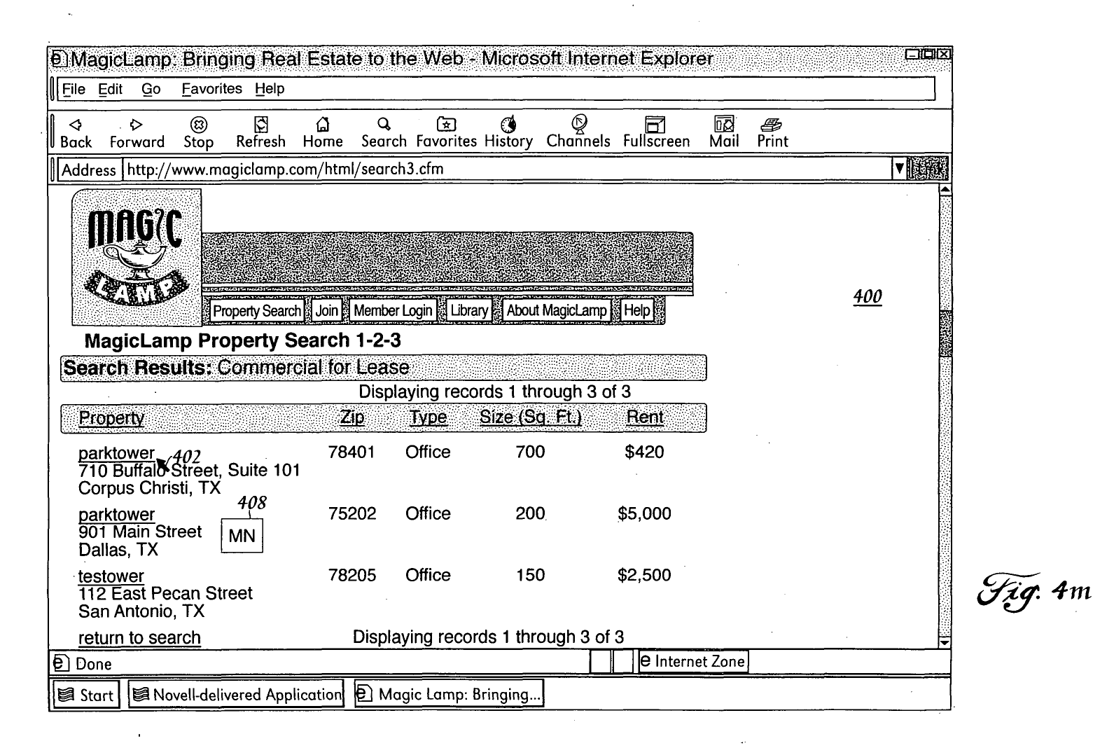

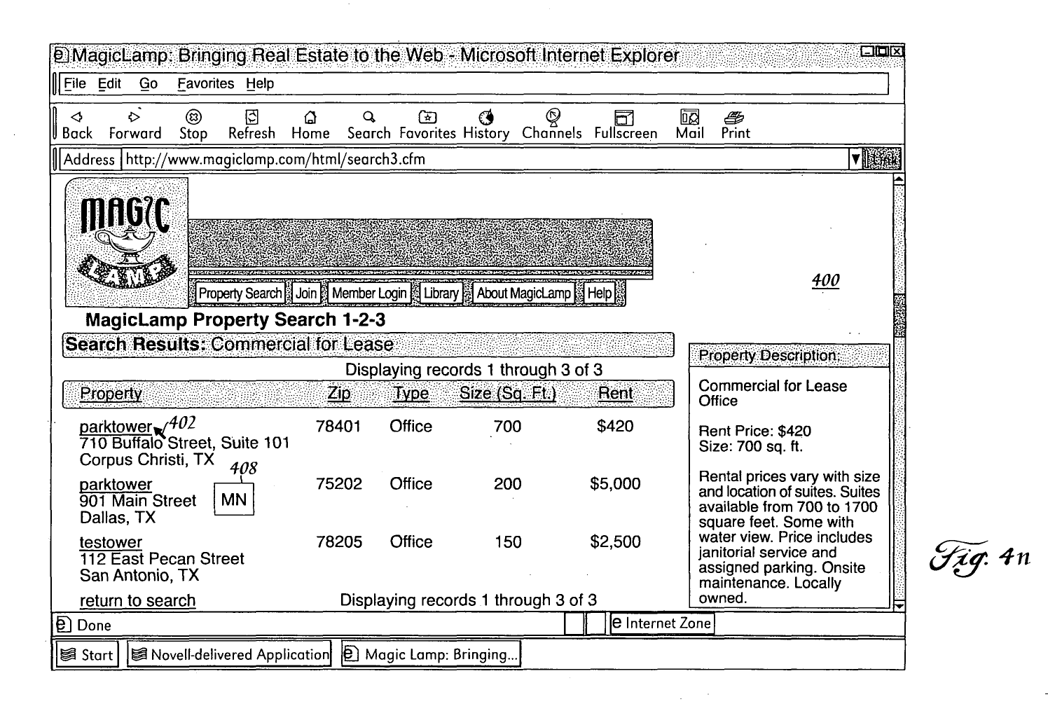

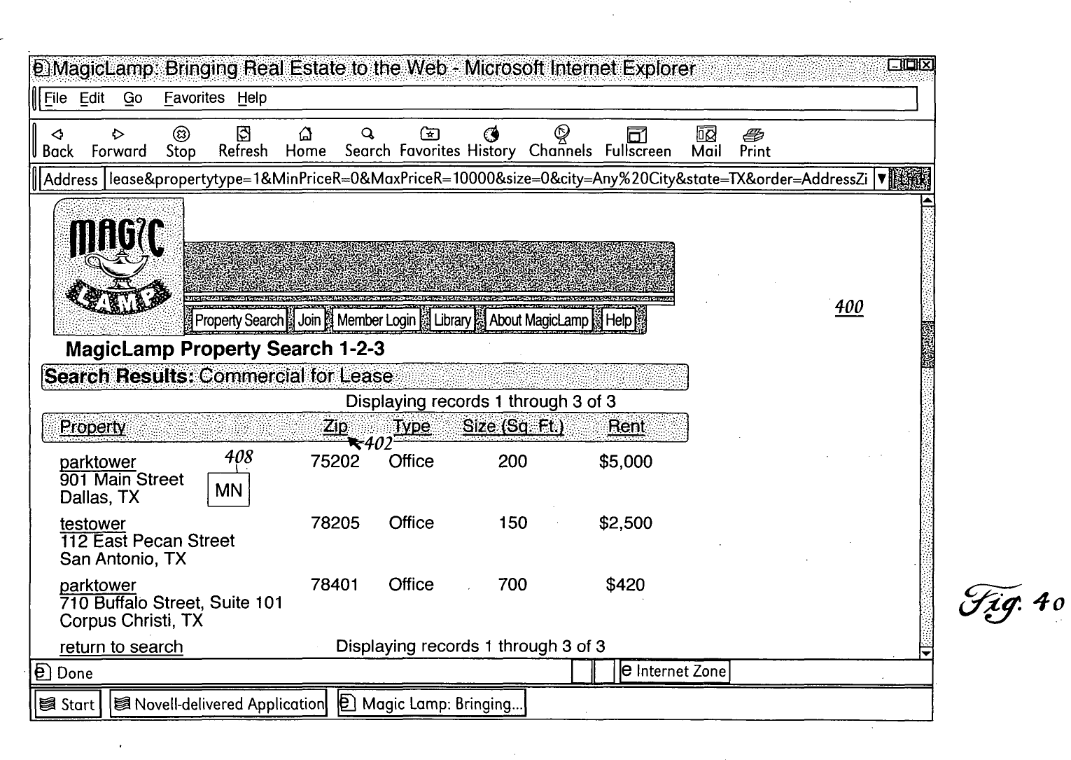

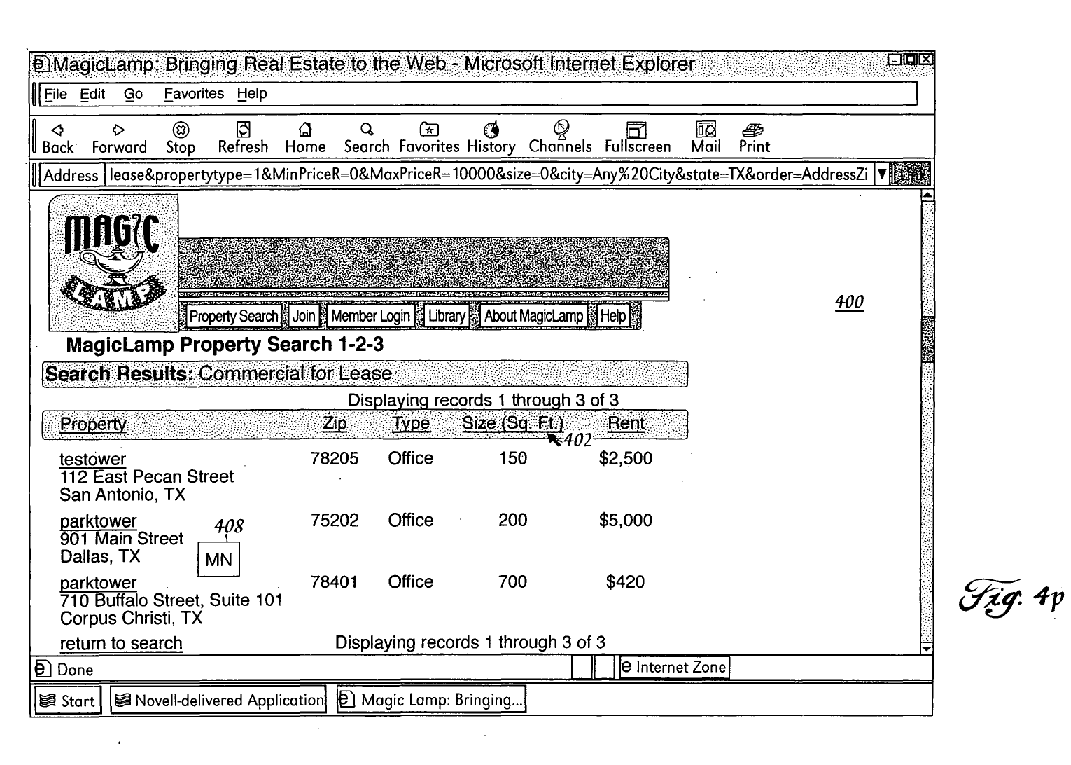

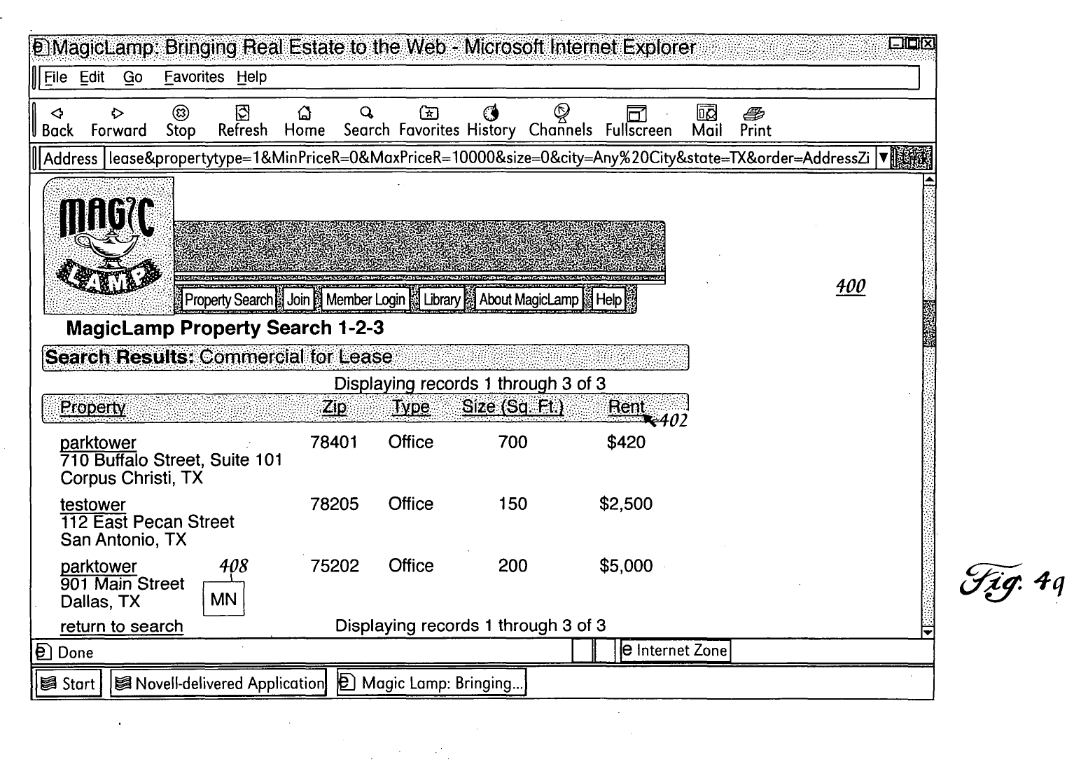

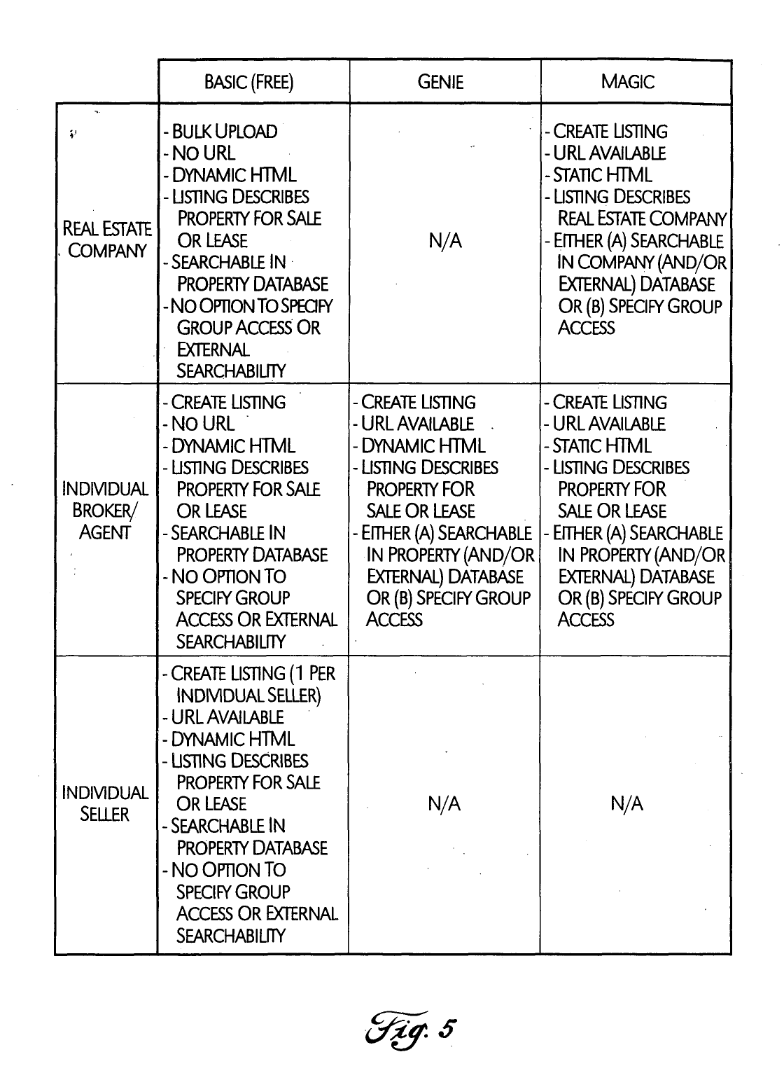

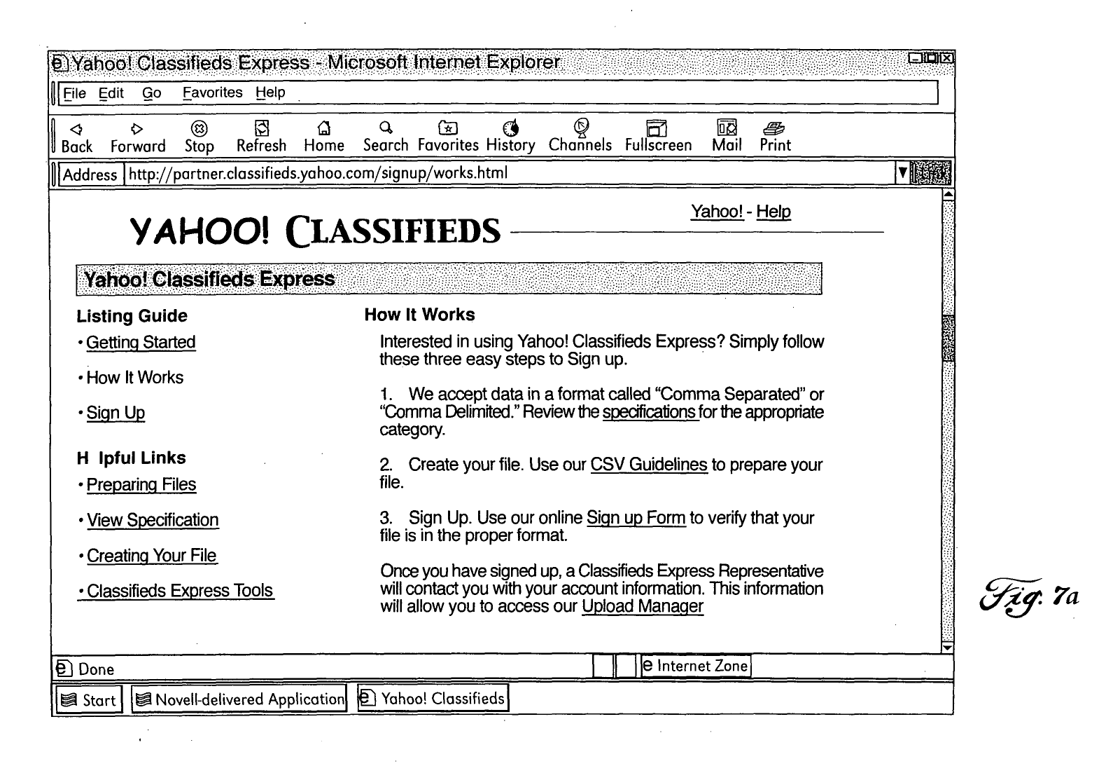

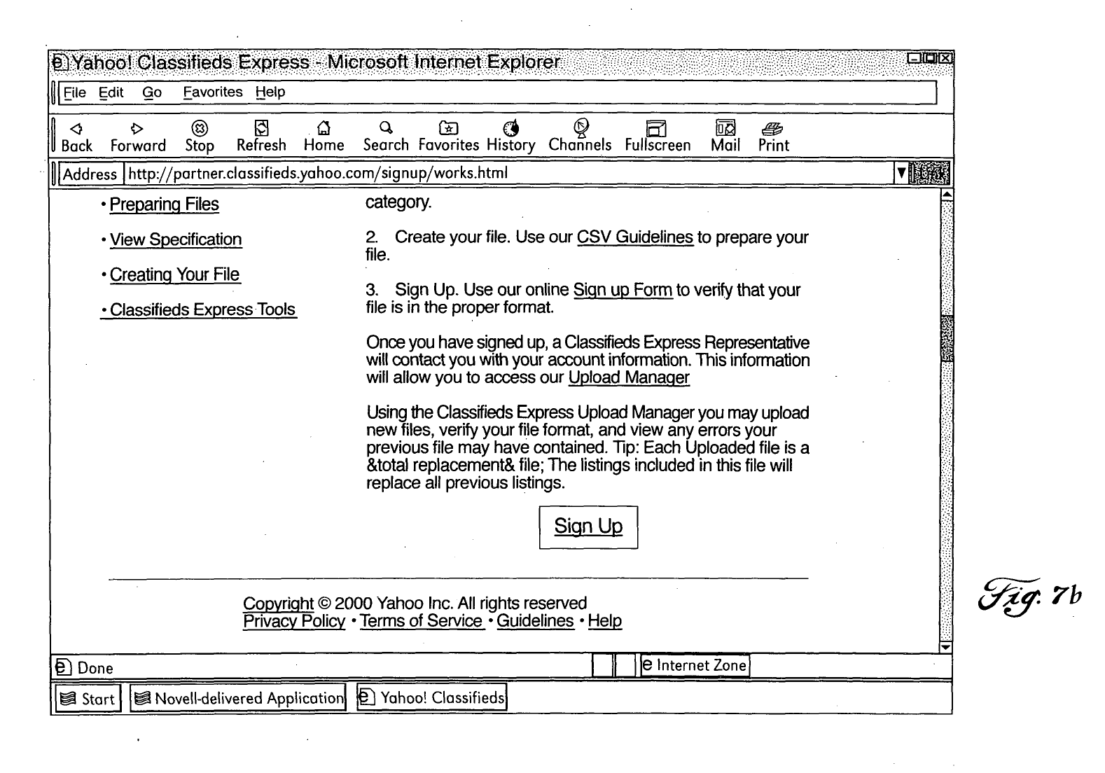

As shown in FIG. 1, system 100 includes (a) sellers 102 and 104, each for executing a respective seller process as discussed further hereinbelow in connection with FIGS. 3a-w, (b) buyers 106, 108 and 110, each for executing a respective buyer process as discussed further hereinbelow in connection with FIGS. 4a-q, (c) a website server 112 for executing a website process as discussed further hereinbelow in connection with FIGS. 3a-w, 4a-q, 5 and 6a-i, and (d) an advertiser 114 for executing an advertiser process as discussed further hereinbelow in connection with FIGS. 7a-b. Further, system 100 includes (a) a global computer network 116, such as a Transport Control Protocol/Internet Protocol (“TCP/IP”) network 116 (e.g. the Internet or an intranet), and (b) network routers 118, 120 and 122, which are connected to network 116 as shown in FIG. 1.

Each of sellers 102 and 104, buyers 106, 108 and 110, website server 112, and advertiser 114 includes a respective network interface for communicating with network 116 (i.e. outputting information to, and receiving information from, network 116), such as by transferring information (e.g. instructions, data, signals) between such seller (or buyer or website server or advertiser) and network 116. Accordingly, through network 116, website server 112 communicates with (a) sellers 102 and 104, (b) buyers 106, 108 and 110, (c) advertiser 114, and vice versa. Network routers 118, 120 and 122 assist in managing such communications (through network 116) between website server 112 and (a) sellers 102 and 104, (b) buyers 106, 108 and 110, and (c) advertiser 114.

In that manner, website server 112 is coupled through network router 118, network 116, and network routers 120 and 122 to each of sellers 102 and 104, buyers 106, 108 and 110, and advertiser 114. As shown in FIG. 1, website server 112 and network router 118 communicate with one another through a conventional “ethernet” connection. Similarly, seller 104 and network router 120 communicate with one another through a conventional ethernet connection. Likewise, advertiser 114 and network router 122 communicate with one another through a conventional ethernet connection.

For clarity, FIG. 1 depicts only two sellers 102 and 104, although system 100 may include additional sellers which may be substantially identical to one another. Similarly, for clarity, FIG. 1 depicts only three buyers 106, 108 and 110, although system 100 may include additional buyers which may be substantially identical to one another. Likewise, for clarity, FIG. 1 depicts only one advertiser, although system 100 may include additional advertisers which may be substantially identical to one another. For explanatory purposes, seller 102 is a representative one of the sellers, buyer 106 is a representative one of the buyers, and advertiser 114 is a representative one of the advertisers.

Each of sellers 102 and 104, buyers 106, 108 and 110, website server 112, advertiser 114, and network 116, is a computing system that includes at least one respective computing device (e.g. computer) for executing a respective process and performing respective operations (e.g. processing and communicating information) in response thereto as discussed further hereinbelow. Each such computing system and computing device is formed by various electronic circuitry components. Moreover, as shown in FIG. 1, all such computing systems and computing devices are coupled to one another.

In the illustrative embodiment, the computing devices of seller 102, and of buyers 106 and 108, are personal computers (e.g. IBM-compatible personal computers (“PCs”)) that execute Microsoft Windows operating system (“OS”) software. All Microsoft products identified herein are available from Microsoft Corporation, One Microsoft Way, Redmond, Wash. 98052-6399, telephone (425) 882-8080.

Also, in the illustrative embodiment, the computing device of buyer 110 is a portable battery-powered handheld computing device that executes Microsoft Windows CE OS software. For example, in one embodiment, the computing device of buyer 110 is a Palm electronic organizer available from Palm Computing, Inc, a 3Com company, 5400 Bayfront Plaza, Mail Stop #10112, P.O. Box 58007, Santa Clara, Calif. 9505-8007, telephone (408) 330-9000.

Buyer 110 further includes a wireless telecommunications modem. Accordingly, via an antenna of buyer 110, buyer 110 is operable to output (e.g. uplink) and receive (e.g. downlink) information to and from network 116 through a public wireless telecommunications network. In an alternative embodiment, buyer 110 is a portable battery-powered telephone having an integral computing device (e.g. a “smartphone”) and display device, such as a Motorola i1000plus handset available from Motorola, Inc., www.Motorola.com.

Moreover, in the illustrative embodiment, the computing devices of seller 104, website server 112, advertiser 114, and network 116 are server computers that execute Microsoft Windows NT OS software. Alternatively, any one or more of the computing devices of system 100 is any type of computer that executes any type of OS.

Advantageously, buyer 110 is able to access network 116 from a remote location. In one example, a human buyer is able to transport buyer 110 within an automobile while shopping for real estate. Also, a human seller may place a physical sign on a piece of real estate, in order to advertise the real estate as being for sale or lease.

The physical sign may include a website address (e.g. of server 112) where information is stored about the piece of real estate. Accordingly, if the human buyer sees the website address on the physical sign while shopping for real estate, the human buyer is able to operate buyer 110 within the automobile for specifying and accessing the website address through network 116. In that manner, the human user is able to view the information (i.e. stored at the website address, e.g. of server 112) about the piece of real estate.

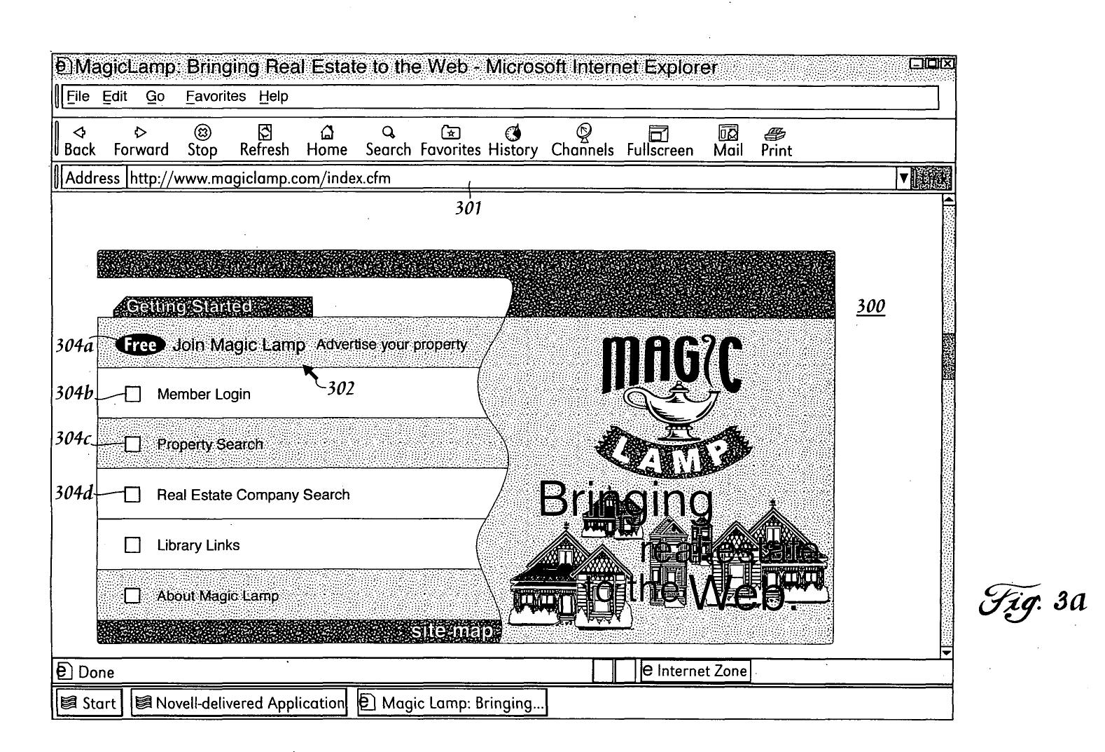

FIG. 2 is a block diagram of a representative one of the computing systems of system 100. Such representative computing system is indicated by dashed enclosure 200. Each of the computing systems of system 100 operates in association with a respective human user. Accordingly, in the example of FIG. 2, computing system 200 operates in association with a human user 202, as discussed further hereinbelow. For clarity, FIG. 2 is not drawn to scale.

As shown in FIG. 2, computing system 200 includes (a) a computer 204 for executing and otherwise processing instructions, (b) input devices 206 for receiving information from human user 202, (c) a display device 208 (e.g. a conventional electronic cathode ray tube (“CRT”) device) for displaying information to user 202, (d) optionally, a print device 210 (e.g. a conventional electronic printer or plotter), (e) a computer-readable medium (or apparatus) 212 (e.g. a portable floppy diskette, hard disk, or other nonvolatile storage device) for storing information, as discussed further hereinbelow, (f) optionally, another computer-readable medium (or apparatus) 214 for storing information, and (g) various other electronic circuitry for performing other operations of computing system 200.

For example, computer 204 includes (a) a network interface (e.g. circuitry) for communicating between computer 204 and network 116 and (b) a memory device (e.g. random access memory (“RAM”) device and read only memory (“ROM”) device) for storing information (e.g. instructions executed by computer 204 and data operated upon by computer 204 in response to such instructions). Accordingly, as shown in FIG. 2, computer 204 is connected to network 116, input devices 206, display device 208, print device 210, computer-readable medium 212, and computer-readable medium 214.

For example, in response to signals from computer 204, display device 208 displays visual images, and user 202 views such visual images. Moreover, user 202 operates input devices 206 for outputting information to computer 204, and computer 204 receives such information from input devices 206. Also, in response to signals from computer 204, print device 210 prints visual images on paper, and user 202 views such visual images.

Input devices 206 include, for example, a conventional electronic keyboard and a pointing device such as a conventional electronic “mouse”, rollerball or light pen. User 202 operates the keyboard to output alphanumeric text information to computer 204, and computer 204 receives such alphanumeric text information from the keyboard. User 202 operates the pointing device to output cursor-control information to computer 204, and computer 204 receives such cursor-control information from the pointing device. The input devices of buyer 110 include, for example, touch-sensitive circuitry of a liquid crystal display (“LCD”) display device.

FIG. 3a is an illustration of a visual image (or “screen”), indicated generally at 300, displayed by a display device (such as display device 208) of a seller (such as seller 102) or buyer (such as buyer 106) of system 100. Likewise, FIGS. 3b-w are illustrations of other screens 300 displayed by the computing system's display device. Similarly, FIGS. 4a-q are illustrations of screens, indicated generally at 400, displayed by a display device (such as display device 208) of a buyer or seller of system 100. In the course of performing operations that are discussed further hereinbelow in connection with FIGS. 3a-w, 4a-q, 5 and 6a-i, website server 112 (a) writes information for storage in a database of its computer-readable medium and (b) reads information that has been previously stored in such database.

As indicated in FIG. 3a, a computer (such as computer 204) executes browser software, such as Microsoft Internet Explorer software. Screen 300 includes a Uniform Resource Locator (“URL”) field 301, which is a region of screen 300 in which a user (such as user 202) is able to specify a URL address. In FIG. 3a, the user-specified URL address is http://www.magiclamp.com, which specifies the route to a file on website server 112 (which is a global computer network facility). A user specifies the URL address by selecting URL field 301 and specifying alphanumeric character information of the URL address for display within URL field 301.

For example, a user selects URL field 301 by (a) operating the computing system's pointing device (such as the pointing device of input devices 206) to position a cursor 302 overlapping with URL field 301 and (b) after so positioning cursor 302, activating a switch of the pointing device. Such selection of a region (such as URL field 301) of screen 300 by a user is hereinafter referred to as the user “clicking” such region.

After clicking (or “selecting”) URL field 301, a user is able to specify alphanumeric character information of the URL address for display within URL field 301. For example, a user specifies such information by operating the computing system's electronic keyboard (such as the electronic keyboard of input devices 206), so that screen 300 displays such information within the selected field (such as URL field 301). Such operation of the electronic keyboard by a user is hereinafter referred to as the user “typing” such information.

After a user specifies the URL address, the user is able to cause the computer to output (or “transmit” or “send”) the URL address to network 116, as for example by pressing an “Enter” key of the computing system's electronic keyboard. In response to such transmission of the URL address, network 116 communicates with website server 112 through network router 118. Website server 112 detects such communication (which is a request for initial screen 300 of FIG. 3a).

In response thereto, website server 112 outputs one or more signals (such as HyperText Markup Language (“HTML”) commands or EXtensible Markup Language (“XML”) commands) to the computer. Accordingly, through network 116 and network router 118, the computer receives such signals from website server 112. In response thereto, the computer outputs one or more signals to the computing system's display device, so that the display device displays initial screen 300 of FIG. 3a.

Moreover, as shown in URL field 301 of FIG. 3a, website server 112 (in response to its programmed instructions and data) automatically redirected the user-specified URL address from http://www.magiclamp.com to http://www.magiclamp.com/index.cfm. In response to such redirection, website server 112 outputs one or more signals to the computer, which receives such signals through network 116 and network router 118. In response thereto, the computer outputs one or more signals to the computing system's display device, so that the display device (in URL field 301 of FIG. 3a) displays http://www.magiclamp.com/index.cfm as the URL address instead of http://www.magiclamp.com.

Similarly, in response to various actions by a user as discussed further hereinbelow in connection with FIGS. 3b-w, website server 112 (in response to its programmed instructions and data) outputs one or more signals through network 116 to the computer, so that the computing system's display device displays the versions of screen 300 (and the URL addresses of URL field 301) as shown in FIGS. 3b-w.

Referring to FIG. 3a, screen 300 includes a set of “buttons” 304a, 304b, 304c and 304d, which are regions of screen 300. Each button of screen 300 (e.g. each of buttons 304a, 304b, 304c and 304d) is individually clickable by a user. Button 304a is a “Join Magic Lamp” button, button 304b is a “Member Login” button, button 304c is a “Property Search” button, and button 304d is a “Real Estate Company Search” button. In response to a user clicking the “Join Magic Lamp” button 304a, as shown in FIG. 3a, the computer outputs at least one signal, resulting in a display of screen 300 of FIG. 3b by the computing system's display device.

In one example, the computer outputs such signal (which is a request for application screen 300 of FIG. 3b) to website server 112. In such example, website server 112 detects such signal. In response thereto, website server 112 outputs additional signals to the computer, resulting in the display of screen 300 of FIGS. 3b and 3c by the computing system's display device.

Accordingly, referring to FIGS. 3b and 3c, screen 300 includes a set of fields indicated generally at 306. As shown in FIGS. 3b and 3c, fields 306 are regions of screen 300 in which a user is able to specify alphanumeric character information, similar to the example of FIG. 3a hereinabove in which a user specified alphanumeric character information of the URL address for display within URL field 301. More particularly, in fields 306, a user is able to specify information about the user (e.g. the owner of real estate), such as the user's (a) first name, (b) last name, (c) company name, (d) member type, (e) street address, (f) city, (g) state, (h) ZIP code, (i) telephone number, (j) fax number, (k) e-mail address, and (l) password.

A user is able to view all of fields 306 by (a) clicking a scroll bar 308 and (b) while continuing to activate the switch of the computing system's pointing device, operating the pointing device to reposition scroll bar 308 within screen 300. Accordingly, in comparison to FIG. 3b, FIG. 3c shows scroll bar 308 after a user has repositioned it within screen 300.

Moreover, in a significant aspect of the illustrative embodiment, a user is able to click a button 310, as shown in FIG. 3b. Button 310 is associated with the “member type” field of fields 306. By clicking button 310, a user is able to select between a list of predetermined classes (or “categories”) of member types.

In the illustrative embodiment, the predetermined “member type” classes include (a) property owner, (b) broker/agent, (c) home builder, (d) mobile home dealer, (e) real estate company, (f) buyer, and (g) other. In that manner, system 100 efficiently categorizes the user into one of the predetermined “member type” classes. Advantageously, website server 112 is programmable to perform different operations in response to the user-selected “member type” class.

For example, website server 112 is programmable to output different signals through network 116 to the computer, in response to the user-selected “member type” class, so that the computing system's display device displays different versions of screen 300 according to the user-selected “member type” class, as discussed further hereinbelow in connection with FIGS. 3c and 3e-f. As shown in the example of FIG. 3c, the user-selected “member type” class is broker/agent, which is different than the default “member type” class shown in FIG. 3b. Accordingly, as shown in FIG. 3c, in response to the user-selected “member type” class being broker/agent, the computing system's display device displays a different version of screen 300 (according to the user-selected “member type” class) in response to signals from website server 112.

For example, in response to the user-selected “member type” class being broker/agent, the computing system's display device displays a set of fields indicated generally at 312. Fields 312 are a notification that describes an information structure associated with the user-selected broker/agent “member type” class. Accordingly, as shown in FIG. 3c, fields 312 are regions of screen 300 in which a user is able to specify additional alphanumeric character information.

More particularly, in fields 312, a user is able to specify additional information about the user, according to the information structure of the user-selected broker/agent “member type” class, such as the user's (a) real estate license number, (b) state in which the user is licensed as a real estate broker/agent, (c) credit card number for the user's payment of fees to the owner of the www.magiclamp.com Internet site, (d) credit card issuer (e.g. Visa, MasterCard, Discover, American Express), (e) cardholder's name (e.g. the user's name), (f) expiration month of the credit card, and (g) expiration year of the credit card. Notably, such fees can be variable according to the user's selected “member type” class.

FIG. 3c is an illustration of screen 300 after a user has specified information for display within fields 306. After a user has specified information for display within each of fields 306 and each of fields 312, a user is able to click a “Save” button 318, as shown in FIG. 3c. In response to a user clicking “Save” button 318, the computer outputs the user-specified information (of fields 306 and 312) to website server 112.

Website server 112 detects such user-specified information. In response to receiving the user-specified information, website server 112 (a) stores it in the database of website server 112 and (b) outputs additional signals through network 116 to the computer, resulting in the display of screen 300 of FIG. 3a by the computing system's display device.

In a significant aspect of the illustrative embodiment, by specifying alphanumeric character information in fields 306 of screen 300, the user is able to “register” within a particular “gateway” of system 100. Advantageously, each such gateway registration is specific to the user's particular “member type” class. In at least some situations, the user's particular “member type” class indicates a geographical aspect of the user. For example, in FIGS. 3b and 3c, the user registers within the gateway for real estate broker/agents that are licensed in Texas.

Likewise, the user is able to register within additional gateways by repeating the process of FIGS. 3a, 3b and 3c for different “member type” classes. For example, the user is able to register within an additional gateway for real estate broker/agents that are licensed in any other state. Notably, the credit card information specified by the user in fields 312 is specific to the particular gateway in which the user is registering. Thus, the user advantageously is able to specify different credit card information for each gateway in which the user registers.

For some “member type” classes (e.g. buyer or property owner) in which a state license is not applicable, the gateway's (e.g. “member type” class's) geographical aspect is the state of the user's address (e.g. as specified in FIG. 3c) instead of the state in which the user is licensed. In a similar manner as specifying different states within the United States (e.g. as shown and described hereinabove in connection with FIG. 3c), another embodiment further enables the user to specify different countries and regions outside the United States. In that manner, the user is able to register within various gateways that are specific to geographies outside the United States, such as registering within a gateway for real estate broker/agents that are licensed in Australia or another country.

Accordingly, referring again to FIG. 3a, in response to a user clicking the “Member Login” button 304b, the computer outputs at least one signal, resulting in a display of screen 300 of FIG. 3d by the computing system's display device. Starting with screen 300 of FIG. 3d, a user is able to review and revise the user's member profile and the user's real estate listings. Also, in a significant aspect of the illustrative embodiment, starting with screen 300 of FIG. 3d, a user is able to access: (a) a predefined group by specifying the group's name/password, as discussed in more detail hereinbelow in connection with FIGS. 3q, 5, 6e and 6f, or (b) the MagicNetwork service, as discussed in more detail hereinbelow in connection with FIGS. 3q, 5, 6e and 6f. Moreover, in another significant aspect of the illustrative embodiment, starting with screen 300 of FIG. 3d, if the user-selected “member type” class is broker/agent, a user is able to review and revise the user's real estate license information and credit card information.

Referring to FIG. 3d, in response to the user specifying an accurate e-mail address, specifying an accurate password, and clicking a “Continue” button as shown in FIG. 3d, the computer outputs such information to website server 112, and website server 112 verifies such accuracy relative to information stored in its database. In response to such verification, website server 112 outputs additional signals through network 116 to the computer, resulting in the display of screen 300 of FIG. 3e. Referring to FIGS. 3e and 3f, screen 300 includes user-specified information (from FIGS. 3b and 3c) of the gateway registration, which is associated with the user's member profile. By repositioning a scroll bar as shown in FIGS. 3e and 3f, a user is able to view all information of screen 300 therein.

Initially, screen 300 (of FIGS. 3e and 3f) displays the user's member profile information associated with a particular gateway registration. For example, the particular gateway registration is associated with a particular “member type” class which, in the example of FIGS. 3e and 3f, is a broker/agent having a license in the geography of Texas. Notably, the user is able to cause a change in the display of screen 300 (of FIGS. 3e and 3f), so that it displays the user's member profile information associated with other gateway registrations, if any, that were previously created by the user (e.g. as discussed further hereinabove in connection with FIGS. 3b and 3c) under the same user-specified e-mail address. The user is able to cause such a change in the displayed gateway registration by selecting a different “member type” (e.g. a different geographical aspect of the user) in FIG. 3e.

Notably, in a significant aspect of the illustrative embodiment, with reference to the user-specified information (from FIGS. 3b and 3c) of the gateway registration, which is associated with the user's member profile and accordingly displayed in screen 300 of FIGS. 3e and 3f, such information is variable in response to the user-selected gateway registration. For example, the user is able to click a region of screen 300 (FIG. 3e) entitled, “Click here to view features & information available for your member type & state.” In response to the user clicking such region, the computer outputs one or more signals to the computing system's display device, so that the display device displays additional information according to the user-selected gateway registration (e.g. according to the user-selected “member type” class and state).

As another example, in connection with the user specifying information for a real estate listing (as discussed further hereinbelow in connection with FIGS. 3g-t), system 100 varies the structure of such information in response to the user-selected gateway registration (e.g. in response to the gateway's geographical aspect), such as receiving and displaying a building's size in dimensions of square meters instead of square feet (e.g. if the gateway is specific to a geography of England instead of the United States). In that manner, system 100 performs a different operation in response to the user-selected gateway registration (e.g. according to the user-selected “member type” class and state).

Moreover, in a significant aspect of the illustrative embodiment, if the user-selected “member type” class is broker/agent, as shown in FIG. 3e, the user is able to click a region of screen 300 entitled, “Click here to edit license or credit info.” In response to the user clicking such region, the computer outputs one or more signals to the computing system's display device, so that the display device displays additional information which identifies the user's real estate license information and credit card information (as stored in the database of website server 112, and as discussed hereinabove in connection with fields 312 of FIG. 3c). In response to such display, the user is able to review and revise the user's real estate license information and credit card information, in a similar manner as discussed further hereinabove in connection with FIG. 3c.

Similarly, in response to screen 300 of FIGS. 3e and 3f, the user is able to review and revise the user's member profile, in a similar manner as discussed further hereinabove in connection with FIGS. 3b and 3c. After reviewing and revising the user's member profile, or after reviewing and revising the user's real estate license information and credit card information, the user is able to click either a “Save Changes” button or a “Cancel Changes” button in FIG. 3f. In response to the user clicking the “Save Changes” button in FIG. 3f, the computer outputs the user-specified information to website server 112, which detects such user-specified information and stores it in the database of website server 112. Conversely, in response to the user clicking the “Cancel Changes” button in FIG. 3f, the computer ignores any current changes in the user-specified information.

Also, in FIG. 3f, the user is able to click a region of screen 300 entitled, “Click here to access the MagicNetwork service.” In response to the user clicking such region, the user's associated computer outputs one or more signals to website server 112. In response thereto, website server 112 outputs one or more signals to the user's associated computer, so that the computing system's display device displays screen 300 according to a sequence similar to that of screen 400 of FIGS. 4f-q, yet with access directed to a subset of the database of website server 112.

In a significant aspect of the illustrative embodiment, website server 112 identifies the subset in response to “member type” classes that are specified by various users when they add new listings, as discussed further hereinbelow in connection with FIG. 3q. For example, if a particular user's selected “member type” class is broker/agent, as shown in FIG. 3e, then website server 112 identifies the subset as including only listings that are published through the MagicNetwork service for viewing by broker/agents, as discussed further hereinbelow in connection with FIG. 3q.

Moreover, in FIG. 3f, the user is able to access a predefined group by typing the group's name/password in fields 316, followed by the user clicking the “Continue” button in FIG. 3f. In response to the user clicking the “Continue” button, the user's associated computer outputs one or more signals (e.g. including a command that includes the user-specified name/password in fields 316) to website server 112. In response thereto, website server 112 outputs one or more signals to the user's associated computer, so that the computing system's display device displays screen 300 according to a sequence similar to that of screen 400 of FIGS. 4f-q, yet with access directed to a subset of the database of website server 112.

In a significant aspect of the illustrative embodiment, website server 112 identifies the subset in response to the user-specified name/password (in fields 316) matching a group's name/password, and in response to the user's “member type” class matching at least one of the selected one or more “member type” classes that are specified by various users when they add new listings to the group, as discussed further hereinbelow in connection with FIG. 3q. For example, if a particular user's selected “member type” class is broker/agent, as shown in FIG. 3e, then website server 112 identifies the subset as including only listings that are published through the group for viewing by broker/agents, as discussed further hereinbelow in connection with FIG. 3q.

Various users are able to share a group's name/password with one another via conventional e-mail messages and other forms of communication. In the illustrative embodiment, website server 112 permits multiple users to publish respective listings through the group for viewing by respectively selected “member type” classes of users, irrespective of whether the users know one another's specific identity or specific address. Significantly, the available “member type” classes are predetermined by website server 112, as discussed further hereinabove in connection with button 310 of FIG. 3b, thereby improving manageability.

In an alternative embodiment, website server 112 permits only a single user (who originally defines the group by specifying publication of a listing through the group) to publish additional listings through the group for viewing by respectively specified (e.g. per listing) “member type” classes of users. In another alternative embodiment, website server 112 permits only a single user (who originally defines the group by specifying publication of a listing through the group) to publish only a single listing through the group for viewing by selected “member type” class(es) of users. According to such an alternative embodiment, in response to a buyer's user clicking the “Continue” button after typing the group's name/password in fields 316, the buyer's computer outputs one or more signals to the computing system's display device, so that the display device displays the single listing (e.g. the listing of screen 400 in FIG. 4d), but only if the buyer's user is within the selected “member type” class(es) of users. Advantageously, such an alternative embodiment is more direct and expeditious in displaying the single listing to the buyer's user, without the buyer's user navigating a more complex version of screen 300 according to a sequence similar to that of FIGS. 4f-q.

In one embodiment, if the user accesses a predefined group by typing the group's name/password in fields 316, followed by the user clicking the “Continue” button in FIG. 3f, website server 112 causes screen 300 to display personal information to the user. For example, such personal information can include substantially real-time photographs or video of the user's house. Such photographs or video can be output from a security camera physically located at the user's house. Moreover, such personal information can include information about appliances and electronic devices at the user's house. In such an embodiment, the user is able to control such appliances and electronic devices by specifying information through screen 300 of the user's associated computing system for transmission through network 116 to such appliances and electronic devices under management of website server 112.

Referring again to FIG. 3f, the user is able to click a region of screen 300 entitled, “Click here to add new listing.” In response to the user clicking such region, the computer outputs one or more signals to the computing system's display device, so that the display device displays screen 300 according to the sequence of FIGS. 3g-q. For example, in one embodiment, (a) the computer outputs one or more signals (indicative of the fact that the user clicked such region) to website server 112, (b) in response thereto, website server 112 detects such fact, and (c) in response thereto, website server 112 outputs additional signals through network 116 to the computer, resulting in the display (by the computing system's display device) of screen 300 according to the sequence of FIGS. 3g-q.

Accordingly, referring to FIG. 3g, screen 300 includes a “Basic Website” button, a “Genie Website” button, and a “Magic Website” button. In a significant aspect of the illustrative embodiment, a user is able to click either the “Basic Website” button (as shown in FIG. 3b), the “Genie Website” button, or the “Magic Website” button, in order to select an account type for the user's real estate listing. Advantageously, website server 112 is programmable to perform different operations in response to the user's selection of either the “Basic Website” button, the “Genie Website” button, or the “Magic Website” button.

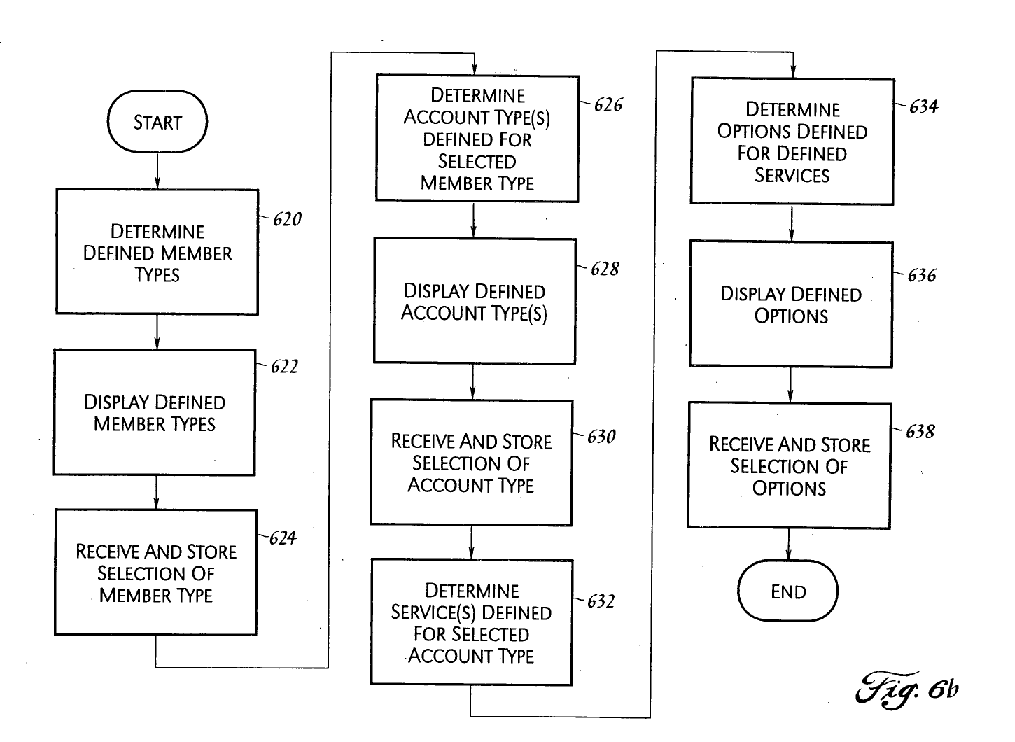

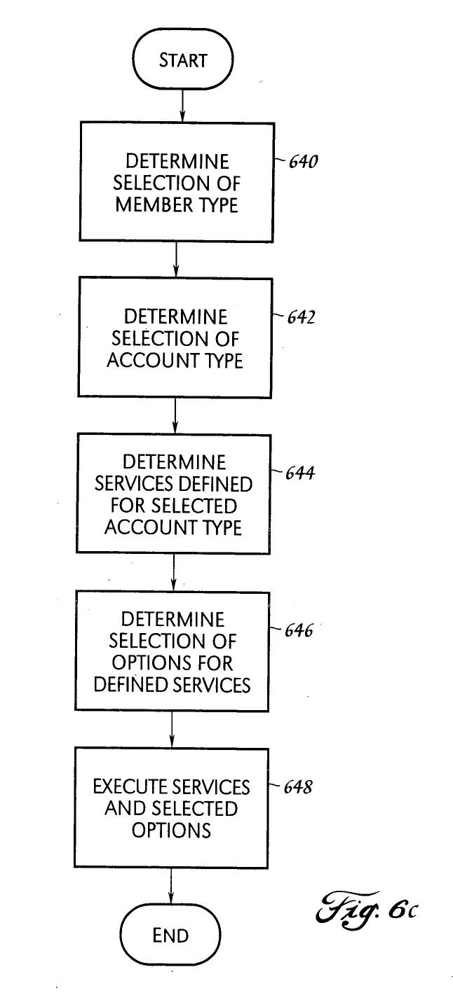

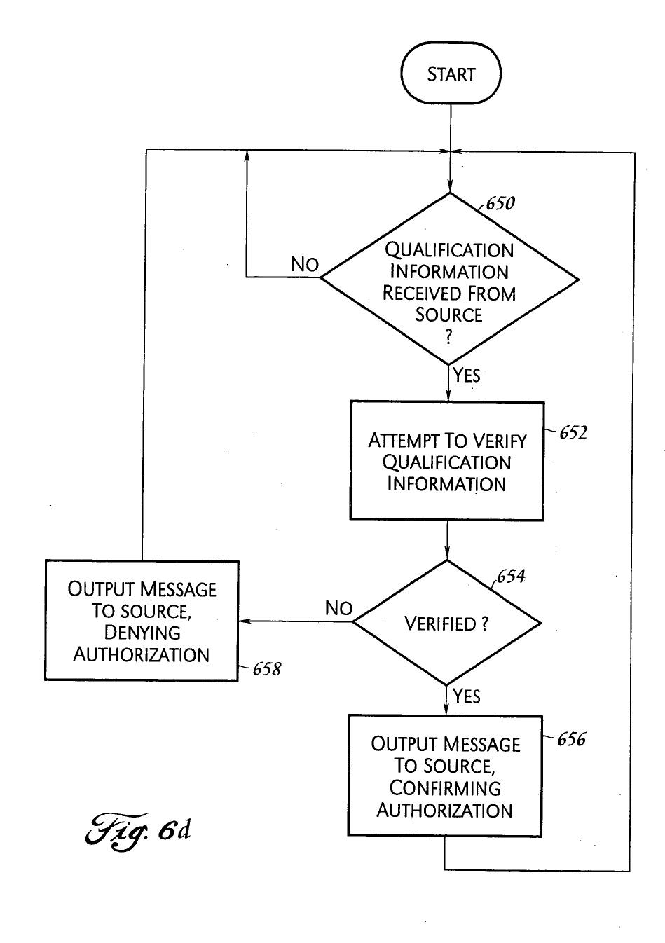

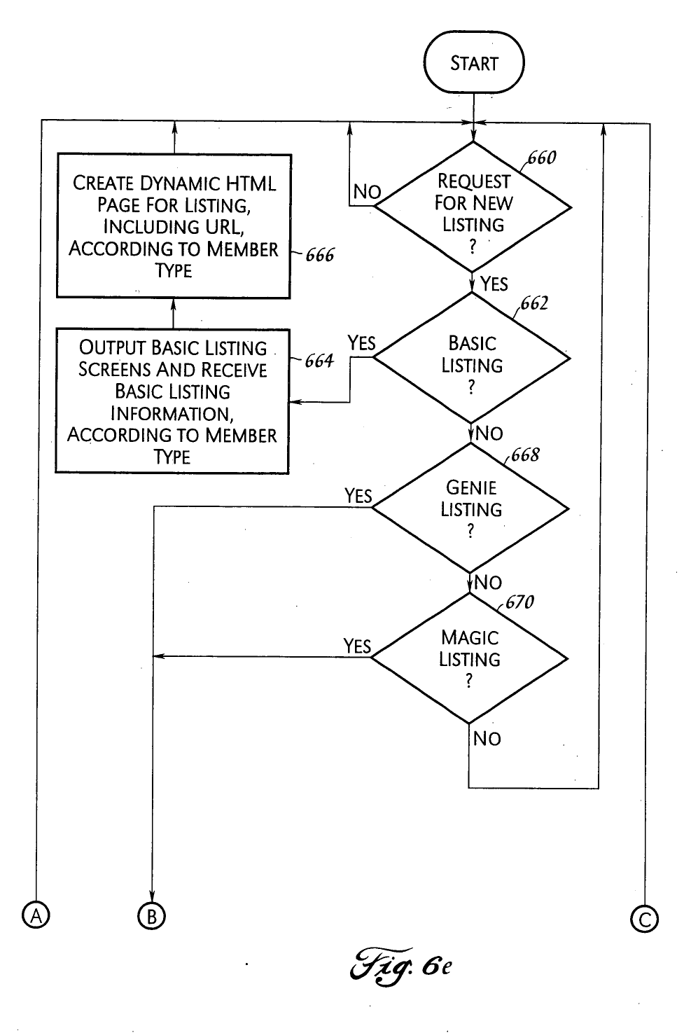

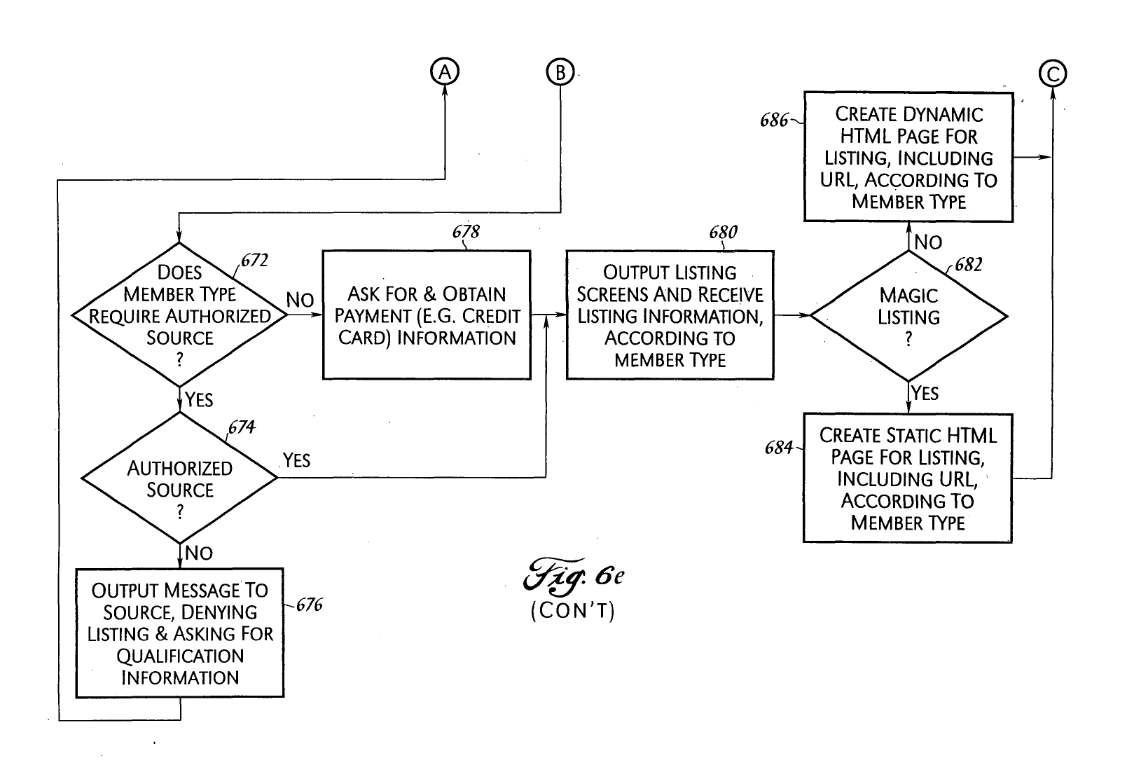

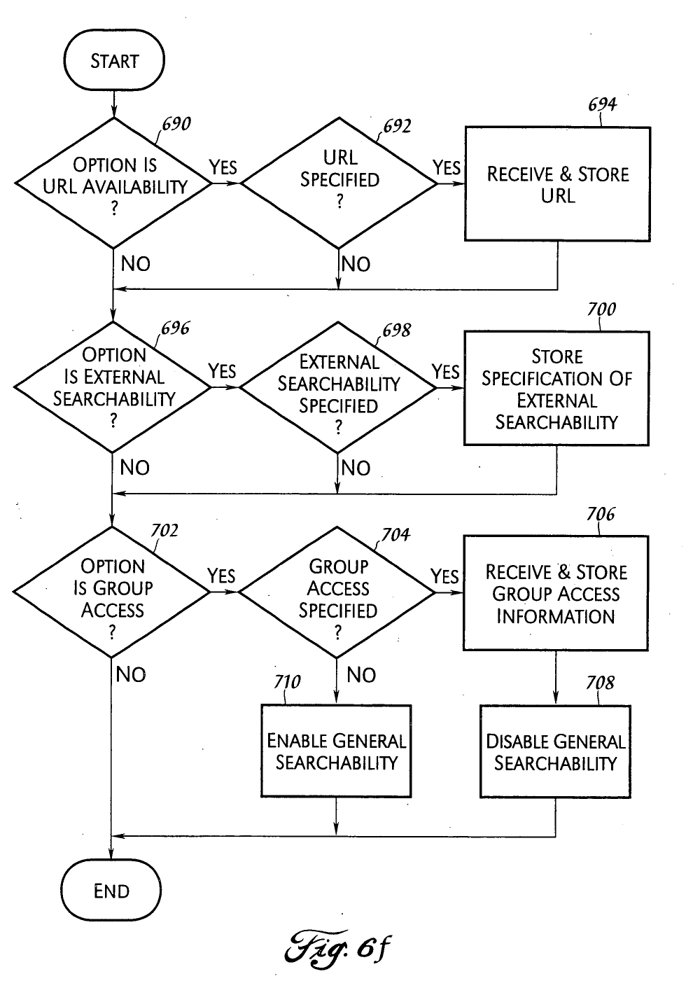

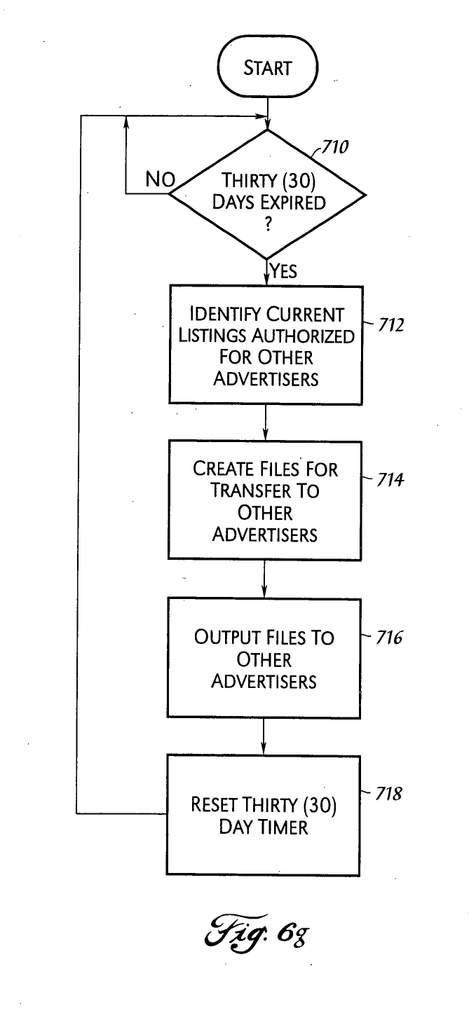

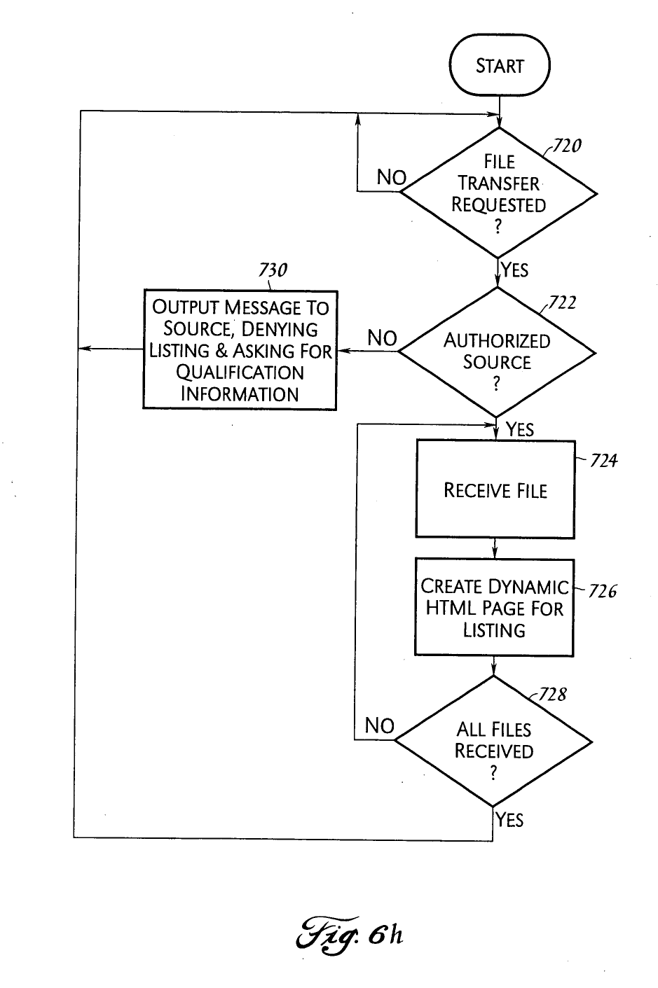

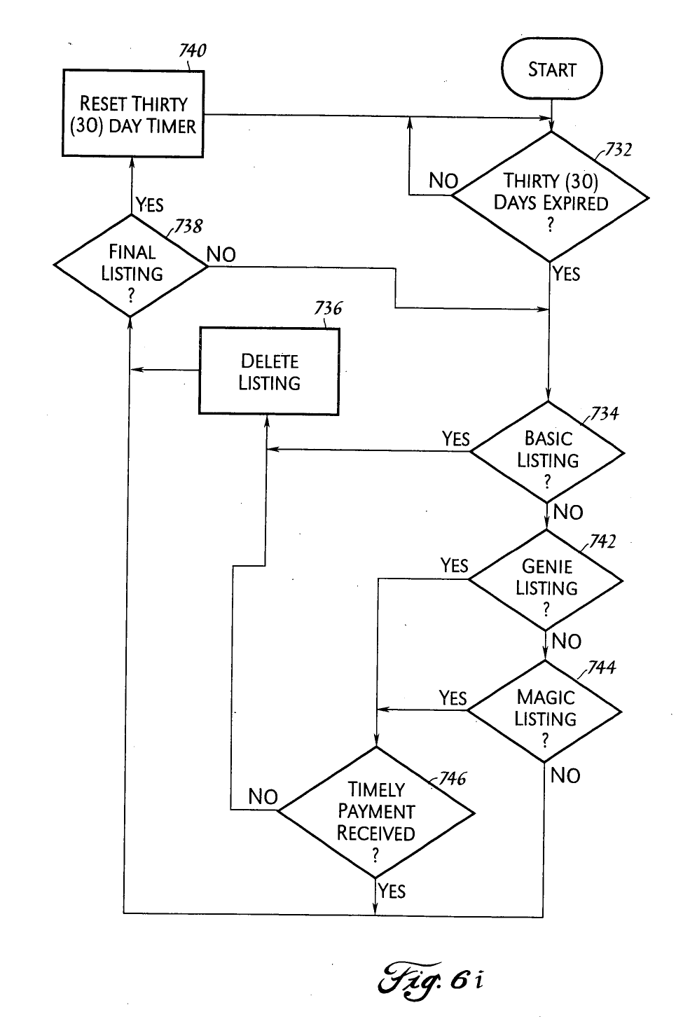

For example, as discussed further hereinbelow in connection with FIG. 6i, website server 112 is programmable to delete the user's real estate listing, according to different criteria, in response to the user's selection of either the “Basic Website” button, the “Genie Website” button, or the “Magic Website” button.

In the illustrative embodiment:

(a) in response to the user's selection of the “Basic Website” button (i.e. selection of a “Basic” account type), website server 112 automatically deletes the user's real estate listing after the expiration of thirty (30) days;

(b) in response to the user's selection of either the “Genie Website” button (i.e. selection of a “Genie” account type) or the “Magic Website” button (i.e. selection of a “Magic” account type), website server 112 automatically deletes the user's real estate listing if the user fails to timely pay all monetary amounts that are contractually owed to the owner of the www.magiclamp.com Internet site; and

(c) irrespective of whether the user selects the “Basic Website” button or the “Genie Website” button or the “Magic Website” button, website server 112 deletes the user's real estate listing if the user requests such deletion, as discussed further hereinbelow in connection with FIG. 3v.

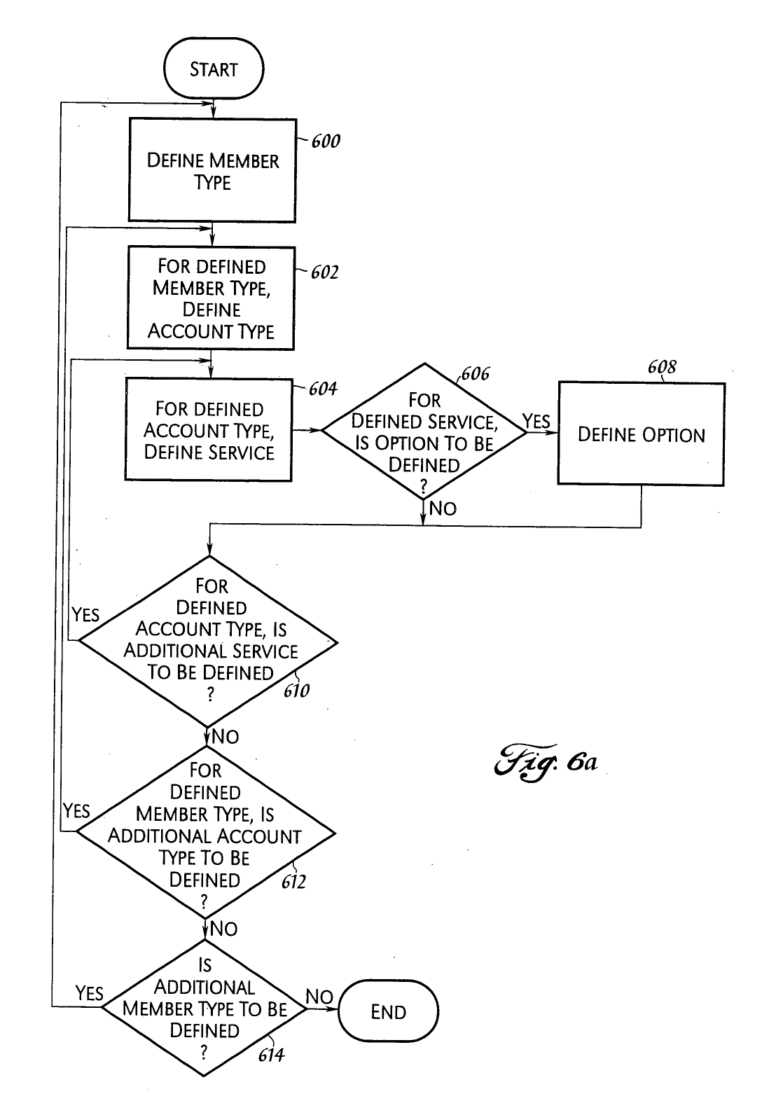

Moreover, website server 112 is programmable to selectively output the displayed notification (e.g. “Basic Website” button, “Genie Website” button, and/or “Magic Website” button) of user-selectable account types (e.g. “Basic” account type, “Genie” account type, and/or “Magic” account type) in response to the user-selected “member type” class and associated gateway (discussed further hereinabove in connection with FIGS. 3b-c and 3e-f). For example, website server 112 is programmable to selectively permit only a predetermined one or more “member type” classes to select a “Basic” account type, “Genie” account type, and/or “Magic” account type. Accordingly, in the illustrative embodiment, as discussed further hereinbelow in connection with FIG. 5, website server 112 permits: (a) only the broker/agent “member type” class to select a “Genie” account type; and (b) only the broker/agent “member type” class and the real estate company “member type” class to select a “Magic” account type.

In an alternative embodiment, in response to the user's selection of the “Genie Website” button or the “Magic Website” button instead of the “Basic Website” button, website server 112 additionally prompts a user for (and, in response thereto, receives from a user) an enhanced amount of information associated with the user's real estate listing. For example, in such an alternative embodiment, the enhanced amount of information is additional to the information (a) received from a user in FIGS. 3g-n and 3r-t, (b) displayed to a user in FIGS. 3o-p and 3v-w, (c) displayed to a user in FIGS. 4c-d.

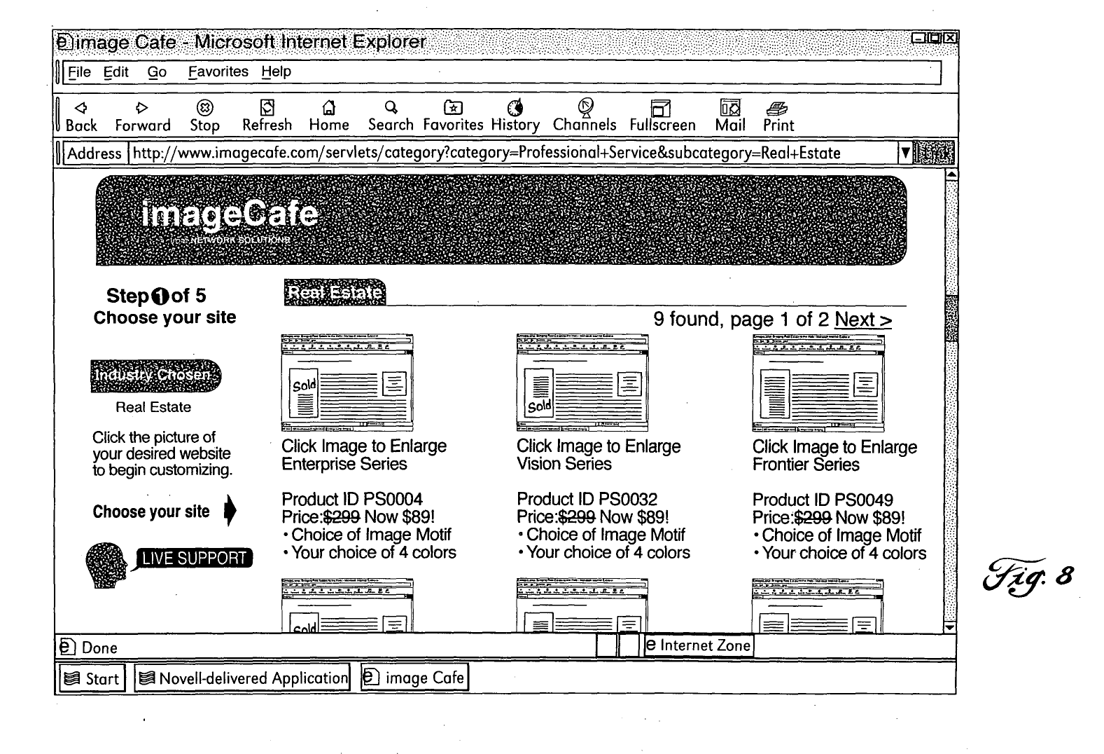

In another alternative embodiment, in response to the user's selection of the “Genie Website” button or the “Magic Website” button instead of the “Basic Website” button, website server 112 additionally prompts a user for (and, in response thereto, receives from a user) a selection of a display template associated with the user's real estate listing. For example, in such an alternative embodiment, website server 112 substitutes the user-selected display template in place of the styles (a) displayed to a user in FIGS. 3o-p and 3v-w and (b) displayed to a user in FIGS. 4c-d. Examples of various display templates (e.g. FIG. 8) are shown at http://www.imagecafe.com, which are available from ImageCafe, Inc., 5565 Sterrett Place, Suite 210, Columbia, Md. 21044. The user-selected display template may include multiple photographs or video (e.g. accompanied by audio) of the user's real estate listing, instead of a single photograph.

Notably, in a significant aspect of the illustrative embodiment, at least one of the user-selected “member type” classes is subject to verification by website server 112, as discussed further hereinbelow in connection with FIG. 6d. In the illustrative embodiment, broker/agents are subject to verification. In an alternative embodiment, real estate companies are likewise subject to verification.

For example, if a particular user has selected a “member type” class (e.g. broker/agents) that is subject to verification, then website server 112 verifies whether the particular user is indeed qualified to belong within such “member type” class. In performing such verification, website server 112 obtains qualification information from the particular user. For example, in the illustrative embodiment, such qualification information for broker/agents includes the information in fields 312 of FIG. 3c. After obtaining the qualification information, website server 112 reads information from various computer databases and, in response thereto, determines whether the particular user's identity is verified (or “authenticated”) in relation to the qualification information.

As discussed further hereinbelow in connection with FIGS. 5 and 6e, in the illustrative embodiment, website server 112 creates. a “Genie” account for only broker/agents who are so verified. Similarly, in the illustrative embodiment, website server 112 creates a “Magic” account for only (a) broker/agents who are so verified and (b) real estate companies. By comparison, website server 112 creates a “Basic” account for any user, irrespective of such verification.

Referring again to FIG. 3g, in response to a user clicking either the “Basic Website” button, the “Genie Website” button, or the “Magic Website” button (FIG. 3g shows the user clicking the “Basic Website” button), the computer outputs such event to website server 112, and website server 112 detects such event. In response thereto, website server 112 (a) stores the user's selection in its database (i.e. stores the user's selection of either the “Basic Website” button, the “Genie Website” button, or the “Magic Website” button) and (b) outputs additional signals through network 116 to the computer.

If the user's selection is “Basic Website,” such additional signals result in the display of screen 300 of FIG. 3h by the computing system's display device. Similarly, if the user's selection is “Genie Website,” such additional signals result in the display of screen 300 of FIG. 3h by the computing system's display device, but only if website server 112 succeeds in verifying the user as a broker/agent. Likewise, if the user's selection is “Magic Website,” such additional signals result in the display of screen 300 of FIG. 3h by the computing system's display device, but only if (a) website server 112 succeeds in verifying the user as a broker/agent or (b) the user has specified a “member type” class of “real estate company.”

Accordingly, referring to FIG. 3h, screen 300 includes a “property type” field and a “transaction type” field. In a significant aspect of the illustrative embodiment, a user is able to click (a) a button 318, as shown in FIG. 3h, and (b) a button 320. Button 318 is associated with the “property type” field, and button 320 is associated with the “transaction type” field.

By clicking button 318, a user is able to select the property type (of the user's real estate listing) from a list of predetermined classes. In the illustrative embodiment, the predetermined “property type” classes include (a) commercial and (b) residential. In that manner, system 100 efficiently categorizes the user's real estate listing into one of the predetermined “property type” classes.

Advantageously, website server 112 is programmable to perform different operations in response to the user-selected “property type” class. For example, as discussed further hereinbelow in connection with FIGS. 3j-k and 3r-t, website server 112 is programmable to output different signals through network 116 to the computer, in response to the user-selected “property type” class, so that the computing system's display device displays different versions of screen 300 according to the user-selected “property type” class.

Similarly, by clicking button 320, a user is able to select the transaction type (of the user's real estate listing) from a list of predetermined classes. In the illustrative embodiment, the predetermined “transaction type” classes include (a) for sale and (b) for lease. In that manner, system 100 efficiently categorizes the user's real estate listing into one of the predetermined “transaction type” classes.

Advantageously, website server 112 is programmable to perform different operations in response to the user-selected “transaction type” class. For example, as discussed further hereinbelow in connection with FIGS. 3j-k and 3r-t, website server 112 is programmable to output different signals through network 116 to the computer, in response to the user-selected “transaction type” class, so that the computing system's display device displays different versions of screen 300 according to the user-selected “transaction type” class.

After a user has selected a “property type” class and a “transaction type” class, the user-selected classes are displayed in screen 300. As shown in the example of FIG. 3i, the user has selected “commercial” and “for lease.” Also, after a user has selected a “property type” class and a “transaction type” class, a user is able to click a “Continue” button 322, as shown in FIG. 3i.

In response to a user clicking “Continue” button 322, the computer outputs the user-selected “property type” class and the “transaction type” class to website server 112, and website server 112 detects such event. In response thereto, website server 112 (a) stores the user's selections in its database and (b) outputs additional signals through network 116 to the computer, resulting in the display of a new version of screen 300 by the computing system's display device.

Advantageously, website server 112 varies the new version of screen 300 according to the user-selected real estate listing type (e.g. combination of “property type” class and “transaction type” class).

For example, if the user has selected “commercial” and “for lease” as shown in the example of FIG. 3i, then the new version of screen 300 is shown in FIGS. 3j and 3k. Accordingly, referring to FIGS. 3j and 3k, screen 300 includes a set of fields indicated generally at 324. Fields 324 are a notification that describes an information structure associated with the user-selected real estate listing type. As shown in FIGS. 3j and 3k, fields 324 are regions of screen 300 in which a user is able to specify alphanumeric character information, similar to the example of FIGS. 3b and 3c hereinabove in which a user specified alphanumeric character information for display within fields 306.

More particularly, in fields 324, a user is able to specify information about the user's real estate listing, according to the information structure of the user-selected real estate listing type, such as the listing's (a) property name (e.g. the listed real estate's property name), (b) property type, (c) street address, (d) city, (e) state, (f) ZIP code, (g) rent price, (h) square footage, and (i) property description. Such information is potentially relevant to a buyer's evaluation of the listed real estate when determining a level of interest. Notably, in the “property description” field of fields 324, a user is able to type any descriptive information about the listing.

A user is able to view all of fields 324 by (a) clicking a scroll bar 326 and (b) while continuing to activate the switch of the computing system's pointing device, operating the pointing device to reposition scroll bar 326 within screen 300. Accordingly, in comparison to FIG. 3j, FIG. 3k shows scroll bar 326 after a user has repositioned it within screen 300.

Moreover, in a significant aspect of the illustrative embodiment, a user is able to click a button 328, as shown in FIG. 3j. Button 328 is associated with the “property type” field of fields 324. By clicking button 328, a user is able to select the listing's property type from a list of predetermined classes.

In the illustrative embodiment, the predetermined “property type” classes for a listing type of “commercial for lease” include (a) office, (b) retail, (c) warehouse, (d) land, and (e) other. In that manner, system 100 efficiently categorizes the listing into one of the predetermined “property type” classes. Advantageously, website server 112 is programmable to perform different operations in response to the user-selected “property type” class.

For example, website server 112 is programmable to additionally prompt a user for (and, in response thereto, receive from a user) an enhanced amount of information associated with the user's real estate listing, according to the user-selected “property type” class. In an alternative embodiment, such additional prompting occurs in response to the user clicking a “Save New Listing” button 330. Accordingly, website server 112 is programmable to prompt a user for different information associated with an “office” class of real estate listing, in comparison to a “retail” or other class of real estate listing. Information associated with a “retail” class of real estate listing may be less relevant to an “office” or other class of real estate listing.

In another significant aspect of the illustrative embodiment, a user is able to specify the listing's property name. By specifying the listing's property name, a user advantageously specifies an Internet address under (or “in association with”) which the listing is stored by system 100 (e.g. by website server 112). In that manner, system 100 provides a valuable element of user-customization for listing real estate. Notably, the user is able to specify any name as the listing's property name, at the user's discretion, irrespective of whether such name is actually the property's real name in other contexts.

By allowing a user to specify an Internet address under which the listing is stored by system 100, a user is more readily able to know, remember, communicate and advertise the user-specified Internet address. In the illustrative embodiment, the Internet address is a URL (“Uniform Resource Locator”) that includes a domain name (e.g. magiclamp.com). A URL is an address that defines a route to a file (e.g. the real estate listing stored by system 100) on the World Wide Web or any other Internet facility, according to the Internet's DNS (“Domain Name System”).

Advantageously, this feature more readily allows a buyer to deep-link directly to the listing. By allowing a buyer to deep-link directly to the listing, the listing becomes substantially as effective as a stand-alone website, because the buyer avoids (or “bypasses”) the home (or “first” or “top”) page and other pages, directories, subdirectories, documents and objects of the http://www.magiclamp.com Internet site (at which the listing is stored by system 100). This feature is discussed further hereinbelow in connection with FIGS. 4a-d.

In the illustrative embodiment, the user-specified Internet address has a format of http://www.propertyname.magiclamp.com, so that (a) “magiclamp.com” is a primary domain and (b) the user-specified property name is a subdomain. For example, in such an embodiment, if a user specifies a property name of “parktower,” website server 112 stores the listing under an Internet address of http://www.parktower.magiclamp.com. Notably, in association with receiving information about the real estate listing in fields 324 of FIGS. 3j-k, website server 112 outputs a notification to the user about such format before the user specifies the property name, so the user knows such Internet address when specifying the property name. In an alternative embodiment, website server 112 outputs a notification to the user about such format and such Internet address by sending an e-mail message to the user's associated computer, promptly after the user's associated computer outputs the user-specified information (of fields 324) to website server 112.

In another alternative embodiment, the user-specified Internet address has a format of http://www.magiclamp.com/propertyname, so that (a) “magiclamp.com” is a primary domain and (b) the user-specified property name is a directory (e.g. subdirectory). For example, in such an embodiment, if a user specifies a property name of “parktower,” website server 112 stores the listing under an Internet address of http://www.magiclamp.com/parktower.

Advantageously, under either format of http://www.propertyname.magiclamp.com or http://www.magiclamp.com/propertyname, the domain name (e.g. magiclamp.com) and the user-specified property name (“propertyname”) are separated from one another by only a single character. In that manner, the user is more readily able to know, remember, communicate and advertise the user-specified Internet address, so that the listing becomes substantially as effective as a stand-alone website. In the http://www.propertyname.magiclamp.com format, the domain name is preceded by (and separated by a single dot character from) the user-specified property name. In :the http://www.magiclamp.com/propertyname format, the domain name is followed by (and separated by a single slash character from) the user-specified property name.

FIGS. 3j and 3k are illustrations of screen 300 after a user has specified information for display within fields 324. After a user has specified information for display within each of fields 324, a user is able to click “Save New Listing” button 330, as shown in FIG. 3k. In response to a user clicking “Save New Listing” button 330, the computer outputs the user-specified information (of fields 324) to website server 112.

Website server 112 detects such user-specified information. In response to receiving the user-specified information, website server 112 (a) stores it in the database of website server 112 and (b) outputs additional signals through network 116 to the computer, resulting in the display of screen 300 of FIG. 31 by the computing system's display device. In one embodiment, website server 112 includes (a) a first server computer for detecting and receiving the user-specified information (of fields 324) and (b) a second server computer, including the database, for storing such information in association with the user-specified Internet address.

Accordingly, referring to FIG. 31, screen 300 includes a “Browse” button 332, an “Upload File” button 334, and a “File” field 336. Field 336 is a region of screen 300 in which a user is able to specify alphanumeric character information, similar to the example of FIG. 3a hereinabove in which a user specified alphanumeric character information of the URL address for display within URL field 301. More particularly, in field 336, a user is able to specify a file name of a photograph, drawing or other visual work associated (and to be displayed) with the user's real estate listing.

In the illustrative embodiment, the photograph is stored on the computer-readable medium in a graphics file having either a Graphics Interchange Format (“.gif” format) or a Joint Photographic Experts Group (“.jpg”) format. As shown in the example of FIG. 31, a user is able to click “Browse” button 332, in order to browse the names of various files stored on the computer-readable medium. Accordingly, in response to the user clicking “Browse” button 332, the computer outputs additional signals to the computing system's display device, resulting in the display of screen 300 of FIG. 3m.

Referring to FIG. 3m, the user selects a file name by clicking it within a window 338. In response to the user clicking a file name (e.g. “Parktower.jpg”), the file name appears in a field 340. Then, in response to the user clicking an “Open” button 342, the computer outputs additional signals to the computing system's display device, resulting in the display of screen 300 of FIG. 3n.

Referring to FIG. 3n, the user-selected file name appears in field 336. Then, in response to the user clicking “Upload File” button 334, as shown in FIG. 3n, the computer outputs the user-selected file (named in field 336) from the computer-readable medium to website server 112. Instead of clicking “Upload File” button 334, the user is able to click a “Click Here” region of screen 300 if the user does not have a suitably formatted photograph to upload. If field 336 is blank (i.e. the user fails to select a file) when the user clicks “Upload File” button 334, or if the user clicks the “Click Here” region instead of “Upload File” button 334, then the computer outputs such fact to website server 112.

Website server 112 detects such information (i.e. the user-selected file or the fact that such file is absent). In response thereto, website server 112 (a) stores it in the database of website server 112 and (b) outputs additional signals through network 116 to the computer, resulting in the display of screen 300 of FIGS. 3o and 3p by the computing system's display device.

Similarly, in an alternative embodiment, the user is able to specify a file name of a photograph, drawing or other visual work associated (and to be displayed) with the user's real estate listing by specifying a location within a user-designated website (e.g. www.Photonet.com).

A user is able to view all information of FIGS. 3o and 3p by (a) clicking a scroll bar 344, as shown in FIG. 3o, and (b) while continuing to activate the switch of the computing system's pointing device, operating the pointing device to reposition scroll bar 344 within screen 300, as shown in FIG. 3p. Accordingly, in comparison to FIG. 3o, FIG. 3p shows scroll bar 344 after a user has repositioned it within screen 300.

Referring to FIGS. 3o and 3p, screen 300 includes (a) the user-specified Internet address of the listing, under which the listing is stored by system 100, (b) user-specified information (from FIGS. 3b and 3c) of the listing, which is associated with the user's member profile, (c) the user-specified information (from FIGS. 3h-k) of the listing, and (d) the user-specified photograph (from FIGS. 3l-n), if any, of the listing. If the user failed to select a photograph in FIGS. 3l-n, the photograph region of screen 300 states “No picture available.” In response to screen 300 of FIGS. 3o and 3p, the user is able to review and revise the listing and the user's member profile.

For example, if the user wants to edit the user-specified information (from FIGS. 3h-k) or the user-specified photograph (from FIGS. 3l-n) of the listing, the user is able to click an “Edit Property” button 346. In response to the user clicking “Edit Property” button 346, the computer outputs such fact to website server 112, and website server 112 detects such fact. In response thereto, website server 112 outputs additional signals through network 116 to the computer, resulting in the display (by the computing system's display device) of screen 300 according to the sequence of FIGS. 3h-p, thereby giving the user an opportunity to revise any of the previously specified information.

If the user wants to edit the user-specified member profile information (from FIGS. 3e and 3f), the user is able to click an “Edit Profile” button 348. In response to the user clicking “Edit Profile” button 348, the computer outputs such fact to website server 112, and website server 112 detects such fact. In response thereto, website server 112 outputs additional signals through network 116 to the computer, resulting in the display (by the computing system's display device) of screen 300 according to the sequence of FIGS. 3e-f and 3o-p, thereby giving the user an opportunity to revise any of the previously specified information.

Also, in FIGS. 3o-p, in response to the user clicking a “view map” region 350 of screen 300, a map to the listed real estate appears in screen 300 within a separate window, in the manner discussed further hereinbelow in connection with FIG. 4e.

In FIG. 3p, the user is able to click a “Save” button 352, as for example if the user is satisfied with the user-specified information (from FIGS. 3h-k), the user-specified photograph (from FIGS. 3l-n), and the user-specified member profile information (from FIGS. 3e and 3f). In response to the user clicking “Save” button 352, the computer outputs such fact to website server 112, and website server 112 detects such fact. In response thereto, website server 112 (a) stores such fact in the database of website server 112 and (b) outputs additional signals through network 116 to the computer, resulting in the display of screen 300 of FIG. 3q by the computing system's display device.

In FIG. 3q, the user is able to specify a manner and extent to which the listing (i.e. the listing as specified by the user in connection with FIGS. 3b-p) is published through system 100 for viewing by other users. The user performs such specification by clicking one or more applicable boxes of screen 300 of FIG. 3q. For a “Basic” listing, website server 112 permits the user to specify publication of the listing only in a manner that permits viewing by all “member type” classes of users, and only through (a) the Internet via the user-specified URL, as discussed further hereinabove in connection with FIG. 3j, or (b) a search via the MagicLamp Internet site (i.e. www.magiclamp.com). Accordingly, for a “Basic” listing, website server 112 permits the user to click only the box of screen 300 of FIG. 3q that is entitled, “via URL and MagicLamp Search.” After clicking the “via URL and MagicLamp Search” box, the user is able to click the “Continue” button of screen 300 of FIG. 3q.

For a “Genie” listing or “Magic” listing, website server 112 permits the user to specify publication of the listing either (a) in the same manner as a “Basic” listing, (b) in a manner that, in addition to the “Basic” listing manner, permits viewing by all “member type” classes of users through the Internet via one or more non-MagicLamp Internet sites (e.g. www.yahoo.com of advertiser 114), or (c) in a manner that permits viewing by only selected “member type” classes of users. Accordingly, for a “Genie” listing or “Magic” listing, website service 112 permits the user to click any of the boxes of screen 300 of FIG. 3q.

For example, in order to publish the listing in a manner that, in addition to the “Basic” listing manner, permits viewing by all “member type” classes of users through the Internet via one or more non-MagicLamp Internet sites (e.g. www.yahoo.com), the user is able to click the box of screen 300 of FIG. 3q that is entitled, “via URL and MagicLamp Search, plus other Advertisers (e.g. Yahoo Classifieds).” In order to publish the listing in a manner that permits viewing by only selected “member type” classes of users, the user is able to click either: (a) the box of screen 300 of FIG. 3q that is entitled, “via MagicLamp Search, but only through the MagicNetwork service,” or (b) the box of screen 300 of FIG. 3q that is entitled, “via MagicLamp, but only to your authorized group.”

In response to the user clicking the “via MagicLamp Search, but only through the MagicNetwork service” box, website server 112 permits the user to select (by clicking) any one or more of the “member type” classes of users displayed in screen 300 of FIG. 3q. After selecting one or more of the “member type” classes, the user is able to click the “Continue” button of screen 300 of FIG. 3q.

In response to the user clicking the “via MagicLamp, but only to your authorized group” box, website server 112 permits the user to (a) specify a group by typing the group's name/password in fields 354 and (b) select (by clicking) any one or more of the “member type” classes of users displayed in screen 300 of FIG. 3q. After typing the group's name/password in fields 354 and selecting one or more of the “member type” classes, the user is able to click the “Continue” button of screen 300 of FIG. 3q. In an alternative embodiment, website server 112 permits the user to specify a particular group's name/password in fields 354, but only if the particular group's name/password has not already been specified by another user.

In response to the user clicking the “Continue” button in FIG. 3q, the computer outputs the user-specified information/selections to website server 112, which detects such user-specified information/selections and stores them in the database of website server 112. In that manner, website server 112 permits the user to specify publication of a “Genie” listing or a “Magic” listing for viewing by only the selected “member type” classes of users, irrespective of whether the users know one another's specific identity or specific address. Significantly, the available “member type” classes are predetermined by website server 112, as discussed further hereinabove in connection with button 310 of FIG. 3b, thereby improving manageability.

Accordingly, in that manner (and as discussed further hereinbelow), the user is able to publish a real estate listing for viewing by other users through system 100. Advantageously, the user is able to so publish the real estate listing without significant delay that might otherwise have resulted from intermediate involvement by another human during the publication process. System 100 substantially avoids such delay by enabling the user is able to specify (in an automated manner through system 100) all relevant information for publishing the real estate listing at the user-specified Internet address.

Referring again to FIG. 3h, in response to a user selecting “commercial” as the “property type” class, selecting “for sale” as the “transaction type” class, and clicking “Continue” button 322, website server 112 causes the computing system's display device to display screen 300 of FIG. 3r instead of FIGS. 3j and 3k (screen 300 of FIG. 3r includes a “property description” field, although such field is not shown in FIG. 3r for clarity). Accordingly, as discussed further hereinabove in connection with FIGS. 3h-k, website server 112 varies the new version of screen 300 according to the user-selected real estate listing type (e.g. combination of “property type” class and “transaction type” class).

Similar to FIGS. 3j and 3k, screen 300 of FIG. 3r includes a set of fields, which are regions of screen 300 in which a user is able to specify alphanumeric character information. More particularly, in such fields (which are a notification that describes an information structure associated with the user-selected real estate listing type), a user is able to specify information about the user's real estate listing, according to the information structure of the user-selected real estate listing type, such as the listing's (a) property name, (b) property type, (c) street address, (d) city, (e) state, (f) ZIP code, (g) sales price, (h) square footage, and (i) property description. Thus, unlike FIGS. 3j and 3k, screen 300 of FIG. 3r includes a “sales price” field instead of a “rent price” field. Again, such information is potentially relevant to a buyer's evaluation of the listed real estate when determining a level of interest.

Moreover, in a significant aspect of the illustrative embodiment, a user is able to click a button associated with the “property type” field in FIG. 3r. By clicking such button, a user is able to select the listing's property type from a list of predetermined classes. In the illustrative embodiment, the predetermined “property type” classes for a listing type of “commercial for sale” include (a) apartments, (b) office, (c) retail, (d) warehouse, (e) land, and (f) other. Thus, in comparison to FIGS. 3j and 3k, screen 300 of FIG. 3r includes a different list of predetermined classes into which system 100 efficiently categorizes the listing. Advantageously, as discussed further hereinabove in connection with FIGS. 3j-k, web site server 112 is programmable to perform different operations in response to the user-selected “property type” class.

Referring yet again to FIG. 3h, in response to a user selecting “residential” as the “property type” class, selecting “for lease” as the “transaction type” class, and clicking “Continue” button 322, website server 112 causes the computing system's display device to display screen 300 of FIG. 3s instead of FIG. 3r (screen 300 of FIG. 3s includes a “property name” field and a “property description” field, although such fields are not shown in FIG. 3s for clarity). Accordingly, as discussed further hereinabove in connection with FIGS. 3h-k, website server 112 varies the new version of screen 300 according to the user-selected real estate listing type (e.g. combination of “property type” class and “transaction type” class).

Similar to FIG. 3r, screen 300 of FIG. 3s includes a set of fields, which are regions of screen 300 in which a user is able to specify alphanumeric character information. More particularly, in such fields (which are a notification that describes an information structure associated with the user-selected real estate listing type), a user is able to specify information about the user's real estate listing, according to the information structure of the user-selected real estate listing type, such as the listing's (a) property name, (b) property type, (c) street address, (d) city, (e) state, (f) ZIP code, (g) rent price, (h) number of bedrooms, (i) number of bathrooms, (j) square footage, and (k) property description. Thus, unlike FIG. 3r, screen 300 of FIG. 3s includes a “rent price” field instead of a “sales price” field, and further includes a “number of bedrooms” field and a “number of bathrooms” field. Again, such information is potentially relevant to a buyer's evaluation of the listed real estate when determining a level of interest.

Moreover, in a significant aspect of the illustrative embodiment, a user is able to click a button associated with the “property type” field in FIG. 3s. By clicking such button, a user is able to select the listing's property type from a list of predetermined classes. In the illustrative embodiment, the predetermined “property type” classes for a listing type of “residential for lease” include (a) house/duplex, (b) apartment, (c) townhome/condominium, and (d) other. Thus, in comparison to FIGS. 3j, 3k and 3r, screen 300 of FIG. 3s includes a different list of predetermined classes into which system 100 efficiently categorizes the listing. Advantageously, as discussed further hereinabove in connection with FIGS. 3j-k, website server 112 is programmable to perform different operations in response to the user-selected “property type” class.

Referring once again to FIG. 3h, in response to a user selecting “residential” as the “property type” class, selecting “for sale” as the “transaction type” class, and clicking “Continue” button 322, website server 112 causes the computing system's display device to display screen 300 of FIG. 3t instead of FIG. 3s (screen 300 of FIG. 3t includes a “property name” field, although such field is not shown in FIG. 3t for clarity). Accordingly, as discussed further hereinabove in connection with FIGS. 3h-k, website server 112 varies the new version of screen 300 according to the user-selected real estate listing type (e.g. combination of “property type” class and “transaction type” class).

Similar to FIG. 3s, screen 300 of FIG. 3t includes a set of fields, which are regions of screen 300 in which a user is able to specify alphanumeric character information. More particularly, in such fields (which are a notification that describes an information structure associated with the user-selected real estate listing type), a user is able to specify information about the user's real estate listing, according to the information structure of the user-selected real estate listing type, such as the listing's (a) property name, (b) property type, (c) street address, (d) city, (e) state, (f) ZIP code, (g) sales price, (h) number of bedrooms, (i) number of bathrooms, (j) square footage, and (k) property description. Thus, unlike FIG. 3s, screen 300 of FIG. 3s includes a “sales price” field instead of a “rent price” field. Again, such information is potentially relevant to a buyer's evaluation of the listed real estate when determining a level of interest.

Moreover, in a significant aspect of the illustrative embodiment, a user is able to click a button associated with the “property type” field in FIG. 3t. By clicking such button, a user is able to select the listing's property type from a list of predetermined classes. In the illustrative embodiment, the predetermined “property type” classes for a listing type of “residential for sale” include (a) house/duplex, (b) townhome/condominium, and (c) other. Thus, in comparison to FIGS. 3j, 3k, 3r and 3s, screen 300 of FIG. 3t includes a different list of predetermined. classes into which system 100 efficiently categorizes the listing. Advantageously, as discussed further hereinabove in connection with FIGS. 3j-k, website server 112 is programmable to perform different operations in response to the user-selected “property type” class.

FIG. 3u is a version of FIG. 3f after the user has created multiple listings through system 100. Screen 300 of FIG. 3u identifies the multiple listings according to each listing's account type and property name. In the example of FIG. 3u, three (3) such listings are so identified in screen 300. In a significant aspect of the illustrative embodiment, promptly after a user creates a particular listing through system 100, website server 112 adds the particular listing to its database and publishes the listing for viewing by other users (according to the user-specified manner and extent, as discussed further hereinabove in connection with FIG. 3q).

Also, adjacent to (and associated with) each listing, the user is able to click a respective region of screen 300 entitled, “Click here to edit.” In an alternative embodiment, in addition to the “Click here to edit” region, screen 300 of FIG. 3u displays a “number of viewers” count adjacent to (and associated with) each listing. The “number of viewers” count notifies the user about the number of other users who have thusfar viewed such listing through system 100.

In response to the user clicking a particular listing's respectively associated “Click here to edit” region, the computer outputs such fact to website server 112, and website server 112 detects such fact. In response thereto, website server 112 outputs at least one signal through network 116 to the user's associated computer, resulting in a display of the listing's detailed information (as stored in the database of website server 112) by the computing system's display device.

For example, in response to the user clicking the “Click here to edit” region of the “parktower” listing of screen 300 of FIG. 3u, the computer outputs at least one signal, resulting in a display of screen 300 of FIGS. 3v-w by the computing system's display device. By repositioning a scroll bar as shown in FIGS. 3v-w, a user is able to view all information of screen 300 therein. In response to screen 300 of FIGS. 3v-w, the user is able to review and revise the listing, in a similar manner as discussed further hereinabove in connection with FIGS. 3j-k.

After reviewing and revising the listing, the user is able to click either a “Save Changes” button or a “Cancel Changes” button of FIG. 3w. In response to the user clicking the “Save Changes” button in FIG. 3w, the computer outputs the user-specified information to website server 112, which detects such user-specified information and stores it in the database of website server 112. Conversely, in response to the user clicking the “Cancel Changes” button in FIG. 3w, the computer ignores any current changes in the user-specified information.

If the user wants to delete the listing, the user is able to click a region of screen 300 entitled, “Click here to delete listing,” as shown in FIG. 3v. In response to the user clicking such region, the computer outputs such fact to website server 112, which detects such fact and deletes the listing in the database of website server 112. Also, in response thereto, website server 112 outputs additional signals through network 116 to the computer, resulting in the display again of screen 300 of FIG. 3u by the computing system's display device (except omitting the deleted listing).

If the user wants to edit the user-specified photograph (from FIGS. 3l-n) of the listing, the user is able to click a region of screen 300 entitled, “Update Property Photo,” as shown in FIG. 3w. In response to the user clicking such region, the computer outputs such fact to website server 112, and website server 112 detects such fact. In response thereto, website server 112 outputs additional signals through network 116 to the computer, resulting in the display (by the computing system's display device) of screen 300 according to the sequence of FIGS. 3l-n, 3v and 3w, thereby giving the user an opportunity to revise any of the previously specified information.

Referring to FIG. 4a, the user-specified Internet address (as discussed further hereinabove in connection with FIGS. 3j-k) is useful for allowing a buyer to deep-link directly to a listing. In deep-linking directly to the listing, the buyer advantageously avoids (or “bypasses”) the home (or “first” or “top”) page and other pages, directories, sub-directories, documents and objects of the http://www.magiclamp.com Internet site (at which the listing is stored by system 100). For example, within a screen 400, FIG. 4a shows an e-mail message that includes a hyperlink to the user-specified address of http://www.parktower.magiclamp.com.

As shown in the example of FIG. 4a, a user is able to suitably position a cursor 402 and click the http://www.parktower.magiclamp.com hyperlink. In response thereto, the user's associated computer: (a) initiates execution of browser software, such as Microsoft Internet Explorer software, as shown in FIG. 4b; and (b) outputs such URL address (i.e. http://www.parktower.magiclamp.com) to network 116. In response to such transmission of the URL address, network 116 communicates with website server 112 through network router 118.

Website server 112 detects such communication (which is a request for screen 400 of FIG. 4b). In response thereto, website server 112 outputs one or more signals to the user's associated computer. Accordingly, through network 116 and network router 118, the computer receives such signals from website server 112. In response thereto, the computer outputs one or more signals to the computing system's display device, so that the display device displays screen 400 of FIG. 4b.

Moreover, as shown in a URL field 401 of FIG. 4b, website server 112 (in response to its programmed instructions and data) automatically redirected the user-specified URL address from http://www.parktower.magiclamp.com to http://www.magiclamp.com/html/subdomainSearch.cfm?propertysubdomain=parktower&order=Name. In response to such redirection, website server 112 outputs one or more signals to the computer, which receives such signals through network 116 and network router 118. In response thereto, the computer outputs one or more signals to the computing system's display device, so that the display device (in URL field 401 of FIG. 4b) displays http://www.magiclamp.com/html/subdomainSearch.cfm?propertysubdomain=parktower&order=Name as the URL address instead of http://www.parktower.magiclamp.com.

Similarly, in response to various actions by a user as discussed further hereinbelow in connection with FIGS. 4c-q, website server 112 (in response to its programmed instructions and data) outputs one or more signals through network 116 to the user's associated computer, so that the computing system's display device displays the versions of screen 400 (and the URL addresses of URL field 401) as shown in FIGS. 4c-q.

In a significant aspect of the illustrative embodiment, screen 400 of FIG. 4b identifies two listings named “parktower” in response to the user having clicked the http://www.parktower.magiclamp.com hyperlink. Notably, in that manner, system 100 permits multiple listings (e.g. created by multiple users) to share a property name, so that the corresponding user-specified Internet address (e.g. http://www.parktower.magiclamp.com) is the same for each such listing. In that situation, each such listing is addressable by the same corresponding user-specified Internet address (“selection address”) via an index page, such as screen 400 of FIG. 4b, which is associated with all such listings.

Conversely, if only a single listing has a particular name, the single listing is addressable by the corresponding user-specified Internet address via a respective page, such as screen 400 of FIG. 4d, which is associated with only the single listing. In an alternative embodiment, if the user pays a higher fee to the owner of the www.magiclamp.com Internet site for exclusive rights (during a period of time) in a particular Internet address (e.g. http://www.parktower.magiclamp.com), system 100 disallows other listings from other users to share the particular Internet address during the period of time. In that situation, during the period of time, only the higher paying user's listing is addressable by the particular Internet address via a respective page, such as screen 400 of FIG. 4d, which is associated with only the higher paying user's listing.

Significantly, such a “shared name” technique is practical if the listings describe real estate. For example, various real estate properties are distinct from one another by definition, especially in view of the fact that each real estate property is a physical object having a distinct physical address. Accordingly, even though each “shared name” listing is associated with the same index page at the same selection address, such as screen 400 of FIG. 4b, a sufficient amount of distinct information (about each “shared name” listing) is available for display within screen 400 to distinguish the “shared name” listings from one another.

In the example of FIG. 4b, the two identified listings share the same property name and state, yet are distinguished from one another by various descriptive (e.g. geographic and/or physical) information, such as street address, city, zip code, and property type. Accordingly, by reviewing the information of FIG. 4b, the user is able to distinguish the two identified listings from another, in order to identify and select one of the identified listings for a more detailed inspection. Advantageously, such a technique substantially overcomes the shortcoming of other services (e.g. America Online) in which various users encounter significant difficulty in selecting a name that has not already been reserved by another user.

As shown in the example of FIG. 4b, the user clicks the first listing, which describes a property located in Austin, Tex. In response thereto, website server 112 (in response to its programmed instructions and data) outputs one or more signals through network 116 to the user's associated computer, so that the computing system's display device displays the version of screen 400 (and its associated URL address (“detail address”) of URL field 401) as shown in FIG. 4c. Alternatively, if the user clicks the second listing of FIG. 4b, which describes a property located in Corpus Christi, Tex., website server 112 causes the computing system's display device to display the version of screen 400 (and its associated URL address (“detail address”) of URL field 401) as shown in FIG. 4d.

Notably, like the selection address, the detail addresses includes the “magiclamp.com” domain name. Nevertheless, in the illustrative embodiment, the selection address and the detail address are different from one another, as shown in FIGS. 4b, 4c and 4d. Significantly, referring to FIG. 4d, in response to the user clicking a “view map” region 406 of screen 400, website server 112 causes a map (for the listed real estate) to appear in screen 400 within a separate window, as shown in FIG. 4e.

Referring again to FIG. 3a, in response to a user clicking the “Property Search” button 304c, the user's associated computer outputs at least one signal, resulting in a display of screen 400 of FIG. 4f by the computing system's display device. In a significant aspect of the illustrative embodiment, screen 400 of FIG. 4f displays a list of gateways in which the user has previously registered (as discussed further hereinabove in connection with FIGS. 3b-c) and been approved by website server 112. For example, with regard to such approval, at least one of the user-selected “member type” classes is subject to verification by website server 112, as discussed further hereinabove in connection with FIG. 3g and hereinbelow in connection with FIG. 6d.

In the example of FIG. 4f, the user has been approved by website server 112 in the “Property Owner,” “Broker/Agent (Texas),” “Home Builder,” and “Mobile Home Dealer” gateways. Advantageously, in searching listings that are stored in the database of website server 112, the user is able to click one or more applicable boxes of screen 400 of FIG. 4f in order to (a) exclude non-gateway-specific listings from the search or (b) include one or more of the approved gateways within the search. By including a gateway within the search, the search will include listings that are published through the MagicNetwork service (discussed further hereinabove in connection with FIG. 3q) for viewing by users who are approved for searching in such gateway.

Accordingly, a particular listing can be published (according to FIG. 3q) through the MagicNetwork service for viewing by users in selected “member type” classes. As an example, if the particular listing is. published (according to FIG. 3q) through the MagicNetwork service for viewing by users in the broker/agent “member type” class, and if the listing's property is located in Texas, then such listing is published for viewing by users who are approved for searching in the “Broker/Agent (Texas)” gateway (i.e. by users who are verified by website server 112 as real estate broker/agents that are licensed in Texas).

If multiple gateways are sufficiently similar in terms of their information content types and search criteria, such gateways may be searched concurrently with one another. For example, the user is able to click both the “Property Owner” box and the “Broker/Agent (Texas)” box of screen 400 of FIG. 4f in order to search the “Property Owner” and “Broker/Agent (Texas)” gateways concurrently with one another. Conversely, the “Home Builder” and “Mobile Home Dealer” gateways are sufficiently distinct in terms of their information content types and/or search criteria, so that each such gateway is searched apart from any other gateway.

With screen 400 of FIG. 4f, a user is able to select a property type and a transaction type; similar to the manner discussed further hereinabove in connection with FIG. 3h. Notably, website server 112 varies the available real estate listing-types (e.g. “property type” classes and “transaction type” classes) in response to the user-selected gateway. For example, if the user selects the “Mobile Home Dealer” gateway, the available property types include “used,” “new” and “land.” In another example, if the user selects the “Home Builder” gateway, the available transaction types include “remodel” and “new construction.”

Moreover, website server 112 is advantageously programmable to perform different operations in response to the user-selected “property type” class and “transaction type” class, as discussed further hereinbelow in connection with FIGS. 4h-l. After a user has selected a “property type” class and a “transaction type” class, the user-selected classes are displayed in screen 400. As shown in the example of FIG. 4g, the user has selected the “Broker/Agent (Texas)” gateway, the “residential” property type, and the “for sale” transaction type. Also, after a user has selected a gateway, a “property type” class, and a “transaction type” class, a user is able to click a “Continue” button, as shown in FIG. 4g.

In response thereto, the user's associated computer outputs at least one signal, resulting in a display of screen 400 of FIG. 4h by the computing system's display device. With screen 400 of FIG. 4h, the user is able to select various criteria for searching “residential” and “for sale” listings that are stored in the database of website server 112. The criteria are selected in a similar manner as discussed further hereinabove in connection with FIG. 3t.

Accordingly, similar to FIG. 3t, screen 400 of FIG. 4h includes a set of fields, which are regions of screen 400 in which a user is able to specify alphanumeric character information. More particularly, in such fields, a user is able to select various criteria from a list of predetermined classes, such as the listing's (a) property type, such as any type, house/duplex, townhome/condominium, or other, (b) sales price range, such as a minimum of $0 up to $10,000, and a maximum of up to $10 million (or even no maximum), (c) minimum number of bedrooms, such as any or up to 5, (d) minimum number of bathrooms, such as any or up to: 4, (e) minimum square footage, such as any or up to 4,000, (f) city, and (g) state.

As shown in the example of FIG. 4i, in response to the user selecting “residential” and “for lease” in FIG. 4g (and then clicking the “Continue” button of FIG. 4g), the user's associated computer outputs at least one signal, resulting in a display of screen 400 of FIG. 4i by the computing system's display device. With screen 400 of FIG. 4i, the user is able to select various criteria for searching “residential” and “for lease” listings that are stored in the database of website server 112. The criteria are selected in a similar manner as discussed further hereinabove in connection with FIG. 3s.

Accordingly, similar to FIG. 3s, screen 400 of FIG. 4i includes a set of fields, which are regions of screen 400 in which a user is able to specify alphanumeric character information. More particularly, in such fields, a user is able to select various criteria from a list of predetermined classes, such as the listing's (a) property type, such as any type, house/duplex, apartment, townhome/condominium, or other, (b) lease price range, such as a minimum of $0 up to $500, and a maximum of up to $10,000, (c) minimum number of bedrooms, such as any or up to 5, (d) minimum number of bathrooms, such as any or up to 4, (e) minimum square footage, such as any or up to 4,000, (f) city, and (g) state.

As shown in the example of FIG. 4j, in response to the user selecting “commercial” and “for sale” in FIG. 4g (and then clicking the “Continue” button of FIG. 4g), the user's associated computer outputs at least one signal, resulting in a display of screen 400 of FIG. 4j by the computing system's display device. With screen 400 of FIG. 4j, the user is able to select various criteria for searching “commercial” and “for sale” listings that are stored in the database of website server 112. The criteria are selected in a similar manner as discussed further hereinabove in connection with FIG. 3r.

Accordingly, similar to FIG. 3r, screen 400 of FIG. 4j includes a set of fields, which are regions of screen 400 in which a user is able to specify alphanumeric character information. More particularly, in such fields, a user is able to select various criteria from a list of predetermined classes, such as the listing's (a) property type, such as any type, apartments, office, retail, warehouse, land, or other, (b) sales price range, such as a minimum of $0 and a maximum of up to $10 million, (c) minimum square footage, such as any or up to 50,000, (d) city, and (e) state.

As shown in the example of FIG. 4k, in response to the user selecting “commercial” and “for lease” in FIG. 4g (and then clicking the “Continue” button of FIG. 4g), the user's associated computer outputs at least one signal, resulting in a display of screen 400 of FIG. 4k by the computing system's display device. With screen 400 of FIG. 4k, the user is able to select various criteria for searching “commercial” and “for lease” listings that are stored in the database of website server 112. The criteria are selected in a similar manner as discussed further hereinabove in connection with FIGS. 3j-k.

Accordingly, similar to FIGS. 3j-k, screen 400 of FIG. 4k includes a set of fields, which are regions of screen 400 in which a user is able to specify alphanumeric character information. More particularly, in such fields, a user is able to select various criteria from a list of predetermined classes, such as the listing's (a) property type, such as any type, office, retail, warehouse, land, or other, (b) lease price range, such as a minimum of $0, and a maximum of up to $10,000, (c) minimum square footage, such as any or up to 50,000, (d) city, and (e) state.

As shown in FIG. 41, the user has specified (a) an office property type, (b) a lease price range between a minimum of $0 and a maximum of $10,000, (c) any square footage, (d) any city, and (e) the state of Texas. In response to the user clicking a “Rub the Lamp” button as shown in FIG. 41, the user's associated computer outputs such user-specified information to network 116. In response to such transmission of such user-specified information, network 116 communicates with website server 112 through network router 118.

Website server 112 detects such communication (which is a request for website server 112 to execute a search of listings that are stored in its database, according to the user-specified criteria). In response thereto, website server 112 executes a search of listings that are stored in its database, according to the user-specified criteria, and outputs one or more signals to the user's associated computer. Similarly, in response to the user clicking the “Rub the Lamp” button of FIGS. 4h, 4i or 4j, website server 112 executes a search of listings that are stored in its database, according to the user-specified criteria, and outputs one or more signals to the user's associated computer.

Such signals are representative of results of the search executed by website server 112. Accordingly, through network 116 and network router 118, the user's associated computer receives such signals from website server 112. In response thereto, the computer outputs one or more signals to the computing system's display device, so that the display device displays results of the search executed by website server 112.

One example is screen 400 of FIG. 4m, which displays results of the search executed by website server 112 in response to the user clicking the “Rub the Lamp” button as shown in FIG. 41. In FIG. 4m, multiple listings are displayed, each satisfying the user-specified criteria of FIG. 4l. Initially, the search results are alphabetically sorted according to (a) first, property name and (b) second, city name.

Notably, the second listing includes a notation 408, which indicates that such listing is published through the MagicNetwork service (discussed further hereinabove in connection with FIG. 3q). In one embodiment, users are contractually obligated to maintain secrecy of listings that are published through the MagicNetwork service (or published to a predefined group), in order to maintain a user-specified limited audience for such listings. Before the second listing is displayed in FIG. 4m, website server 112 (a) first, identifies the user's “member type” class, and (b) second, determines whether such listing was published through the MagicNetwork service for viewing by such identified “member type” class.

For example, although the second listing has a “parktower” property name, it did not appear in screen 400 of FIG. 4b, because: (a) such listing was published through the MagicNetwork service; and (b) screen 400 of FIG. 4b was displayed in response to the user's associated computer outputting a URL address (i.e. http://www.parktower.magiclamp.com) to network 116, without regard to the user's “member type” class. Accordingly, although the second listing has a “parktower” property name, it did not appear in screen 400 of FIG. 4b, because screen 400 of FIG. 4b was displayed without website server 112 (a) first, identifying the user's “member type” class, and (b) second, determining whether such listing was published through the MagicNetwork service for viewing by such identified “member type” class.

In FIG. 4m, the user positions cursor 402 adjacent to the first-listed “parktower” property name. In response thereto, the display device displays a property description as shown in FIG. 4n. The property description is associated with the first-listed “parktower” property name. Notably, such property description is readily displayed by the computing device of buyer 110, which (in the illustrative embodiment) is a portable battery-powered handheld computing device.

As shown in FIG. 4o, in response to the user clicking on the “Zip” heading, the computer outputs one or more signals to the computing system's display device, so that the display device displays results of the search numerically sorted according to Zip code. Similarly, as shown in FIG. 4p, in response to the user clicking on the “Size” heading, the computer outputs one or more signals to the computing system's display device, so that the display device displays results of the search numerically sorted according to square footage. Likewise, as shown in FIG. 4q, in response to the user clicking on the “Rent” heading, the computer outputs one or more signals to the computing system's display device, so that the display device displays results of the search numerically sorted according to rent (i.e. lease price).

FIG. 5 is a conceptual illustration of operations performed by website server 112 according to member types and account types. As discussed further hereinabove in connection with FIG. 3g, for each real estate listing, website server 112 allows the user to select one of at least three (3) account types having various features. Advantageously, website server 112 is programmable to perform different operations in response to the user-selected account type and “member type” class.

For example, as shown in FIG. 5, for a “Basic” listing (“Basic” account type), which is provided to the user at no fee by the owner of the www.magiclamp.com Internet site, website server 112 is programmable to perform different operations in response to the user-selected “member type” class. For a “Basic” listing, if the user-selected “member type” class is real estate company, then website server 112 allows the user (e.g. associated with seller 104) to bulk upload a large number of real estate listings for (a) storage in the database of website server 112, (b) searching via the MagicLamp Internet site by users of system 100, and (c) display by system 100 to such users in response to their search queries that are specified to website server 112 externally, as discussed further hereinabove in connection with FIGS. 4f-q.

In view of the potentially large number of such bulk upload listings, website server 112 (a) disallows such a bulk upload user from specifying URL addresses for defining routes to the real estate listings and (b) stores and publishes such bulk upload listings in a dynamic HTML format. Otherwise, for example, the number of real estate listings (e.g. that share a particular URL address, or that are searched and indexed by Internet search engines) could be unacceptably large and difficult to manage.

Likewise, website server 112 disallows such a bulk upload user from, as discussed further hereinabove in connection with FIG. 3q, (a) defining a group for publishing the listing or (b) specifying publication of the listing through the MagicNetwork service (e.g. selecting a subset of “member type” classes of users that are allowed to view the listing in response to their search queries) or (c) specifying publication of the listing in a manner that, in addition to viewing through the Internet via the MagicLamp Internet site, further permits viewing by all “member type” classes of users through the Internet via one or more non-MagicLamp Internet sites (e.g. www.yahoo.com of advertiser 114).

Also, for a “Basic” listing, if the user-selected “member type” class is broker/agent (e.g. individual broker/agent other than a real estate company), then website server 112 allows the user (e.g. associated with seller 102) to create a real estate listing for (a) storage in the database of website server 112, (b) searching via the MagicLamp Internet site by users of system 100, and (c) display by system 100 to such users in response to their search queries that are specified to website server 112 externally, as discussed further hereinabove in connection with FIGS. 4f-q.

For a “Basic” listing, website server 112 disallows such a broker/agent user from specifying a URL address for defining a route to the real estate listing. Otherwise, for example, the broker/agent users would have less incentive to pay a fee to the owner of the www.magiclamp.com Internet site, as for example in exchange for a “Genie” listing (“Genie” account type) or a “Magic” listing (“Magic” account type).

Likewise, website server 112 disallows such a broker/agent user from (a) creating more than one “Basic” listing or (b) as discussed further hereinabove in connection with FIG. 3q, (i) defining a group for publishing the listing or (ii) specifying publication of the listing through the MagicNetwork service (e.g. selecting a subset of “member type” classes of users that are allowed to view the listing in response to their search queries) or (iii) specifying publication of the listing in a manner that, in addition to viewing through the Internet via the MagicLamp Internet site, further permits viewing by all “member type” classes of users through the Internet via one or more non-MagicLamp Internet sites (e.g. www.yahoo.com of advertiser 114).

Moreover, for a “Basic” listing, if the user-selected “member type” class is property owner (e.g. individual seller who is neither a real estate company nor a broker/agent), then website server 112 allows the user (e.g. associated with seller 102) to create a real estate listing for (a) storage in the database of website server 112, (b) searching via the MagicLamp Internet site by users of system 100, and (c) display by system 100 to such users in response to their search queries that are specified to website server 112 externally, as discussed further hereinabove in connection with FIGS. 4f-q. Also, website server 112 allows such a property owner user to specify a URL address for defining a route to the real estate listing.

Notably, website server 112 disallows such a property owner user from (a) creating more than one “Basic” listing or (b) as discussed further hereinabove in connection with FIG. 3q, (i) defining a group for publishing the listing or (ii) specifying publication of the listing through the MagicNetwork service (e.g. selecting a subset of “member type” classes of users that are allowed to view the listing in response to their search queries) or (iii) specifying publication of the listing in a manner that, in addition to viewing through the Internet via the MagicLamp Internet site, further permits viewing by all “member type” classes of users through the Internet via one or more non-MagicLamp Internet sites (e.g. www.yahoo.com of advertiser 114). Otherwise, for example, the broker/agent users would have less incentive to pay a fee to the owner of the www.magiclamp.com Internet site, as for example in exchange for a “Genie” listing or a “Magic” listing.

If a broker/agent user pays a fee to the owner of the www.magiclamp.com Internet site in exchange for a “Genie” listing or a “Magic” listing, then website server 112. allows the user to (a) specify a URL address for defining a route to the real estate listing, (b) create more than one “Genie” listing, and (c) as discussed further hereinabove in connection with FIG. 3q, either (i) define a group for publishing the listing or (ii) specify publication of the listing through the MagicNetwork service (e.g. selecting a subset of “member type” classes of users that are allowed to view the listing in response to their search queries) or (iii) specify publication of the listing in a manner that, in addition to viewing through the Internet via the MagicLamp Internet site, further permits viewing by all “member type” classes of users through the Internet via one or more non-MagicLamp Internet sites (e.g. www.yahoo.com of advertiser 114). For such a user, the features of a “Genie” listing and a “Magic” listing are identical, except that website server 112 stores and publishes a “Magic” listing in a static HTML format, which increases the “Magic” listing's individual searchability and indexing by Internet search engines. Website server 112 stores and publishes all “Basic” listings and “Genie” listings in a dynamic HTML format, so the user has incentive to pay an extra fee to the owner of the www.magiclamp.com Internet site in exchange for a “Magic” listing. Accordingly, (a) by selecting a “Magic” account type, the user selects a static HTML format, and (b) by selecting a “Basic” or “Genie” account type, the user selects a dynamic HTML format.

If a real estate company user pays a fee to the owner of the www.magiclamp.com Internet site in exchange for a “Magic” listing, then website server 112 allows the user to create a listing that describes the real estate company. Website server 112 stores such a listing in its database for (a) searching via the MagicLamp Internet site by users of system 100 and (b) display by system 100 to such users in response to their search queries that are specified to website server 112 externally. For such a listing, website server 112 allows the user to (a) specify a URL address for defining a route to the listing, (b) create more than one “Magic” listing, and (c) as discussed further hereinabove in connection with FIG. 3q, either (i) define a group for publishing the listing or (ii) specify publication of the listing through the MagicNetwork service (e.g. selecting a subset of “member type” classes of users that are allowed to view the listing in response to their search queries) or (iii) specify publication of the listing in a manner that, in addition to viewing through the Internet via the MagicLamp Internet site, further permits viewing by all “member type” classes of users through the Internet via one or more non-MagicLamp Internet sites (e.g. www.yahoo.com of advertiser 114). Moreover, website server 112 stores and publishes such a “Magic” listing in a static HTML format.

Accordingly, in the illustrative embodiment, from the user through network 116, website server 112 receives a selection between multiple “types” which are respectively associated with various services. Website server 112 performs an operation in response to the listing, according to the user-selected type's associated service. For example, one such associated service includes an operation of storing and publishing the listing in a static HTML format. Another associated service includes an operation of storing and publishing the listing in a dynamic HTML format.

Yet another associated service includes an operation of publishing the listing for viewing by all “member type” classes of users through the Internet via one or more non-MagicLamp Internet sites (e.g. www.yahoo.com of advertiser 114), in addition to viewing through the Internet via the MagicLamp Internet site. Moreover, as discussed further hereinabove in connection with FIG. 3g and hereinbelow in connection with FIG. 6i, website server 112 is programmable to delete the user's real estate listing, according to different criteria, in response to the user's selection of either a “Basic” account type, a “Genie” account type, or a “Magic” account type. Accordingly, another associated service includes an operation of publishing (for a period of time according to the type) the stored listing for viewing through the Internet via the MagicLamp Internet site.

In the illustrative embodiment, the “type” is a particular combination of (a) account type of the stored listing and (b) “member type” class of the user (e.g. a geographical aspect of the user). In an alternative embodiment, the “type” is a particular account type, irrespective of the particular “member type” class. In another alternative embodiment, the “type” is a particular “member type” class, irrespective of the particular account type. In yet another alternative embodiment, the “type” is a particular listing type of the real estate, irrespective of the particular account type, and irrespective of the particular “member type” class. In a further alternative embodiment, the “type” is a particular combination of two or more of the following: (a) account type, (b) “member type” class, and (c) listing type.

Moreover, the multiple “types” are respectively associated with various information structures. In response to the user-selected type, website server 112 is programmable to (a) selectively output notifications (for display to the user) that describe the user-selected type's associated information structure and (b) from the user, receive information about the real estate, according to such information structure. Such a feature is discussed further hereinabove in connection with FIGS. 3b-t.

FIGS. 6a-i are flowcharts of various operations performed by website server 112. The operations shown in FIGS. 6a-i are illustrative, and not exhaustive, of the operations performed by website server 112. More particularly, FIG. 6a is a flowchart of the operation in which website server 112 (in response to commands from a human system administrator of website server 112) establishes a variety of “member type” classes, account types, and features of such “member type” classes and account types, as discussed further hereinabove in connection with FIG. 5.

Referring to FIG. 6a, the operation starts at a step 600, at which website server 112 defines a particular “member type” class (e.g. broker/agent). After step 600, the operation continues to a step 602, at which website server 112 defines a particular account type (e.g. “Genie”) that is available for selection by users in the particular “member type” class. After step 604, the operation continues to a step 604, at which website server 112 defines a particular feature (or service) that is available for the particular combination of “member type” class and account type. An example of such feature is the MagicNetwork service.

After step 604, the operation continues to a step 606, at which website server 112 determines whether a user-selectable option is to be defined for the defined feature (or service). An example of such option is the user's selection of “member type” classes of users that are allowed to view a MagicNetwork listing in response to their search queries. If yes, then website server 112 defines such option at a step 608, and the operation continues to a step 610. If no, the operation continues directly to step 610.

At step 610, website server 112 determines whether any additional feature (or service) is to be defined for the particular combination of “member type” class and account type. If yes, the operation returns to step 604. If no, the operation continues to a step 612.

At step 612, website server 112 determines whether an additional account type is to be defined as available for selection by users in the particular “member type” class. If yes, the operation returns to step 602. If no, the operation continues to a step 614.

At step 614, website server 112 determines whether an additional “member type” class is to be defined. If yes, the operation returns to step 600. If no, the operation ends.

FIG. 6b is a flowchart of the operation in which website server 112 receives and stores selections from a user, as discussed further hereinabove in connection with FIGS. 3a-w, 4a-q and 5. The operation starts at a step 620, at which website server 112 determines the “member type” classes that were defined in step 600 of FIG. 6a. After step 620, the operation continues to a step 622, at which website server 112 displays the defined “member type” classes to the user (e.g. FIG. 3b). After step 622, the operation continues to a step 624, at which website server 112 receives and stores (in its database) the user's selection of a displayed “member type” class (e.g. as discussed further hereinabove in connection with FIGS. 3b and 3c).

After step 624, the operation continues to a step 626, at which website server 112 determines the account types that were defined in step 602 of FIG. 6a as being available for selection by users in the user-selected “member type” class. After step 626, the operation continues to a step 628, at which website server 112 displays the defined account types to the user (e.g. FIG. 3g). After step 628, the operation continues to a step 630, at which website server 112 receives and stores (in its database) the user's selection of a displayed account type (e.g. as discussed further hereinabove in connection with FIG. 3g).

After step 630, the operation continues to a step 632, at which website server 112 determines the features (or services) that were defined in step 604 of FIG. 6a as being available for the user-selected combination of “member type” class and account type. After step 632, the operation continues to a step 634, at which website server 112 determines the user-selectable option(s), if any, that were defined in step 608 of FIG. 6a for the defined features (or services). After step 634, the operation continues to a step 636, at which website server 112 displays the defined options to the user (e.g. FIGS. 3h-q). After step 636, the operation continues to a step 638, at which website server 112 receives and stores (in its database) the user's selection of various defined options (e.g. as discussed further hereinabove in connection with FIGS. 3h-q). After step 638, the operation ends.

FIG. 6c is a flowchart of the operation in which website server 112 executes the user-selected services and options. The operation starts at a step 640, at which website server 112 determines (e.g. by reading from its database) the user's selection of a “member type” class (e.g. as discussed further hereinabove in connection with step 624 of FIG. 6b). After step 640, the operation continues to a step 642, at which website server 112 determines (e.g. by reading from its database) the user's selection of an account type (e.g. as discussed further hereinabove in connection with step 630 of FIG. 6b).

After step 642, the operation continues to a step 644, at which website server 112 determines the features (or services) that were defined in step 604 of FIG. 6a as being available for the user-selected combination of “member type” class and account type. After step 644, the operation continues to a step 646, at which website server 112 determines (e.g. by reading from its database) the user's selection of various defined options (e.g. as discussed further hereinabove in connection with step 638 of FIG. 6b). After step 648, the operation continues to a step 648, at which website server 112 executes the user-selected services and options. After step 648, the operation ends.

FIG. 6d is a flowchart of the operation in which website server 112 performs verification of a particular user's qualification to belong within the user's selected “member type” class, if such class is subject to verification. In the illustrative embodiment, broker/agents are subject to verification. In an alternative embodiment, real estate companies are likewise subject to verification.

In FIG. 6d, the operation starts at a step 650, at which website server 112 determines whether it has received qualification information (e.g. as discussed further hereinabove in connection with fields 312 of FIG. 3c) from the source (e.g. the user). If no, the operation self-loops at step 650. If yes, the operation continues to a step 652, at which website server 112 reads information from various computer databases and, in response thereto, determines whether the user's identity is verified (or “authenticated”) in relation to the qualification information.

For example, if the user's selected “member type” class is broker/agent, website server 112 receives information from a computer database of a real estate authority (e.g. a governmental authority) through network 116. Such information (from the real estate authority) includes information that describes whether the user's name matches a name that is listed (in the real estate authority's database) as belonging to a licensed broker/agent and, if so, the valid real estate license number assigned to such name.

Moreover, website server 112 receives information from a computer database of an authentication authority (e.g. credit card issuer) through network 116. Website server 112 receives such information after website server 112 outputs the user-specified credit card information (of fields 312) to the authentication authority through network 116. Such information (from the authentication authority) includes information that authenticates whether the user-specified credit card information is accurate in relation to the authentication authority's database.

If all of the following conditions are satisfied, website server 112 verifies the user's identity in relation to the qualification information:

(a) the user's name matches a name that is listed (in the real estate authority's database) as belonging to a licensed broker/agent;

(b) the user-specified real estate license number (of fields 312) matches the valid real estate license number assigned to such name, as received from the real estate authority's database; and

(c) the user-specified credit card information is authenticated by the authentication authority as being accurate in relation to the authentication authority's database.

After step 652, the operation continues to a step 654, at which website server 112 determines whether the user's identity is verified in relation to the qualification information. If yes, website server 112 outputs a message to the source at a step 656, confirming the user's authorization (e.g. confirming the particular user's qualification to belong within the user's selected “member type” class). If no, website server 112 outputs a message to the source at a step 658, denying the user's authorization. After step 656 or step 658, the operation returns to step 650.

FIG. 6e is a flowchart of the operation in which website server 112 creates a listing in response to information from a user, as discussed further hereinabove in connection with FIGS. 3f-t and 5. The operation starts at a step 660, at which website server 112 determines whether the user has requested a new listing (e.g. as discussed further hereinabove in connection with FIG. 3f). If no, the operation self-loops at step 660. If yes, the operation continues to a step 662.

At step 662, website server 112 determines whether the user has requested a “Basic” listing. If yes, the operation continues to a step 664, at which website server 112 (a) outputs the “Basic” listing screens according to the user's selected “member type” class and (b) receives “Basic” listing information from the user in response thereto. After step 664, the operation continues to a step 666, at which website server 112 creates the listing according to the user's selected “member type” class, in a dynamic HTML format, at the route defined by the user-specified URL address. After step 666, the operation returns to step 660.

At step 662, if website server 112 determines that the user has not requested a “Basic” listing, the operation continues to a step 668, at which website server 112 determines whether the user has requested a “Genie” listing. If no, the operation continues to a step 670, at which website server 112 determines whether the user has requested a “Magic” listing. If no, the operation returns to step 660.

At step 668 or step 670, if website server 112 determines that the user has requested either a “Genie” “listing” or a “Magic” listing, the operation continues to a step 672. At step 672, website server 112 determines whether the user's selected “member type” class is subject to verification. If yes, the operation continues to a step 674, at which website server 112 determines whether the whether the user's identity is verified (e.g. as discussed further hereinabove in connection with FIG. 6d).

At step 674, if website server 112 determines that the user's identity is. not verified, the operation continues to a step 676, at which website server outputs a message to the source (e.g. the user), denying the listing and asking the source for qualification information. After step 676, the operation returns to step 660.

At step 672, if website server 112 determines that the user's selected “member type” class is not subject to verification, the operation continues to a step 678. At step 678, website server 112 outputs a message to the source, asking for payment (e.g. credit card) information (e.g. as discussed further hereinabove in connection with fields 312 of FIG. 3c). Also, at step 678, website server 112 receives such payment information from the source, in order to ensure the user's payment of fees to the owner of the www.magiclamp.com Internet site in exchange for the new listing.

After step 678, the operation continues to a step 680. Also, at step 674, if website server 112 determines that the user's identity is verified, the operation continues to step 680, because such verification includes payment information. At step 680, website server 112 (a) outputs the “Genie”/“Magic” listing screens according to the user's selected “member type” class and (b) receives “Genie”/“Magic” listing information from the user in response thereto.

After step 680, the operation continues to a step 682, at which website server 112 determines whether the user has requested a “Genie” “listing” or a “Magic” listing. If a “Magic” listing, the operation continues to a step 684, at which website server 112 creates the listing according to the user's selected “member type” class, in a static HTML format, at the route defined by the user-specified URL address. Conversely, if the user has requested a “Genie” listing, the operation continues to a step 686, at which website server 112 creates the listing according to the user's selected “member type” class, in a dynamic HTML format, at the route defined by the user-specified URL address. After either step 684 or step 686, the operation returns to step 660.

FIG. 6f is a flowchart of the operation in which website server 112 receives, stores (in its database), and executes the user's selection of various defined options (e.g. as discussed further hereinabove in connection with FIGS. 3h-q, 6b, and 6c). The operation starts at a step 690, at which website server 112 determines whether the user is allowed to specify a URL address for defining a route to the listing. If yes, the operation continues to a step 692, at which website server 112 determines whether the user has specified the URL address.

At step 692, if website server 112 determines that the user has specified the URL address, website server 112 receives and stores (in its database) the URL address at a step 694. After step 694, the operation continues to a step 696. Also, at step 690, if website server 112 determines that the user is disallowed from specifying a URL address, the operation continues to step 696. Likewise, at step 692, if website server 112 determines that the user has not specified the URL. address, the operation continues to step 696.

At step 696, website server 112 determines whether the user is allowed to publish the listing through the MagicNetwork service (e.g. selecting a subset of “member type” classes of users that are allowed to view the listing in response to their search queries), as discussed further hereinabove in connection with FIG. 3q. If yes, the operation continues to a step 698, at which website server 112 determines whether the user has specified the manner in which the listing is to be published through the MagicNetwork service.

At step 698, if website server 112 determines that the user has specified the manner in which the listing is to be published through the MagicNetwork service, website server 112 receives and stores (in its database) the user's specification of such manner at a step 700. After step 700, the operation continues to a step. 702. Also, at step 696, if website server 112 determines that the user is disallowed from specifying publication of the listing through the MagicNetwork service, the operation continues to step 702. Likewise, at step 692, if website; server 112 determines that the user has not specified the manner in which the listing is to be published through the MagicNetwork service, the operation continues to step 702.

At step 702, website server 112 determines whether the user is allowed to define a group for publishing the listing, as discussed further hereinabove in connection with FIG. 3q. If yes, the operation continues to a step 704, at which website server 112 determines whether the user has specified the manner in which the listing is to be published through the group.

At step 704, if website server 112 determines that the user has specified the manner in which the listing is to be published through a group, website server 112 receives and stores (in its database) the user's specification of such manner at a step 706. After step 706, the operation continues to a step 708, at which website server 112 disables general searchability (e.g. as discussed further hereinabove in connection with FIGS. 4f-q) of the listing.

Conversely, at step 704, if website server 112 determines that the user has not specified the manner in which the listing is to be published through a group, the operation continues to a step 710. At step 710, website server 112 enables general searchability (e.g. as discussed further hereinabove in connection with FIGS. 4f-q) of the listing. After either step 708 or step 710, the operation ends.

FIG. 6g is a flowchart of the operation in which website server 112 publishes listings in a manner that permits viewing by all “member type” classes of users through the Internet via one or more non-MagicLamp Internet sites of other advertisers (e.g. in Yahoo Classifieds via www.yahoo.com), as discussed further hereinabove in connection with FIG. 3q. The operation starts at a step 710, at which website server 112 determines whether a period of thirty (30) days has expired, as measured by a timer. If no, the operation self-loops at step 710. If yes, the operation continues to a step 712, at which website server 112 identifies current listings that are authorized by users (as discussed further hereinabove in connection with FIG. 3q) for such publication via one or more non-MagicLamp Internet sites of other advertisers.

After step 712, the operation continues to a step 714, at which website server 112 creates one or more files for transfer to the non-MagicLamp Internet sites of other advertisers. Such files include relevant information about the listings identified in step 712. For example, the procedure and file format for Yahoo Classifieds are discussed in FIGS. 7a-b.

After step 714, the operation continues to a step 716, at which website server 112 outputs such files to the non-MagicLamp Internet sites of other advertisers. After step 716, the operation continues to a step 718, at which website server 112 resets the thirty (30) day timer. After step 718, the operation returns to step 710.

FIG. 6h is a flowchart of the operation in which website server 112 allows a user (e.g. associated with seller 104) to bulk upload a large number of real estate listings for (a) storage in the database of website server 112, (b) searching via the MagicLamp Internet site by users of system 100, and (c) display by system 100 to such users in response to their search queries that are specified to website server 112 externally, as discussed further hereinabove in connection with FIGS. 4f-q and 5.

The operation starts at a step 720, at which website server 112 determines whether a user (e.g. associated with seller 104) has requested such a bulk upload. If no, the operation self-loops at step 720. If yes, the operation continues to a step 722.

At step 722, website server 112 determines whether the user is an authorized source of such a bulk upload (e.g. whether the user-selected “member. type” class is real estate company whose identity has been verified by website server 112 in relation to qualification information), as discussed further hereinabove in connection with FIG. 5 and FIG. 6d. If yes, the operation continues to a step 724, at which website server 112 receives a file containing a real estate listing. After step 724, the operation continues to a step 726, at which website server 112 publishes such listing in a dynamic HTML format for (a) storage in the database of website server 112, (b) searching via the MagicLamp Internet site by users of system 100, and (c) display by system 100 to such users in response to their search queries that are specified to website server 112 externally, as discussed further hereinabove in connection with FIGS. 4f-q and 5.

After step 726, the operation continues to a step 728, at which website server 112 determines whether all such files have been received. If no, the operation returns to step 724. If yes, the operation returns to step 720.

At step 722, if website server 112 determines that the user is not an authorized source of such a bulk upload, the operation continues to a step 730, at which website server 112 outputs a message to the source (e.g. the user), denying the listing and asking the source for qualification information. After step 730, the operation returns to step 720.

FIG. 6i is a flowchart of the operation in which website server 112 deletes real estate listings, according to different criteria, in response to the user's selection of either the “Basic Website” button, the “Genie Website” button, or the “Magic Website” button, as discussed further hereinabove in connection with FIG. 3g. The operation starts at a step 732, at which website server 112 determines whether a period of thirty (30) days has expired, as measured by a timer. If no, the operation self-loops at step 732. If yes, the operation continues to a step 734, at which website server 112 determines whether a listing is a “Basic” listing.

At step 734, if website server 112 determines that the listing is a “Basic” listing, the operation continues to a step 736. At step 736, website server 112 deletes the listing, so that it is no longer published for (a) storage in the database of website server 112, (b) searching via the MagicLamp Internet site by users of system 100, or (c) display by system 100 to such users. After step 736, the operation continues to a step 738, at which website server 112 determines whether the listing is the final listing.

At step 738, if website server 112 determines that the listing is the final listing, the operation continues to a step 740. At step 740, website server 112 resets the thirty (30) day timer. After step 740, the operation returns to step 732.

At step 738, if website server 112 determines that the listing is not the final listing, the operation returns to step 734 for a next listing.

At step 734, if website server 112 determines that the listing is not a “Basic” listing, the operation continues to a step 742. At step 742, website server 112 determines whether the listing is a “Genie” listing. If no, the operation continues to a step 744, at which website server 112 determines whether the listing is a “Magic” listing. If no, the operation continues to step 738.

If website server 112 determines at step 742 that the listing is a “Genie” listing, or if website server 112 determines at step 744 that the listing is a “Magic” listing, the operation continues to a step 746. At step 746, website server 112 determines whether the owner of the www.magiclamp.com Internet site has received timely payment of applicable fees from the user who created the listing. If no, the operation continues to step 736. If yes, the operation continues to step 738.

Referring again to FIG. 2, computer-readable medium 212 is a floppy diskette. Computer-readable medium 212 and computer 204 are structurally and functionally interrelated with one another as discussed further hereinbelow. Each computing device of the illustrative embodiment is structurally and functionally interrelated with a respective computer-readable medium, similar to the manner in which computer 204 is structurally and functionally interrelated with computer-readable medium 212. In that regard, computer-readable medium 212 is a representative one of such computer-readable media, including for example but not limited to computer-readable medium 214.

Computer-readable medium 212 stores (or encodes, or records, or embodies) functional descriptive material (e.g. including but not limited to software (also referred to as computer programs or applications) and data structures). Such functional descriptive material imparts functionality when encoded on computer-readable medium 212. Also, such functional descriptive material is structurally and functionally interrelated to computer-readable medium 212.

Within such functional descriptive material, data structures define structural and functional interrelationships between such data structures and computer-readable medium 212 (and other aspects of computer 204, computing system 200 and system 100). Such interrelationships permit the data structures' functionality to be realized. Also, within such functional descriptive material, computer programs define structural and functional interrelationships between such computer programs and computer-readable medium 212 (and other aspects of computer 204, computing system 200 and system 100). Such interrelationships permit the computer programs' functionality to be realized.

For example, computer 204 reads (or accesses, or copies) such functional descriptive material from computer-readable medium 212 into the memory device of computer 204, and computer 204 performs its operations (as discussed elsewhere herein) in response to such material which is stored in the memory device of computer 204. More particularly, computer 204 performs the operation of processing a computer application (that is stored, encoded, recorded or embodied on a computer-readable medium) for causing computer 204 to perform additional operations (as discussed elsewhere herein). Accordingly, such functional. descriptive material exhibits a functional interrelationship with the way in which computer 204 executes its processes and performs its operations.

Further, the computer-readable medium is an apparatus from which the computer application is accessible by computer 204, and the computer application is processable by computer 204 for causing computer 204 to perform such additional operations. In addition to reading such functional descriptive material from computer-readable medium 212, computer 204 is capable of reading such functional descriptive material from (or through) network 116 which is also a computer-readable medium (or apparatus). Moreover, the memory device of computer 204 is itself a computer-readable medium (or apparatus).

Notably, the features of system 100 are readily combinable with the features of the Allaire Developer's Exchange and Custom Tags available from Allaire Corporation, One Alewife Center, Cambridge, Mass. 02140, 1-888-939-2545.

Although illustrative embodiments have been shown and described, a wide range of

What is claimed is:

1. A method performed by a computing system, the method comprising:
from a user through a global computer network, receiving:
first information about real estate; and
second information; and
in association with an address within the global computer network, storing at least a portion of the first information, the address including a domain name and the second information; and
through the global computer network, in association with receiving the first information, outputting a notification of the address to the user.

2. The method of claim 1 wherein the second information is about the real estate.

3. The method of claim 1 wherein the outputting comprises:
before receiving the first information, outputting the notification describing that the address includes the domain name and the second information.

4. A method performed by a computing system, the method comprising:
from a user through a global computer network, receiving:
first information about real estate; and
second information; and
in association with an address within the global computer network, storing at least a portion of the first information, the address including a domain name and the second information separated from one another by only a single character.

5. The method of claim 4 wherein the address is a first address, and wherein the receiving comprises:
receiving the first and second information from the user through a second address within the global computer network, the second address including the domain name.

6. The method of claim 4 wherein the second information is about the real estate.

7. The method of claim 4 and comprising:
through the global computer network, in association with receiving the first information, outputting a notification of the address to the user.

8. The method of claim 7 wherein the outputting comprises:
before receiving the first information, outputting the notification describing that the address includes the domain name and the second information.

9. The method of claim 4 wherein the domain name is preceded by the second information.

10. The method of claim 9 wherein the single character is a dot.

11. The method of claim 4 wherein the domain name is followed by the second information.

12. The method of claim 11 wherein the single character is a slash.

13. The method of claim 4 wherein the computing system includes first and second computing devices, and wherein:
the receiving comprises:
with the first computing device, receiving the first and second information; and
the storing comprises:
with the second computing device, storing at least the portion of the first information.

14. A computing system, comprising:
at least one device for:
from a user through a global computer network, receiving:
first information about real estate; and
second information; and
in association with an address within the global computer network, storing at least a portion of the first information, the address including a domain name and the second information separated from one another by only a single character.

15. The system of claim 14 wherein the address is a first address, and wherein the device is for:
receiving the first and second information from the user through a second address within the global computer network, the second address including the domain name.

16. The system of claim 14 wherein the second information is about the real estate.

17. The system of claim 14 wherein the device is for:
through the global computer network, in association with receiving the first information, outputting a notification of the address to the user.

18. The system of claim 17 wherein the device is for:
before receiving the first information, outputting the notification describing that the address includes the domain name and the second information.

19. The system of claim 14 wherein the domain name is preceded by the second information.

20. The system of claim 19 wherein the single character is a dot.

21. The system of claim 14 wherein the domain name is followed by the second information.

22. The system of claim 21 wherein the single character is a slash.

23. The system of claim 14 wherein the device includes:
a first computing device for receiving the first and second information; and
a second computing device for storing at least the portion of the first information.
